(19) United States
(12) Patent Application Publication
(10) Pub. No.: US 2025/0322070 A1
(43) Pub. Date: Oct. 16, 2025

(54) AUGMENTED ARTIFICIAL INTELLIGENCE-BASED INVESTIGATIONS OF POTENTIAL CYBER INCIDENTS, AND USE THEREOF

(71) Applicant: Darktrace Holdings Limited, Cambridge (GB)

(72) Inventors: Tim Bazalgette, Knebworth (GB); Simon Fellows, Chester (GB); Patrick Osborne, Brighton (GB)

(21) Appl. No.: 19/058,612

(22) Filed: Feb. 20, 2025

Related U.S. Application Data
(60) Provisional application No. 63/555,823, filed on Feb. 20, 2024.

(51) Int. Cl. G06F 21/57; G06F 21/55

(52) U.S. Cl. CPC G06F 21/57; G06F 21/554

(57) ABSTRACT

A computer-implemented method of investigating a potential cyber incident detected by a cyber security system is described. The method comprises using artificial intelligence (AI) based analysis to perform an investigation into the potential cyber incident based on one or more user-selected hypotheses selected by a user responsive to one or more alerts generated by the cyber security system. The method further comprises causing one or more actions to be performed based on an outcome of the investigation.

### RELATED APPLICATION

This application claims priority under 35 USC 119 to U.S. provisional patent application No. 63/555,823, titled “CYBER SECURITY” filed Feb. 20, 2024, which is incorporated herein by reference in its entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Cyber security and in an embodiment use of Artificial Intelligence in cyber security.

### BACKGROUND

Cybersecurity attacks have become a pervasive problem for enterprises as many computing devices and other resources have been subjected to attack and compromised. A “cyberattack” constitutes a threat to security of an enterprise (e.g., enterprise network, one or more computing devices connected to the enterprise network, or the like). As an example, the cyberattack may be a cybersecurity threat against the enterprise network, one or more computing devices connected to the enterprise network, stored or in-flight data accessible over the enterprise network, and/or other enterprise-based resources. This cyber threat may involve malware (malicious software) introduced into a computing device or into the network. The cyber threat may originate from an external endpoint or an internal entity (e.g., a negligent or rogue authorized user). The cyber threats may represent malicious or criminal activity, ranging from theft of credential to even a nation-state attack, where the source initiating or causing the security threat is commonly referred to as a “malicious” source. Conventional cybersecurity products are commonly used to detect and prioritize cybersecurity threats (hereinafter, “cyber threats”) against the enterprise, and to determine preventive and/or remedial actions for the enterprise in response to those cyber threats.

### SUMMARY

Methods, systems, and apparatus are disclosed for an Artificial Intelligence-based (AI-based) cyber security system. Such an AI-based cyber security system includes example aspects relating to the use of the cyber threat analyst module. In some cases, the cyber threat analyst module can perform investigations into potential cyber-attacks from potential cyber threats and can provide the ability for customers to review the outcomes of the cyber threat analyst module's investigations at the hypothesis-level and supply custom model criteria supplied from a user to choose a hypothesis for potential cyber-attacks to be investigated. In some cases, the AI analyst can perform investigations into potential cyber-attacks from potential cyber threats and can cooperate with a response module (also referred to herein as AI respond or response engine) to assist with containment of a cyber incident that is in progress. The AI-based cyber security system may be configured with software code and/or electronic hardware to support functionality within the system including performing an investigation into a potential cyber incident detected by a cyber security system, and/or representing data generated as part of an investigation into a potential cyber incident detected by a cyber security system.

In a first aspect, an apparatus for performing an investigation into a potential cyber incident detected by a cyber security system is described. The apparatus comprises an cyber threat analyst module configured to perform the investigation into the potential cyber incident based on one or more user-selected hypotheses selected by a user responsive to one or more alerts generated by the cyber security system. The cyber threat analyst module is configured to cause one or more actions to be performed based on an outcome of the investigation. Instructions implemented in software for the cyber threat analyst module are configured to be stored in one or more non-transitory storage mediums to be executed by one or more processing units.

In a second aspect, an apparatus for representing data generated as part of an investigation into a potential cyber incident detected by a cyber security system is described. The apparatus comprises an cyber threat analyst module configured to perform an investigation into the potential cyber incident based on one or more hypotheses. The cyber threat analyst module is configured to generate data indicative of one or more investigative steps taken as part of the investigation for each hypothesis of the one or more hypotheses, and an outcome of the investigation for each hypothesis. The apparatus further comprises a user interaction module communicatively coupled to the cyber threat analyst module and a user interface. The user interaction module is configured to provide at least a portion of the data generated by the cyber threat analyst module for use by the user interface to represent the portion of the data. Instructions implemented in software for the cyber threat analyst module 120 and the user interaction module are configured to be stored in one or more non-transitory storage mediums to be executed by one or more processing units.

In a third aspect, a computer-implemented method of investigating a potential cyber incident detected by a cyber security system is described. The method comprises using artificial intelligence (AI) based analysis to perform an investigation into the potential cyber incident based on one or more user-selected hypotheses selected by a user responsive to one or more alerts generated by the cyber security system. The method further comprises causing one or more actions to be performed based on an outcome of the investigation.

In a fourth aspect, a computer-implemented method of representing data generated as part of an investigation into a potential cyber incident detected by a cyber security system. The method comprises using artificial intelligence (AI) based analysis to perform the investigation into the potential cyber incident based on one or more hypotheses. The method further comprises generating data indicative of one or more investigative steps taken as part of the investigation for each hypothesis of the one or more hypotheses, and an outcome of the investigation for each hypothesis. The method further comprises providing at least a portion of the generated data for use by a user interface to represent the portion of the data.

Further aspects relating to the first to fourth aspects include a non-transitory computer-readable medium storing instructions that implements one or more operations corresponding to the functionality described in relation to any one of the first to fourth aspects.

These and other features of the design provided herein can be better understood with reference to the drawings, description, and claims, all of which form the disclosure of this patent application.

### DRAWINGS

The drawings refer to some embodiments of the design provided herein in which:

FIG. 1 illustrates a block diagram of an embodiment of the AI-based cyber security appliance with example components making up a detection engine that protects a system, including but not limited to a network/domain, from cyber threats.

FIG. 2 illustrates a block diagram of an embodiment of the AI-based cyber security appliance with example components making up a cyber security restoration (e.g., self-healing) engine that takes one or more autonomous remediation actions to recover from a cyberattack from a cyber threat.

FIG. 3 illustrates a diagram of an embodiment of the cyber security restoration engine configured to take one or more autonomous remediation actions based on Artificial Intelligence assistance to remediate one or more nodes in the graph of the system being protected back to the trusted operational state before a detected compromise by a cyber threat occurred in the protected system in order to assist in a recovery from the cyber threat.

FIG. 4 illustrates a block diagram of an embodiment of an intelligent orchestration component configured to facilitate an Artificial Intelligence augmented and adaptive interactive response loop between multiple Artificial Intelligence-based engines.

FIG. 5 illustrates a diagram of an embodiment of i) the cyber threat detection engine using Artificial Intelligence algorithms configured and trained to perform a first machine-learned task of detecting the cyber threat, ii) an autonomous response engine using Artificial Intelligence algorithms configured and trained to perform a second machine-learned task of taking one or more mitigation actions to mitigate the cyber threat, iii) a cyber-security restoration engine using Artificial Intelligence algorithms configured and trained to perform a third machine-learned task of remediating the system being protected back to a trusted operational state, and iv) a prediction engine using Artificial Intelligence algorithms configured and trained to perform a fourth machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack, working in tandem.

FIG. 6 illustrates a block diagram of an embodiment of the cyber-attack simulator with Artificial Intelligence-based simulations conducted in the prediction engine by constructing a graph of nodes of the system being protected (e.g. a network including i) the physical devices connecting to the network, any virtualize machines of the network, user accounts in the network, email accounts in the network, etc. as well as ii) connections and pathways through the network) to create a simulated version of the system to be tested.

FIG. 7 illustrates a diagram of an embodiment of a cyber threat prediction engine and its Artificial Intelligence-based simulations constructing a graph of nodes in an example network and simulating how the cyberattack might likely progress in the future tailored with an innate understanding of a normal behavior of the nodes in the system being protected and a current operational state of each node in the graph of the protected system during simulations of cyberattacks.

FIG. 8 illustrates a graph of an embodiment of an example chain of unusual behavior for, in this example, the email activities and IT network activities deviating from a normal pattern of life in connection with the rest of the system/network under analysis.

FIG. 9 illustrates a block diagram of an embodiment of the AI-based cyber security appliance with the cyber security restoration engine and other Artificial Intelligence-based engines plugging in as an appliance platform to protect a system.

FIG. 10 illustrates a diagram of an embodiment of the cyber security restoration engine cooperating with the other Artificial Intelligence-based engines of in a cyber security appliance to track and understand the cyber threat identified by the other Artificial Intelligence-based engines as well as track the one or more mitigation actions taken to mitigate the cyber threat during the cyberattack by the other Artificial Intelligence-based engines in order to assist in intelligently restoring the protected system, while still mitigating the cyber threat attack, back to a trusted operational state.

FIG. 11 illustrates a block diagram of an embodiment of one or more computing devices that can be a part of the Artificial Intelligence-based cyber security system including the multiple Artificial Intelligence-based engines discussed herein.

FIG. 12 illustrates an example user interface presenting a list of AI analyst investigations.

FIG. 13 illustrates an example user interface presenting a model breach analysis.

FIG. 14 is an example of a user suggesting, via a user interface, that AI analyst should investigate a hypothesis as a result of a model breach.

FIG. 15 depicts an example representation of a user interface for allowing a user to select one or more hypotheses for the cyber threat analyst module 120 to use as part of an investigation.

FIG. 16 depicts an example representation of a user interface for allowing a user to select one or more MITRE Tactics for the cyber threat analyst module 120 to use as part of an investigation.

FIG. 17 depicts an example representation of a user interface that allows information generated by the cyber threat analyst module 120 to be provided to a user.

FIG. 18 is a table listing the possible statuses of an investigation associated with a model alert.

FIG. 19 depicts an example representation of a user interface when an investigation has been concluded.

FIG. 20 depicts an example representation of a user interface providing the analysis of a model alert breakdown.

FIG. 21 depicts an example representation of a user interface showing the breakdown open over the event timeline and can be dismissed by a user click.

FIG. 22 depicts an example representation of a user interface providing information about an example hypothesis entry.

FIG. 23 is a flowchart illustrating a computer-implemented method of investigating a potential cyber incident detected by a cyber security system according to an embodiment.

FIG. 24 is a flowchart illustrating a computer-implemented method of representing data generated as part of an investigation into a potential cyber incident detected by a cyber security system according to an embodiment.

FIG. 25 illustrates a block diagram of an apparatus for performing an investigation into a potential cyber incident detected by a cyber security system according to an embodiment.

FIG. 26 illustrates a block diagram of an apparatus for performing an investigation into a potential cyber incident detected by a cyber security system according to an embodiment.

FIG. 27 illustrates a block diagram of an apparatus for representing data generated as part of an investigation into a potential cyber incident detected by a cyber security system according to an embodiment.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first server, can be made. However, the specific numeric reference should not be interpreted as a literal sequential order but rather interpreted that the first server is different than a second server. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

A cyber security system can employ artificial intelligence (AI) based analysis to investigate a potential cyber incident in a computing network. As described herein, the approach to AI-based analysis and the response to such analysis can be enhanced to improve cyber security. The section below titled ‘Artificial intelligence-based cyber security analyst’, which includes the subsections ‘User Selection of AI-Powered Hypothesis Analysis and Outcomes’ and ‘the cyber threat analyst module-powered RESPOND actions for in-progress incident containment’, ‘Further Discussion of Hypotheses’, ‘Detailed cyber threat analyst module 120 Investigations in the Model Alert Log’, and ‘Recommended Autonomous Response Actions’, describes techniques that may provide one or more such enhancements. Embodiments relating to these techniques are described in the section titled ‘Improved and Augmented Artificial Intelligence-based Investigations of Potential Cyber Incidents, and use thereof’.

### Cyber Security Appliance

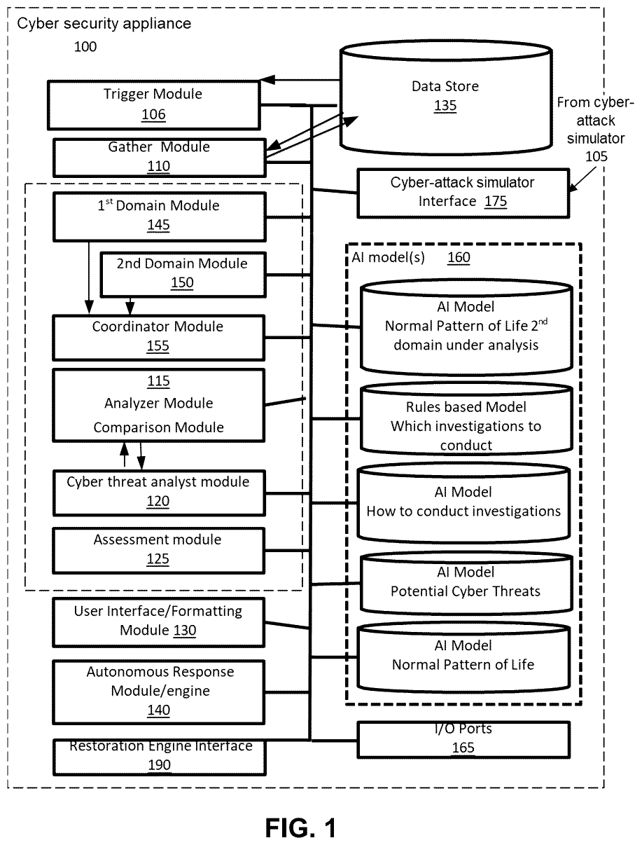

FIG. 1 illustrates a block diagram of an embodiment of the AI-based cyber security appliance with example components making up a detection engine that protects a system, including but not limited to a network/domain, from cyber threats. Various Artificial Intelligence models and modules of the cyber security appliance 100 cooperate to protect a system, such as one or more networks/domains under analysis, from cyber threats. As shown, according to one embodiment of the disclosure, the AI-based cyber security appliance 100 may include a trigger module 106, a gather module 110, an analyzer module 115, a cyber threat analyst module, an assessment module 125, a formatting module 130, a data store 135, an autonomous response module 140, a first (1^{st}) domain module 145, a second (2^{nd}) domain module 150, and a coordinator module 155, one or more AI models 160 (hereinafter, AI model(s)”), and/or other modules. The AI model(s) 160 may be trained with machine learning on a normal pattern of life for entities in the network(s)/domain(s) under analysis, with machine learning on cyber threat hypotheses to form and investigate a cyber threat hypothesis on what are a possible set of cyber threats and their characteristics, symptoms, remediations, etc., and/or trained on possible cyber threats including their characteristics and symptoms, a data store, an interface to an autonomous response engine, an interface to a restoration engine, an interface to a prediction engine, a 1 st domain module, a 2nd domain module, and a coordinator module, and other similar components.

The cyber threat detection engine includes a set of modules cooperating with one or more Artificial Intelligence models configured to perform a machine-learned task of detecting a cyber threat incident. The detection engine uses the set of modules cooperating with the one or more Artificial Intelligence models to detect anomalous behavior of one or more nodes, including at least user accounts, devices, and versions of source code files, in a graph of a system being protected. The detection engine uses the set of modules cooperating with the one or more Artificial Intelligence models to prevent a cyber threat from compromising the nodes and/or spreading through the nodes of the system.

The cyber security appliance 100 with the Artificial Intelligence (AI)-based cyber security system may protect a network/domain from a cyber threat (insider attack, malicious files, malicious emails, etc.). In an embodiment, the cyber security appliance 100 can protect all of the devices (e.g., computing devices) on the network(s)/domain(s) being monitored by monitoring domain activity including communications. For example, a network domain module (e.g., first domain module 145) may communicate with network sensors to monitor network traffic going to and from the computing devices on the network as well as receive secure communications from software agents embedded in host computing devices/containers. The steps below will detail the activities and functions of several of the components in the cyber security appliance 100.

The gather module 110 may be configured with one or more process identifier classifiers. Each process identifier classifier may be configured to identify and track one or more processes and/or devices in the network, under analysis, making communication connections. The data store 135 cooperates with the process identifier classifier to collect and maintain historical data of processes and their connections, which is updated over time as the network is in operation. Individual processes may be present in merely one or more domains being monitored. In an example, the process identifier classifier can identify each process running on a given device along with its endpoint connections, which are stored in the data store 135. In addition, a feature classifier can examine and determine features in the data being analyzed into different categories.

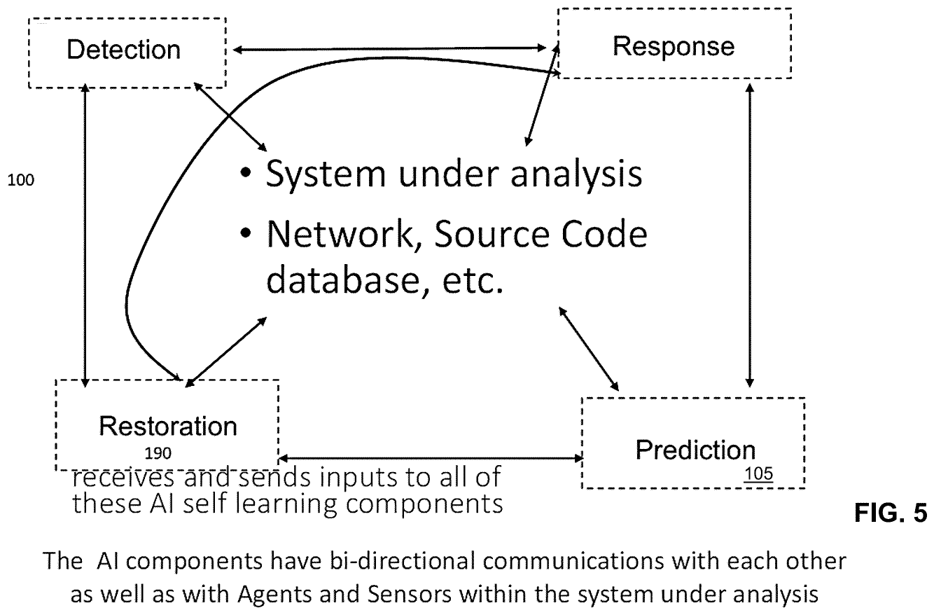

The analyzer module 115 can cooperate with the AI model(s) 160 or other modules in the cyber security appliance 100 to confirm a presence of a cyberattack against one or more domains in an enterprise's system (e.g., see system/enterprise network 50 of FIG. 5). A process identifier in the analyzer module 115 can cooperate with the gather module 110 to collect any additional data and metrics to support a possible cyber threat hypothesis. Similarly, the cyber threat analyst module 120 can cooperate with the internal data sources as well as external data sources to collect data in its investigation. More specifically, the cyber threat analyst module 120 can cooperate with the other modules and the AI model(s) 160 in the cyber security appliance 100 to conduct a long-term investigation and/or a more in-depth investigation of potential and emerging cyber threats directed to one or more domains in an enterprise's system. Herein, the cyber threat analyst module 120 and/or the analyzer module 115 can also monitor for other anomalies, such as model breaches, including, for example, deviations for a normal behavior of an entity, and other techniques discussed herein. As an illustrative example, the analyzer module 115 and/or the cyber threat analyst module 120 can cooperate with the AI model(s) 160 trained on potential cyber threats in order to assist in examining and factoring these additional data points that have occurred over a given timeframe to see if a correlation exists between 1) a series of two or more anomalies occurring within that time frame and 2) possible known and unknown cyber threats. The cyber threat analyst module 120 can cooperate with the internal data sources as well as external data sources to collect data in its investigation.

According to one embodiment of the disclosure, the cyber threat analyst module 120 allows two levels of investigations of a cyber threat that may suggest a potential impending cyberattack. In a first level of investigation, the analyzer module 115 and AI model(s) 160 can rapidly detect and then the autonomous response module 140 will autonomously respond to overt and obvious cyberattacks. However, thousands to millions of low level anomalies occur in a domain under analysis all of the time; and thus, most other systems need to set the threshold of trying to detect a cyberattack by a cyber threat at level higher than the low level anomalies examined by the cyber threat analyst module 120 just to not have too many false positive indications of a cyberattack when one is not actually occurring, as well as to not overwhelm a human cyber security analyst receiving the alerts with so many notifications of low level anomalies that they just start tuning out those alerts. However, advanced persistent threats attempt to avoid detection by making these low-level anomalies in the system over time during their cyberattack before making their final coup de grace/ultimate mortal blow against the system (e.g., domain) being protected. The cyber threat analyst module 120 also conducts a second level of investigation over time with the assistance of the AI model(s) 160 trained with machine learning on how to form cyber threat hypotheses and how to conduct investigations for a cyber threat hypothesis that can detect these advanced persistent cyber threats actively trying to avoid detection by looking at one or more of these low-level anomalies as a part of a chain of linked information.

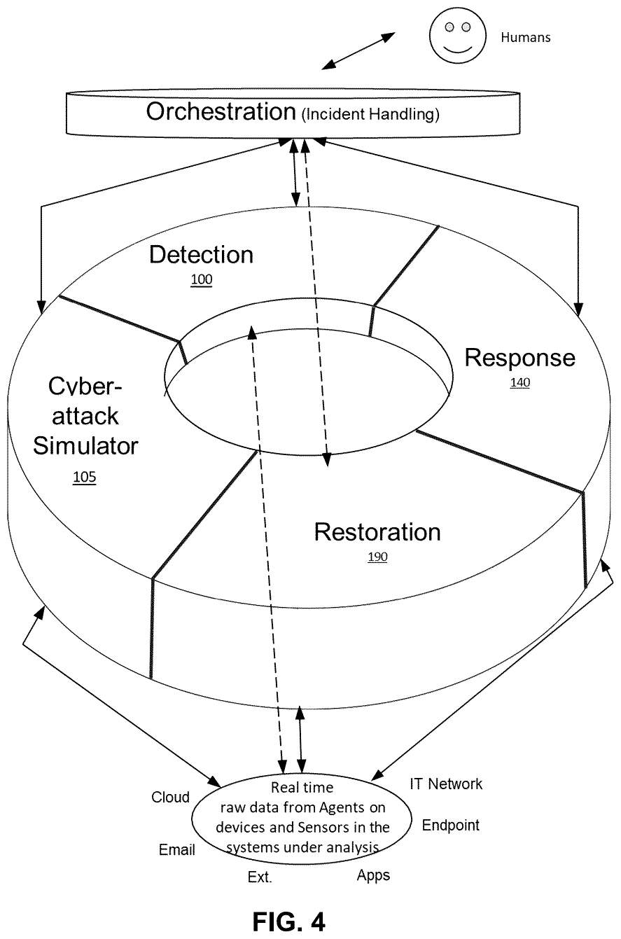

Note, a data analysis process can be algorithms/scripts written by humans to perform their function discussed herein; and can in various cases use AI classifiers as part of their operation. The cyber threat analyst module 120 forms in conjunction with the AI model(s) 160 trained with machine learning on how to form cyber threat hypotheses and how to conduct investigations for a cyber threat hypothesis investigate hypotheses on what are a possible set of cyber threats. The cyber threat analyst module 120 can also cooperate with the analyzer module 115 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 160 trained with machine learning on the normal pattern of life of entities in the system. For example, as shown in FIG. 4, the cyber threat analyst module 120 may perform several additional rounds 400 of gathering additional information, including abnormal behavior, over a period of time, in this example, examining data over a 7-day period to determine causal links between the information. The cyber threat analyst module 120 may submit to check and recheck various combinations/a chain of potentially related information, including abnormal behavior of a device/user account under analysis for example, until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted. For this embodiment, a human cyber security analyst is needed to further investigate the anomaly (and/or anomalies) of interest included in the chain of potentially related information.

The cyber threat analyst module 120 is configured to allow a human user to understand and drive the cyber threat analyst module's 120 investigations as well as augment potential autonomous responses from the autonomous response module. the user interaction module is configured to review an output of the investigation into the potential cyber incident, and then supply the one or more user-selected hypotheses for the cyber threat analyst module 120 to further review by the cyber threat analyst module 120 to conclude whether the potential cyber incident detected by the cyber security system is an actual cyber incident caused by a cyber threat. The human user can also review the output of the cyber threat analyst module's 120 investigations as well as its recommendations for response actions to be taken. The user is able to review both the cyber threat analyst module's 120 investigations on how it concluded something was a cyber threat and then review what autonomous responses will be taken by the autonomous response module. the user interaction module is configured to receive one or more user specified criteria for the cyber security system, wherein the one or more user specified criteria are indicative of the one or more actions that are to be performed based on the outcome of the investigation to allow the user to augment recommended response actions to be taken by the cyber security system with the one or more actions selected by the user. The user interaction module is configured to allow user to be able to review i) how the cyber threat analyst module 120 performed the investigation into the potential cyber incident and concluded a cyber threat was present and ii) then what are one or more autonomous responses to be taken by the cyber security system. The user interaction module is configured to cooperate with an autonomous response module to allow a user to review one or more autonomous responses to be taken by an autonomous response module to mitigate against a cyber threat detected in the potential cyber incident and then to allow the user to insert their own better judgement on what autonomous responses will be taken by the autonomous response module with the suggestions from the cyber threat analyst module 120 along with other actions the user may want to add. The cyber threat analyst module's 120 investigations into potential cyber incidents from potential cyber threats has the ability for users to review the outcomes of the cyber threat analyst module's 120 investigations at the hypothesis-level (hypothesis steps taken and investigation steps taken and then its conclusion) and also let users now define any kind of custom model criteria, and add their own hypothesis to it to choose hypothesis for potential cyber-attacks to be investigated, which is kind of all built into this narrative of like a completely AI investigation experience with a human readable summary on why the system took the hypothesis steps taken and investigation steps taken and then its conclusion. The cyber threat analyst module's 120 investigations into potential cyber-attacks from potential cyber threats can cooperate with the autonomous response module on autonomous responses to be taken by the autonomous response module to assist with containment of a cyber incident that is in progress and then add the cyber threat analyst module's own response action as a user supplied recommendations to take.

Returning back to FIG. 1, an input from the cyber threat analyst module 120 of a supported hypothesis of a potential cyber threat will trigger the analyzer module 115 to compare, confirm, and send a signal to act upon and mitigate that cyber threat. In contrast, the cyber threat analyst module 120 investigates subtle indicators and/or initially seemingly isolated unusual or suspicious activity such as a worker is logging in after their normal working hours or a simple system misconfiguration has occurred. Most of the investigations conducted by the cyber threat analyst module 120 cooperating with the AI model(s) 160 trained with machine learning on how to form cyber threat hypotheses and how to conduct investigations for a cyber threat hypothesis on unusual or suspicious activities/behavior may not result in a cyber threat hypothesis that is supported but rather most are refuted or simply not supported. Typically, during the investigations, several rounds of data gathering to support or refute the long list of potential cyber threat hypotheses formed by the cyber threat analyst module 120 will occur before the algorithms in the cyber threat analyst module 120 will determine whether a particular cyber threat hypothesis is supported, refuted, or needs further investigation by a human. The rounds of data gathering may build chains of linked low-level indicators of unusual activity along with potential activities that could be within a normal pattern of life for that entity to evaluate the whole chain of activities to support or refute each potential cyber threat hypothesis formed. (See again, for example, FIG. 4 and a chain of linked low-level indicators, including abnormal behavior compared to the normal patten of life for that entity, all under a score of 50 on a threat indicator score). The investigations by the cyber threat analyst module 120 can happen over a relatively long period of time and be far more in depth than the analyzer module 115 which will work with the other modules and AI model(s) 160 to confirm that a cyber threat has in fact been detected.

The gather module 110 may further extract data from the data store 135 at the request of the cyber threat analyst module 120 and/or analyzer module 115 on each possible hypothetical threat that would include the abnormal behavior or suspicious activity and then can assist to filter that collection of data down to relevant points of data to either 1) support or 2) refute each particular hypothesis of what the cyber threat, the suspicious activity and/or abnormal behavior relates to. The gather module 110 cooperates with the cyber threat analyst module 120 and/or analyzer module 115 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

Thus, the cyber threat analyst module 120 is configured to cooperate with the AI model(s) 160 trained with machine learning on how to form cyber threat hypotheses and how to conduct investigations for a cyber threat hypothesis to form and investigate hypotheses on what are a possible set of cyber threats and then can cooperate with the analyzer module 115 with the one or more data analysis processes to confirm the results of the investigation on the possible set of cyber threats hypotheses that would include the at least one of i) the abnormal behavior, ii) the suspicious activity, and iii) any combination of both, identified through cooperation with the AI model(s) 160 trained with machine learning on the normal pattern of life/normal behavior of entities in the domains under analysis.

Note, in the first level of threat detection, the gather module 110 and the analyzer module 115 cooperate to supply any data and/or metrics requested by the analyzer module 115 cooperating with the AI model(s) 160 trained on possible cyber threats to support or rebut each possible type of cyber threat. Again, the analyzer module 115 can cooperate with the AI model(s) 160 and/or other modules to rapidly detect and then cooperate with the autonomous response module 140 to autonomously respond to overt and obvious cyberattacks, (including ones found to be supported by the cyber threat analyst module).

As a starting point, the AI-based cyber security appliance 100 can use multiple modules, each capable of identifying abnormal behavior and/or suspicious activity against the AI model(s) 160 trained on a normal pattern of life for the entities in the network/domain under analysis, which is supplied to the analyzer module 115 and/or the cyber threat analyst module. The analyzer module 115 and/or the cyber threat analyst module 120 may also receive other inputs such as AI model breaches, AI classifier breaches, etc. a trigger to start an investigation from an external source.

Many other model breaches of the AI model(s) 160 trained with machine learning on the normal behavior of the system can send an input into the cyber threat analyst module 120 and/or the trigger module 106 to trigger an investigation to start the formation of one or more hypotheses on what are a possible set of cyber threats that could include the initially identified abnormal behavior and/or suspicious activity. Note, a deeper analysis can look at example factors such as i) how long has the endpoint existed or is registered; ii) what kind of certificate is the communication using; iii) is the endpoint on a known good domain or known bad domain or an unknown domain, and if unknown what other information exists such as registrant's name and/or country; iv) how rare; v), etc.

Note, the cyber threat analyst module 120 cooperating with the AI model(s) 160 trained with machine learning on how to form cyber threat hypotheses and how to conduct investigations for a cyber threat hypothesis in the AI-based cyber security appliance 100 provides an advantage as it reduces the time taken for human led or cyber security investigations, provides an alternative to manpower for small organizations and improves detection (and remediation) capabilities within the cyber security appliance 100.

The cyber threat analyst module, which forms and investigates hypotheses on what are the possible set of cyber threats, can use hypotheses mechanisms including any of 1) one or more of the AI model(s) 160 trained on how human cyber security analysts form cyber threat hypotheses and how to conduct investigations for a cyber threat hypothesis that would include at least an anomaly of interest, 2) one or more scripts outlining how to conduct an investigation on a possible set of cyber threats hypotheses that would include at least the anomaly of interest, 3) one or more rules-based models on which investigations to conduct on a possible set of cyber threats hypotheses and how to form a possible set of cyber threats hypotheses that would include at least the anomaly of interest, and 4) any combination of these. Again, the AI model(s) 160 trained on ‘how to form cyber threat hypotheses and how to conduct investigations for a cyber threat hypothesis’ may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 120 and/or the analyzer module 115 can feed the cyber threat details to the assessment module 125 to generate a threat risk score that indicate a level of severity of the cyber threat.

The multiple Artificial Intelligence-based engines each have an interface to communicate with the other separate Artificial Intelligence-based engines. Each Intelligence-based engine has an interface to communicate with another separate Artificial Intelligence-based engine, which is configured to understand a type of information and communication that this other separate Artificial Intelligence-based engine needs to make determinations on an ongoing cyberattack from that other Artificial Intelligence-based engine's perspective. The autonomous response engine works with the assessment module in the detection engine when the cyber threat is detected and autonomously takes one or more actions to mitigate the cyber threat. FIG. 1 shows the example components making up the detection engine to include interfaces to the prediction engine, the autonomous response engine, and the restoration engine.

The cyber threat detection engine can also have an anomaly alert system in a formatting module configured to report out anomalous incidents and events as well as the cyber threat detected to a display screen viewable by a human cyber-security professional. Each Artificial Intelligence-based engine has a rapid messaging system to communicate with a human cyber-security team to keep the human cyber-security team informed on actions autonomously taken and actions needing human approval to be taken.

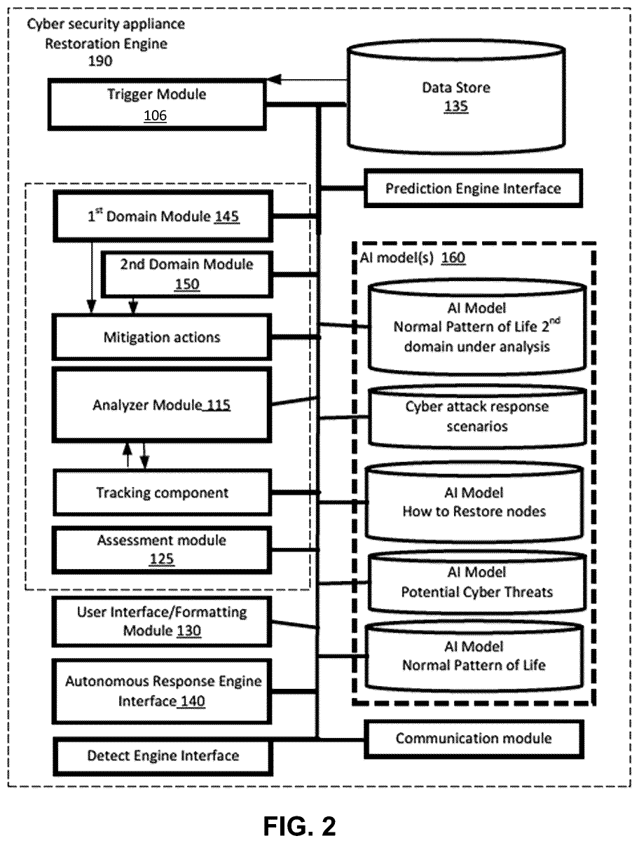

FIG. 2 illustrates a block diagram of an embodiment of the AI-based cyber security appliance with example components making up a cyber security restoration (e.g., self-healing) engine 190 (the interface to which is depicted in FIG. 1) that takes one or more autonomous remediation actions to recover from a cyberattack from a cyber threat. Note, similarly named components in the cyber security restoration engine can operate and function similar to as described for the detection engine.

The cyber security restoration engine 190 is configured to take one or more remediation actions based on configured and/or Artificial Intelligence assistance to remediate the one or more nodes in the graph of the system being protected back to a trusted operational state in a recovery from the cyber threat. These actions might be fully automatic, or require a specific human confirmation decision before they begin.

The cyber security restoration engine 190 is configured to cooperate with the other AI-based engines of the cyber security system, via the interfaces and/or direct integrations, to track and understand the cyber threat identified by the other components as well as track the one or more mitigation actions taken to mitigate the cyber threat during the cyberattack by the other components in order to assist in intelligently restoring the protected system while still mitigating the cyber threat attack back to a trusted operational state; and thus, as a situation develops with an ongoing cyberattack, the cyber security restoration engine 190 is configured to take one or more remediation actions to remediate (e.g. restore) at least one of the nodes in the graph of the protected system back to a trusted operational state while the cyberattack is still ongoing.

The cyber security restoration engine 190 has a tracking component that includes at least one of i) a database to keep a record and track an operational state of each node in the graph of the protected system, ii) an Artificial Intelligence model trained to track the operational state of each node in the graph of the protected system, iii) a query to another artificial intelligence based engine that tracks the operational state of each node in the graph of the protected system from a different perspective, and iv) a combination of any of these, so that the cyber security restoration engine can then take the one or more autonomous remediation actions to remediate each particular node (e.g. user account and/or device) back to a trusted operational state for that node.

The cyber security restoration engine 190 can cooperate with the other Artificial Intelligence-based engines of the cyber security system to track and understand the cyber threat identified by the other Artificial Intelligence-based engines (detection engine and/or the prediction engine) as well as track the one or more mitigation actions taken to mitigate the cyber threat during the cyberattack by an autonomous response engine and/or human cyber security team members in order to assist in intelligently restoring the protected system while still mitigating the cyber threat attack back to a trusted operational state. Thus, as a situation develops with an ongoing cyberattack, the cyber security restoration engine 190 is configured to take the one or more remediation actions to remediate at least one of the nodes in the graph of the protected system back to a trusted operational state to restore portions of the protected system while the cyberattack is still ongoing. The cyber security restoration engine 190 restores the affected nodes in the protected system by using incident modelling in the cyber threat analyst module 120 (e.g., AI Analyst) to map and identify an entire lifecycle of attack, work with the AI models trained on cyber security threats in the detection engine to identify a source of the cyberattack, and recommend restore points (e.g., where in the protected system remediation action is needed).

The communication module can cooperate with the cyber security restoration engine 190 to communicate with the other Artificial Intelligence-based engines of the cyber security system. Again, the machine-learned tasks of the other Artificial Intelligence-based engines can include i) identifying the cyber threat itself and ii) taking one or more mitigation actions to mitigate the cyber threat during a cyberattack by the cyber threat. The communication module also communicates with one or more third party external backup and/or recovery services and systems to invoke backup remediation actions and recovery remediation actions to remediate the nodes from the cyber threat back to a trusted operational state, for example but not limited to the state before the detected compromise by the cyber threat occurred in the protected system. For example, the cyber security restoration engine 190 can send a command to third party back up providers to invoke a full backup of a complete copy of all the files, folders, and operational settings for a device in the system. The cyber security restoration engine 190 can use one or more Application Programming Interfaces (APIs) to translate desired remediation actions for the particular nodes in the system (e.g. its devices from potentially multiple different vendors, user accounts, etc.) being protected devices into a specific language and syntax utilized by the third party external backup and/or recovery services and systems to invoke the backup remediation actions and recovery remediation actions to remediate the nodes. In addition, the cyber security restoration engine 190 can send a request to the human cyber security team to take similar actions where it has no direct capability to do so itself but can recommend the remediation and recovery steps. In another example, the external 3rd party backup and/or recovery services and systems can include, for example, cloud data recovery, desktop, and server backups to take disk images of hardware to restore all of the settings and data prior to an attack, and other forms of salvaging deleted, inaccessible, lost, corrupted, damaged, or formatted data and operational settings from these recovery services, switching to back up systems when the main system has been disrupted, etc.

All of the Artificial Intelligence-based engines are configured to have bi-directional communications with the other Artificial Intelligence-based engines as well as with agents and sensors within the protected system under analysis. The communication module can use an instant messaging application between the cyber security restoration engine 190 and members of a human cyber security team to report autonomous remediation actions taken by the cyber security restoration engine 190 to restore the one or more nodes as well as proposed remediation actions needing the human cyber security team's authorization to remediate the one or more nodes in the protected system back to a trusted operational state. It may also use similar messaging applications to inform IT teams or other relevant but non cyber security teams that they need to take actions.

The cyber security restoration engine 190 can reference both i) a database of restoration response scenarios stored in the database and ii) a prediction engine configured to run Artificial Intelligence-based simulations and use the operational state of each node in the graph of the protected system during simulations of cyberattacks on the protected system to restore 1) each node compromised by the cyber threat and 2) promote protection of the corresponding nodes adjacent to a compromised node in the graph of the protected system.

The cyber security restoration engine 190 can prioritize among the one or more nodes to restore, which nodes to remediate and an order of the nodes to remediate, based on two or more factors including i) a dependency order needed for the recovery efforts, ii) an importance of a particular recovered node compared to other nodes in the system being protected, iii) a level of compromise of a particular node contemplated to be restored, iv) an urgency to recover that node compared to whether containment of the cyber threat was successful, v) a list of a most important things in the protected system to recover earliest, and vi) factoring in a result of a cyberattack simulation being run during the cyberattack by a prediction engine to predict a likely result regarding the cyberattack when that node is restored.

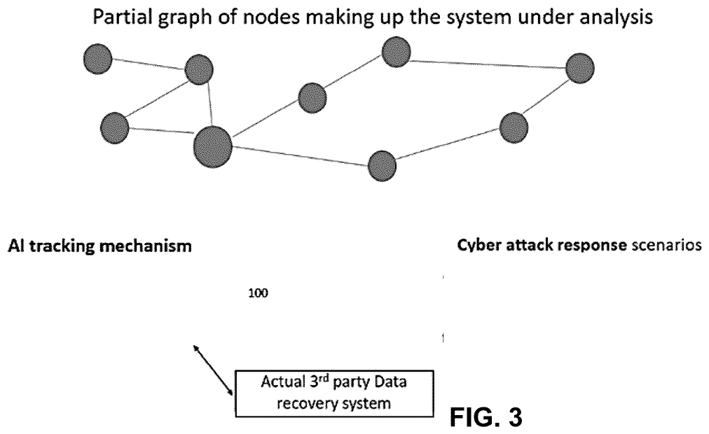

FIG. 3 illustrates a block diagram of an embodiment of the cyber security restoration engine 190 configured to take one or more autonomous remediation actions based on Artificial Intelligence assistance to remediate one or more nodes in the graph of the system being protected back to the trusted operational state before a detected compromise by a cyber threat occurred in the protected system in order to assist in a recovery from the cyber threat.

As discussed, the communication module can be configured to communicate also with one or more external 3rd party backup and/or recovery services and systems to invoke backup remediation actions and recovery remediation actions to remediate the nodes from the cyber threat and restore likely affected users and devices in the protected system back to a trusted operational state. The external 3rd party backup and/or recovery services and systems receive instructions from the cyber security restoration engine 190 to invoke specific and tailored backup remediation actions and recovery remediation actions to remediate the nodes from the cyber threat while still containing the cyber threat itself. As shown, the cyber security restoration engine 190 can generate and maintain a graph of nodes making up the system under analysis.

FIG. 3 further shows a partial graph of nodes making up the system under analysis. An AI tracking mechanism, such as a database (DB) or an AI model can track trusted operational states of each node user account (e.g. user account and or device) in the graph of the system being protected. This can exchange information with an actual third party data recovery system. The cyber attack response scenarios from the database and or direct communication in real time with the Prevent component of potential response actions for each node (e.g. user account and or device) and the corresponding nodes adjacent to a compromised node in the graph of the system being protected.

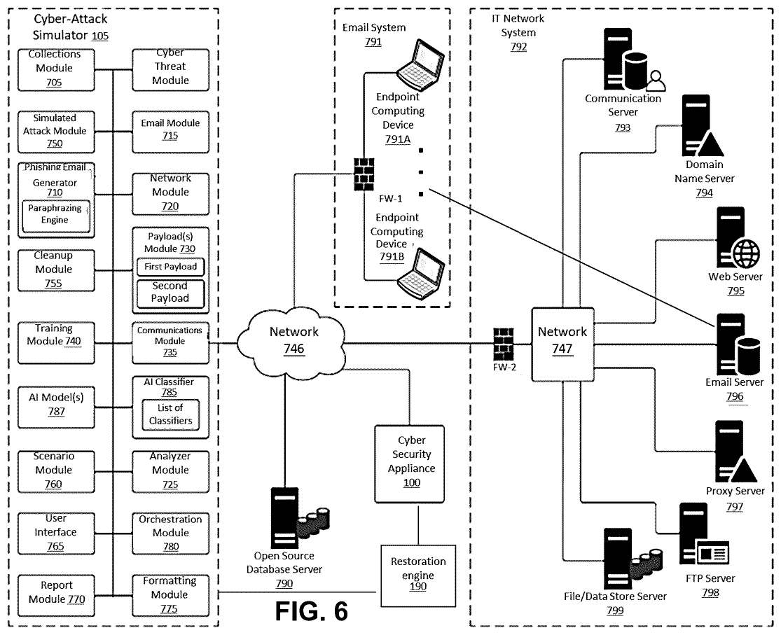

FIG. 4 illustrates a block diagram of an embodiment of an intelligent orchestration component configured to facilitate an Artificial Intelligence augmented and adaptive interactive response loop between the multiple Artificial Intelligence-based engines. The example multiple Artificial Intelligence-based engines cooperating with each other can include i) the cyber threat detection engine, ii) an autonomous response engine, iii) a cyber-security restoration engine, and iv) a prediction engine. i) The cyber threat detection engine can be configured to use Artificial Intelligence algorithms trained to perform a machine-learned task of detecting the cyber threat. (See for example FIG. 1) ii) The autonomous response engine can be configured to use Artificial Intelligence algorithms trained to perform a machine-learned task of taking one or more mitigation actions to mitigate the cyber threat. iii) The cyber-security restoration engine can be configured to use Artificial Intelligence algorithms trained to perform a machine-learned task of remediating the system being protected back to a trusted operational state. (See for example FIG. 2) iv) The prediction engine can be configured to use Artificial Intelligence algorithms trained to perform a machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack. (See, for example, FIG. 6)

The multiple Artificial Intelligence-based engines have communication hooks in between them to exchange a significant amount of behavioral metrics including data between the multiple Artificial Intelligence-based engines to work in together to provide an overall cyber threat response.

The intelligent orchestration component can be configured as a discreet intelligent orchestration component that exists on top of the multiple Artificial Intelligence-based engines to orchestrate the overall cyber threat response and an interaction between the multiple Artificial Intelligence-based engines, each configured to perform its own machine-learned task. Alternatively, the intelligent orchestration component can be configured as a distributed collaboration with a portion of the intelligent orchestration component implemented in each of the multiple Artificial Intelligence-based engines to orchestrate the overall cyber threat response and an interaction between the multiple Artificial Intelligence-based engines. In an embodiment, whether implemented as a distributed portion on each AI engine or a discrete AI engine itself, the intelligent orchestration component can use self-learning algorithms to learn how to best assist the orchestration of the interaction between itself and the other AI engines, which also implement self-learning algorithms themselves to perform their individual machine-learned tasks better.

The multiple Artificial Intelligence-based engines can be configured to cooperate to combine an understanding of normal operations of the nodes, an understanding emerging cyber threats, an ability to contain those emerging cyber threats, and a restoration of the nodes of the system to heal the system with an adaptive feedback between the multiple Artificial Intelligence-based engines in light of simulations of the cyberattack to predict what might occur in the nodes in the system based on the progression of the attack so far, mitigation actions taken to contain those emerging cyber threats and remediation actions taken to heal the nodes using the simulated cyberattack information.

One or more Artificial Intelligence models in the detection engine can be configured to maintain what is considered to be normal behavior for that node, which is constructed on a per node basis, on the system being protected from historical data of that specific node over an operation of the system being protected.

The multiple Artificial Intelligence-based engines each have an interface to communicate with the other separate Artificial Intelligence-based engines configured to understand a type of information and communication that the other separate Artificial Intelligence-based engine needs to make determinations on an ongoing cyberattack from that other Artificial Intelligence-based engine's perspective. Each Artificial Intelligence-based engine has an instant messaging system to communicate with a human cyber-security team to keep the human cyber-security team informed on actions autonomously taken and actions needing human approval as well as generate reports for the human cyber-security team.

FIG. 5 illustrates a diagram of an embodiment of i) the cyber threat detection engine using Artificial Intelligence algorithms trained to perform a first machine-learned task of detecting the cyber threat, ii) an autonomous response engine using Artificial Intelligence algorithms trained to perform a second machine-learned task of taking one or more mitigation actions to mitigate the cyber threat, iii) a cyber-security restoration engine using Artificial Intelligence algorithms trained to perform a third machine-learned task of remediating the system being protected back to a trusted operational state, and iv) a prediction engine using Artificial Intelligence algorithms trained to perform a fourth machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack, in order for these four Artificial Intelligence-based engines to work together. In addition, the intelligent orchestration component can use Artificial Intelligence algorithms trained to perform a fifth machine-learned task of adaptive interactive response between the multiple Artificial Intelligence-based engines to provide information each Artificial Intelligence engine needs to work cohesively to provide an overall incidence response that mitigates different types of cyber threats while still minimizing an impact tailored to this particular system being protected. For example, when a conversation occurs between the AI-based engines such as a system that can be positively affected by both proposed mitigation actions and proposed restoration actions, any of which might be attempted but fail or only partially succeed, then the intelligent orchestration component can arbitrate and evolve the best result for this particular system being protected. The intelligent orchestration component can help anticipate i) the needs of and ii) cohesive response of each Artificial Intelligence-based engine based on a current detected cyber threat.

The cyber-security restoration engine receives and sends inputs through communication hooks (e.g.) interfaces to all of these Artificial Intelligence-based engines each configured with self-learning AI machine learning algorithms to, respectively, i) to detect the cyber threat, ii) to respond to mitigate that cyber threat, and iii) to predict how that cyber threat might occur and likely progress through simulations. Each of these Artificial Intelligence-based engines has bi-directional communications, including the exchange of raw data, with each other as well as with software agents resident in physical and/or virtual devices making up the system being protected as well as bi-directional communications with sensors within the system being protected. Note, the system under protection can be, for example, an IT network, an OT network, a Cloud network, an email network, a source code database, an endpoint device, etc.

In an example, the autonomous response engine uses its intelligence to cooperate with a cyber threat prediction engine and its Artificial Intelligence-based simulations to choose and initiate an initial set of one or more mitigation actions indicated as a preferred targeted initial response to the detected cyber threat by autonomously initiating those mitigation actions to defend against the detected cyber threat, rather than a human taking an action. The autonomous response engine, rather than the human taking the action, is configured to autonomously cause the one or more mitigation actions to be taken to contain the cyber threat when a threat risk parameter from an assessment module in the detection engine is equal to or above an actionable threshold. Example mitigation actions can include 1) the autonomous response engine monitoring and sending signals to a potentially compromised node to restrict communications of the potentially compromised node to merely normal recipients and types of communications according to the Artificial Intelligence model trained to model the normal pattern of life for each node in the protected system, 2) the autonomous response engine trained on how to isolate a compromised node as well as to take mitigation acts with other nodes that have a direct nexus to the compromised node.

In another example, the cyber threat prediction engine and its Artificial Intelligence-based simulations use intelligence to cooperate with the cyber-security restoration engine to assist in choosing one or more remediation actions to perform on nodes affected by the cyberattack back to a trusted operational state while still mitigating the cyber threat during an ongoing cyberattack based on effects determined through the simulation of possible remediation actions to perform and their effects on the nodes making up the system being protected and preempt possible escalations of the cyberattack while restoring one or more nodes back to a trusted operational state.

In another example, the cyber security restoration engine restores the one or more nodes in the protected system by cooperating with at least two or more of 1) an Artificial Intelligence model trained to model a normal pattern of life for each node in the protected system, 2) an Artificial Intelligence model trained on what are a possible set of cyber threats and their characteristics and symptoms to identify the cyber threat (e.g. malicious actor/device/file) that is causing a particular node to behave abnormally (e.g. malicious behavior) and fall outside of that node's normal pattern of life, and 3) the autonomous response engine.

Overall, the cyber security appliance 100 and its modules use Artificial Intelligence algorithms configured and trained to perform a first machine-learned task of detecting the cyber threat as well as the autonomous response module 140 can use a combination of user configurable settings on actions to take to mitigate a detected cyber threat, a default set of actions to take to mitigate a detected cyber threat, and Artificial Intelligence algorithms configured and trained to perform a second machine-learned task of taking one or more mitigation actions to mitigate the cyber threat. A cyber security restoration engine 190 deployed in the cyber security appliance 100 uses Artificial Intelligence algorithms configured and trained to perform a third machine-learned task of remediating the system/network being protected back to a trusted operational state. The prediction engine/cyber-attack simulator 105 (e.g., see FIG. 6) uses Artificial Intelligence algorithms configured and trained to perform a fourth machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack.

Referring now to FIG. 6, an exemplary block diagram of embodiment of the cyber-attack simulator 105 (referred to herein as a prediction engine) is shown. The prediction engine conducts Artificial Intelligence-based simulations by constructing a graph of nodes of the system being protected (e.g., a network including (a) the physical devices connecting to the network, any virtualized instances of the network, user accounts in the network, email accounts in the network, etc. as well as (b) connections and pathways through the network) to create a virtualized instance of the network to be tested. As shown in FIG. 6, the various cooperating modules residing in the prediction engine 700 may include, but are not limited to, a collections module 705, a cyberattack generator (e.g. phishing email generator) 710, an email module 715, a network module 720, an analyzer module 725, a payloads module 730 with first and second payloads, a communication module 735, a training module 740, a simulated attack module 750, a cleanup module 755, a scenario module 760, a user interface 765, a reporting module 770, a formatting module 775, an orchestration module 780, and/or an AI classifier 785 with a list of specified classifiers.

The simulated attack module 750 in the prediction engine 700 may be implemented via i) a simulator to model the system being protected and/or ii) a clone creator to spin up a virtual network and create a virtual clone of the system being protected configured to pen-test one or more defenses provided by the cyber security appliance 100. The prediction engine 700 may include and cooperate with one or more AI models 787 trained with machine learning on the contextual knowledge of the organization, such as those in the cyber security appliance 100 or have its own separate model trained with machine learning on the contextual knowledge of the organization and each user's and device's normal pattern of behavior. These trained AI models 787 may be configured to identify data points from the contextual knowledge of the organization and its entities, which may include, but is not limited to, language-based data, email/network connectivity and behavior pattern data, and/or historic knowledgebase data. The prediction engine 700 may use the trained AI models 787 to cooperate with one or more AI classifier(s) 785 by producing a list of specific organization-based classifiers for the AI classifier(s) 785.

The simulated attack module 750 by cooperating with the other modules in the prediction engine 700 is further configured to calculate and run one or more hypothetical simulations of a possible cyberattack and/or of an actual ongoing cyberattack from a cyber threat through an attack pathway through the system being protected. The prediction engine 700 is further configured to calculate, based at least in part on the results of the one or more hypothetical simulations of a possible cyberattack and/or of an actual ongoing cyberattack from a cyber threat through an attack pathway through the system being protected, a risk score for each node (e.g. each device, user account, etc.), the threat risk score being indicative of a possible severity of the compromise and/or chance of compromise prior to an autonomous response action is taken in response to an actual cyberattack of the cyber incident.

The simulated attack module 750 is configured to initially create the network being protected in a simulated or virtual device environment. Additionally, the orchestration module 780 and communications module 735 may be configured to cooperate with the cyber security appliance 100 to securely obtain specific data about specific users, devices, and entities in specific networks of for this specific organization. The training module 740 and simulated attack module 750 in the prediction engine 700 use the obtained specific data to generate one or more specific cyberattacks, such as a phishing email, tailored to those specific users, devices, and/or entities of the specific organization. Many different cyberattacks can be simulated by the AI red team module but a phishing email attack will be used as an example cyberattack.

The prediction engine 700 is communicatively coupled to the cyber security appliance 100, an open source (OS) database server 790, an email system 791 with one or more endpoint computing devices 791A-B, and a network system 792 with one or more entities 793-799, and a restoration engine 745 over one or more networks 746/747. The cyber security appliance 100 may cooperate with the prediction engine 700 to initiate a pen-test in the form of, for example, a software attack, which generates a customized, for example, phishing email to spoof one or more specific users/devices/entities of an organization in an email/network defense system and then looks for any security vulnerabilities, risks, threats, and/or weaknesses potentially gaining access to one or more features and data of that specific user/device/entity.

The prediction engine 700 may be customized and/or driven by a centralized AI using and/or modelling a smart awareness of a variety of specific historical email/network behavior patterns and communications of a specific organization's hierarchy within a specific organization. Such AI modelling may be trained and derived through machine learning and the understanding of the organization itself based on: (i) a variety of OS materials such as any OS materials collected from the OS database server 790 and (ii) its historical awareness of any specific email/network connectivity and behavior patterns to target for that organization as part of an offensive (or attacking) security approach. The training module 740 can contain for reference a database of cyberattack scenarios as well as restoration response scenarios by the restoration engine 745 stored in the database.

The prediction engine 700 may use the orchestration module 780 to implement and orchestrate this offensive approach all the way from an initial social engineering attack at an earlier stage of the pentest to a subsequent payload delivery attack at a later stage of the pentest and so on. The prediction engine 700 is configured to: (i) intelligently initiate a customized cyberattack on the components, for example, in the IT network and email system 791; as well as (ii) subsequently generating a report to highlight and/or raise awareness of one or more key areas of vulnerabilities and/or risks for that organization after observing the intelligently initiated attack (e.g., such key areas may be formatted and reported in a way tailored for that organization using both the formatting and reporting modules, as described below); and (iii) then allow that enterprise (e.g., organization) to be trained on that attack and its impact on those specific security postures, thereby allowing that organization to go in directly to mitigate and improve those compromised security postures going forward, as well as iv) during an actual cyberattack, obtain and ingest data known on the cyberattack, run simulations, and then supply information, for example, to the autonomous response module in the cyber security appliance to mitigate the actual cyberattack.

The prediction engine 700 may cooperate with the cyber security appliance 100 to provide feedback on any successful attacks and detections. For example, in the event that the prediction engine 700 is successful in pentesting any of the organization's entities in the email and network defense systems 791/792, the prediction engine 700 may be configured to at least provide the cyber security appliance 100 (and/or any other predetermined entities) with any feedback on the successful pentest as well as any specifics regarding the processes uses for that successful pentest, such as providing feedback on the specific attack vectors, scenarios, targeted entities, characteristics of the customized phishing emails, payloads, and contextual data, etc., that were used.

The simulated attack module 750 in the prediction engine 700 may be configured with an attack path modeling component (not shown), which is programmed to work out the key paths and devices in a network via running cyberattacks on a simulated or virtual device version of the network under analysis incorporating metrics that feed into that modeling by running simulated cyberattacks on the particulars known about this specific network being protected by the cyber security appliance 100. The attack modeling has been programmed with the knowledge of a layout and connection pattern of each particular network device in a network and a number of connections and/or hops to other network devices in the network. Also, how important a particular device (a key importance) can be determined by the function of that network device, the user(s) associated with that network device, the location of the device within the network and a number of connections and/or hops to other important devices in the network. The attack path modeling component ingests the information for the purposes of modeling and simulating a potential attack against the network and routes that an attacker would take through the network. The attack path modeling component can be constructed with information to i) understand an importance of network nodes in the network compared to other network nodes in the network, and ii) to determine key pathways within the network and vulnerable network nodes in the network that a cyberattack would use during the cyberattack, via modeling the cyberattack on at least one of 1) a simulated device version and 2) a virtual device version of the network under analysis.

The prediction engine may be implemented via i) a simulator to model the system being protected and/or ii) a clone creator to spin up a virtual network and create a virtual clone of the system being protected configured to pen test one or more defenses provided by scores based on both the level of confidence that the cyber threat is a viable threat and the severity of the cyber threat (e.g., attack type where ransomware attacks has greater severity than phishing attack; degree of infection; computing devices likely to be targeted, etc.). The threat risk scores be used to rank alerts that may be directed to enterprise or computing device administrators. This risk assessment and ranking is conducted to avoid frequent “false positive” alerts that diminish the degree of reliance/confidence on the cyber security appliance 100. The prediction engine may include and cooperate with one or more AI models trained with machine learning on the contextual knowledge of the organization. These trained AI models may be configured to identify data points from the contextual knowledge of the organization and its entities, which may include, but is not limited to, language-based data, email/network connectivity and behavior pattern data, and/or historic knowledgebase data. The prediction engine may use the trained AI models to cooperate with one or more AI classifier(s) by producing a list of specific organization-based classifiers for the AI classifier. The prevent engine is further configured to calculate, based at least in part on the results of the one or more hypothetical simulations of a possible cyberattack and/or of an actual ongoing cyberattack from a cyber threat determine a risk score for each node (e.g., each device, user account, etc.), the threat risk score being indicative of a possible severity of the compromise prior to an autonomous response action is taken in response to the actual cyberattack of the cyber incident.

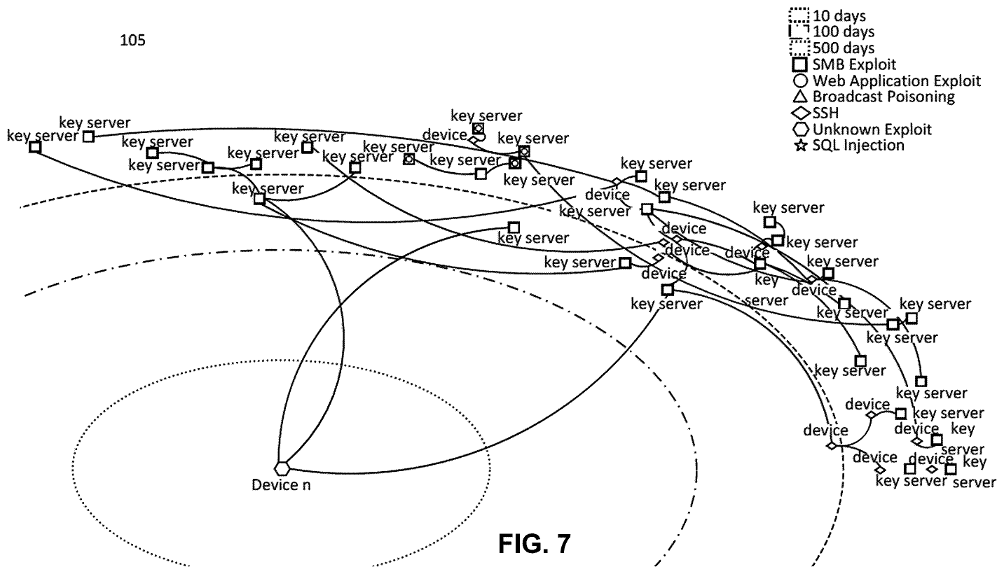

FIG. 7 illustrates a diagram of an embodiment of the cyber security appliance and its Artificial Intelligence-based simulations constructing an example graph of nodes in an example network and simulating how the cyberattack might likely progress in the future tailored with an innate understanding of a normal behavior of the nodes in the system being protected and a current operational state of each node in the graph of the protected system during simulations of cyberattacks. The prediction engine 700 plots the attack path through the nodes and estimated times to reach critical nodes in the network. The cyberattack simulation modeling is run to identify the routes, difficulty, and time periods from certain entry notes to certain key servers. The simulations of the cyber-attack by the cyber threat from one compromised entry point such as Device n to a key server can take 10 days, 100 days, etc. depending on normal behavior of Device n, security settings of the network devices in the different nodes of the network, etc.

The attack path modeling component in the simulated attack module 750 cooperating with the other modules in the prediction engine are configured to determine the key pathways within the network and the vulnerable network nodes in the network that the cyberattack would use during the cyberattack, via the modeling of the cyberattack on at least one of 1) the simulated device version and 2) the virtual device version of the network under analysis via using the actual detected vulnerabilities of each network node, a predicted frequency of remediation of those vulnerabilities within a specific network device in the network without a notice from the restoration engine 745, and an importance of the key network nodes with the actual vulnerabilities compared to other network nodes in the network.

The modules essentially seed the attack path modeling component with weakness scores that provide current data, customized to each user account and/or network device, which then allows the artificial intelligence running the attack path simulation to choose entry network nodes into the network with more accuracy as well as plot the attack path through the nodes and estimated times to reach critical nodes in the network much more accurately based on the actual current operational condition of the many user accounts and network devices in the network. The attack simulation modeling can be run to identify the routes, difficulty, and time periods from certain entry notes to certain key servers.

Note, the cyber threat analyst module 120 in the cyber security appliance 100 of FIG. 1 as well as the prediction engine of FIG. 6 may use any unusual, detected behavior deviating from the normal behavior and then build a sequence/chain of unusual behavior and the causal links between the sequence/chain of unusual behavior to detect any potential cyber threats. For example, as shown in FIG. 4, the cyber security appliance 100 and the prediction engine may determine the unusual patterns by analyzing i) what activities/events/alerts that fall outside of the window of what is the normal pattern of life for that network/system/entity/device/user under analysis; and (ii) then pulling in and analyzing the pattern of the behavior of the activities/events/alerts that are in the normal pattern of life but also connect to the indictors for a possible cyberattack, to determine whether that pattern is indicative of a behavior of a malicious actor, such as a human, program, and/or any other cyber harmful threat.

The prediction engine and its Artificial Intelligence-based simulations use artificial intelligence to cooperate with the restoration engine 745 to assist in choosing one or more remediation actions to perform on nodes affected by the cyberattack back to a trusted operational state while still mitigating the cyber threat during an ongoing cyberattack based on effects determined through the simulation of possible remediation actions to perform and their effects on the nodes making up the system being protected and preempt possible escalations of the cyberattack while restoring one or more nodes back to a trusted operational state. Thus, for example, the restoration engine 745 restores the one or more nodes in the protected system by cooperating with any of 1) an AI model trained to model a normal pattern of life for each node in the protected system, 2) an AI model trained on what are a possible set of cyber threats and their characteristics and symptoms to identify the cyber threat (e.g. malicious actor/device/file) that is causing a particular node to behave abnormally (e.g. malicious behavior) and fall outside of that node's normal pattern of life, and 3) the autonomous response module 140.

The restoration engine 745 can reference both i) a database of restoration response scenarios stored in the database and ii) a prediction engine configured to run AI-based simulations and use the operational state of each node in the graph of the protected system during simulations of cyberattacks on the protected system to restore 1) each node compromised by the cyber threat and 2) promote protection of the corresponding nodes adjacent to a compromised node in the graph of the protected system.

The restoration engine 745 can prioritize among the one or more nodes to restore, which nodes to remediate and an order of the nodes to remediate, based on two or more factors including i) a dependency order needed for the recovery efforts, ii) an importance of a particular recovered node compared to other nodes in the system being protected, iii) a level of compromise of a particular node contemplated to be restored, iv) an urgency to recover that node compared to whether containment of the cyber threat was successful, v) a list of a most important things in the protected system to recover earliest, and vi) factoring in a result of a cyberattack simulation being run during the cyberattack by the prediction engine 700 to predict a likely result regarding the cyberattack when that node is restored.

An interactive response loop exists between the restoration engine 745, the cyber security appliance 100, and the prediction engine 700. The restoration engine 745, the cyber security appliance 100, and the prediction engine 700 can be configured to cooperate to combine an understanding of normal operations of the nodes making up the devices and users in the system being protected by the cyber security appliance 100, an understanding emerging cyber threats, an ability to contain those emerging cyber threats, and a restoration of the nodes of the system to heal the system with an adaptive feedback between the multiple AI-based engines in light of simulations of the cyberattack to predict what might occur in the nodes in the system based on the progression of the attack so far, mitigation actions taken to contain those emerging cyber threats and remediation actions taken to heal the nodes using the simulated cyberattack information. The multiple AI-based engines have communication hooks in between them to exchange a significant amount of behavioral metrics including data between the multiple AI-based engines to work in together to provide an overall cyber threat response.

The cyber security appliance 100 and its modules use Artificial Intelligence algorithms configured and trained to perform a first machine-learned task of detecting the cyber threat as well as the autonomous response module 140 can use a combination of user configurable settings on actions to take to mitigate a detected cyber threat, a default set of actions to take to mitigate a detected cyber threat, and Artificial Intelligence algorithms configured and trained to perform a second machine-learned task of taking one or more mitigation actions to mitigate the cyber threat. The restoration engine 745 uses Artificial Intelligence algorithms configured and trained to perform a third machine-learned task of remediating the system/network being protected back to a trusted operational state. The prediction engine uses Artificial Intelligence algorithms configured and trained to perform a fourth machine-learned task of AI-based simulations of cyberattacks to assist in determining 1) how a simulated cyberattack might occur in the system being protected, and 2) how to use the simulated cyberattack information to preempt possible escalations of an ongoing actual cyberattack. In an example, the autonomous response module 140 uses its intelligence to cooperate with the prediction engine and its AI-based simulations to choose and initiate an initial set of one or more mitigation actions indicated as a preferred targeted initial response to the detected cyber threat by autonomously initiating those mitigation actions to defend against the detected cyber threat, rather than a human taking an action.

Training of AI Pre-Deployment and then During Deployment

In step 1, an initial training of the Artificial Intelligence model trained on cyber threats can occur using unsupervised learning and/or supervised learning on characteristics and attributes of known potential cyber threats including malware, insider threats, and other kinds of cyber threats that can occur within that domain. Each Artificial Intelligence can be programmed and configured with the background information to understand and handle particulars, including different types of data, protocols used, types of devices, user accounts, etc. of the system being protected. The Artificial Intelligence pre-deployment can all be trained on the specific machine learning task that they will perform when put into deployment. For example, the AI model, such as AI model(s) 160 or example (hereinafter “AI model(s) 160”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the AI model(s) 160 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 100, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the AI models 160 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

Thus, a deployed Artificial Intelligence model 160 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of one or more Artificial Intelligence models 160 trained with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of one or more Artificial Intelligence models trained on a normal pattern of life of entities in the system can occur. Initial training of one or more Artificial Intelligence models trained with machine learning on a behavior of the pattern of life of the entities in the network/domain can occur where each type of network and/or domain will generally have some common typical behavior with each model trained specifically to understand components/devices, protocols, activity level, etc. to that type of network/system/domain. What is normal behavior of each entity within that system can be established either prior to deployment and then adjusted during deployment or alternatively the model can simply be placed into an observation mode for an initial week or two when first deployed on a network/domain in order to establish an initial normal behavior for entities in the network/domain under analysis. During deployment, what is considered normal behavior will change as each different entity's behavior changes and will be reflected through the use of unsupervised learning in the model such as various Bayesian techniques, clustering, etc. The AI models 160 can be implemented with various mechanisms such neural networks, decision trees, etc. and combinations of these. Likewise, one or more supervised machine learning AI models 160 may be trained to create possible hypotheses and perform cyber threat investigations on agnostic examples of past historical incidents of detecting a multitude of possible types of cyber threat hypotheses previously analyzed by human cyber security analyst. More on the training of AI models 160 are trained to create one or more possible hypotheses and perform cyber threat investigations will be discussed later.

At its core, the self-learning AI models 160 that model the normal behavior (e.g. a normal pattern of life) of entities in the network mathematically characterizes what constitutes ‘normal’ behavior, based on the analysis of a large number of different measures of a device's network behavior—packet traffic and network activity/processes including server access, data volumes, timings of events, credential use, connection type, volume, and directionality of, for example, uploads/downloads into the network, file type, packet intention, admin activity, resource and information requests, command sent, etc.

### Clustering Methods

In order to model what should be considered as normal for a device or cloud container, its behavior can be analyzed in the context of other similar entities on the network. The AI models (e.g., AI model(s) 160) can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cyber threat analysis. AI models trained on forming and investigating hypotheses on what are a possible set of cyber threats can be trained initially with supervised learning. Thus, these AI models can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful. More on the training of the AI models that are trained to create one or more possible hypotheses and perform cyber threat investigations will be discussed later.

Next, the various Artificial Intelligence models and AI classifiers combine use of unsupervised and supervised machine learning to learn ‘on the job’—it does not depend upon solely knowledge of previous cyber threat attacks. The Artificial Intelligence models and classifiers combine use of unsupervised and supervised machine learning constantly revises assumptions about behavior, using probabilistic mathematics, that is always up to date on what a current normal behavior is, and not solely reliant on human input. The Artificial Intelligence models and classifiers combine use of unsupervised and supervised machine learning on cyber security is capable of seeing hitherto undiscovered cyber events, from a variety of threat sources, which would otherwise have gone unnoticed.

Next, these cyber threats can include, for example: Insider threat—malicious or accidental, Zero-day attacks—previously unseen, novel exploits, latent vulnerabilities, machine-speed attacks—ransomware and other automated attacks that propagate and/or mutate very quickly, Cloud and SaaS-based attacks, other silent and stealthy attacks advance persistent threats, advanced spear-phishing, etc.

### Ranking the Cyber Threat

The assessment module 125 and/or cyber threat analyst module 120 of FIG. 1 can cooperate with the AI model(s) 160 trained on possible cyber threats to use AI algorithms to account for ambiguities by distinguishing between the subtly differing levels of evidence that characterize network data. Instead of generating the simple binary outputs ‘malicious’ or ‘benign’, the AI's mathematical algorithms produce outputs marked with differing degrees of potential threat. This enables users of the system to rank alerts and notifications to the enterprise security administrator in a rigorous manner, and prioritize those which most urgently require action. Meanwhile, it also assists to avoid the problem of numerous false positives associated with simply a rule-based approach.

### More on the Operation of the Cyber Security Appliance 100

As discussed in more detail below, the analyzer module 115 and/or cyber threat analyst module 120 can cooperate with the one or more unsupervised AI (machine learning) model 160 trained on the normal pattern of life/normal behavior in order to perform anomaly detection against the actual normal pattern of life for that system to determine whether an anomaly (e.g., the identified abnormal behavior and/or suspicious activity) is malicious or benign. In the operation of the cyber security appliance 100, the emerging cyber threat can be previously unknown, but the emerging threat landscape data 170 representative of the emerging cyber threat shares enough (or does not share enough) in common with the traits from the AI models 160 trained on cyber threats to now be identified as malicious or benign. Note, if later confirmed as malicious, then the AI models 160 trained with machine learning on possible cyber threats can update their training. Likewise, as the cyber security appliance 100 continues to operate, then the one or more AI models trained on a normal pattern of life for each of the entities in the system can be updated and trained with unsupervised machine learning algorithms. The analyzer module 115 can use any number of data analysis processes (discussed more in detail below and including the agent analyzer data analysis process here) to help obtain system data points so that this data can be fed and compared to the one or more AI models trained on a normal pattern of life, as well as the one or more machine learning models trained on potential cyber threats, as well as create and store data points with the connection finger prints.

All of the above AI models 160 can continually learn and train with unsupervised machine learning algorithms on an ongoing basis when deployed in their system that the cyber security appliance 100 is protecting. Thus, learning and training on what is normal behavior for each user, each device, and the system overall and lowering a threshold of what is an anomaly.

### Anomaly Detection/Deviations

Anomaly detection can discover unusual data points in your dataset. Anomaly can be a synonym for the word ‘outlier’. Anomaly detection (or outlier detection) is the identification of rare items, events or observations which raise suspicions by differing significantly from the majority of the data. Anomalous activities can be linked to some kind of problems or rare events. Since there are tons of ways to induce a particular cyber-attack, it is very difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous. The AI unsupervised learning model learns patterns from the features in the day-to-day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two-level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold (a parameter that can be tuned over time through the self-learning), where feature values with probability larger than this threshold indicate that the given feature's values are non-anomalous, otherwise it is anomalous. Note, this anomaly detection can determine that a data point is anomalous/non-anomalous on the basis of a particular feature. In reality, the cyber security appliance 100 should not flag a data point as an anomaly based on a single feature. Merely, when a combination of all the probability values for all features for a given data point is calculated can the modules cooperating with the AI model of normal behavior can say with high confidence whether a data point is an anomaly or not.

Again, the AI models trained on a normal pattern of life of entities in a network (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. Please reference U.S. Pat. No. 10,701,093 granted Jun. 30, 2020, titled “Anomaly alert system for cyber threat detection” for an example Bayesian probabilistic approach, which is incorporated by reference in its entirety. In addition, please reference US patent publication number “US2021273958A1 filed Feb. 26, 2021, titled “Multi-stage anomaly detection for process chains in multi-host environments” for another example anomalous behavior detector using a recurrent neural network and a bidirectional long short-term memory (LSTM), which is incorporated by reference in its entirety. In addition, please reference US patent publication number “US2020244673A1, filed Apr. 23, 2019, titled “Multivariate network structure anomaly detector,” which is incorporated by reference in its entirety, for another example anomalous behavior detector with a Multivariate Network and Artificial Intelligence classifiers.

Next, as discussed further below, as discussed further below, during pre-deployment the cyber threat analyst module 120 and the analyzer module 115 can use data analysis processes and cooperate with AI model(s) 160 trained on forming and investigating hypotheses on what are a possible set of cyber threats. In addition, another set of AI models can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful.

Similarly, during deployment, the data analysis processes (discussed herein) used by the analyzer module 115 can use unsupervised machine learning to update the initial training learned during pre-deployment, and then update the training with unsupervised learning algorithms during the cyber security appliance's 100 deployment in the system being protected when various different steps to either i) support or ii) refute the possible set of cyber threats hypotheses worked better or worked worse.

The AI model(s) 160 trained on a normal pattern of life of entities in a domain under analysis may perform the threat detection through a probabilistic change in a normal behavior through the application of, for example, an unsupervised Bayesian mathematical model to detect a behavioral change in computers and computer networks. The Bayesian probabilistic approach can determine periodicity in multiple time series data and identify changes across single and multiple time series data for the purpose of anomalous behavior detection. In an example, a system being protected can include both email and IT network domains under analysis. Thus, email and IT network raw sources of data can be examined along with a large number of derived metrics that each produce time series data for the given metric.

### Additional Module Interactions

Referring back to FIG. 1, the gather module 110 cooperates with the data store 135. The data store 135 stores comprehensive logs for network traffic observed. These logs can be filtered with complex logical queries and each IP packet can be interrogated on a vast number of metrics in the network information stored in the data store. Similarly, other domain's communications and data, such as emails, logs, etc. may be collected and stored in the data store 135. The gather module 110 may consist of multiple automatic data gatherers that each look at different aspects of the data depending on the particular hypothesis formed for the analyzed event. The data relevant to each type of possible hypothesis can be automatically pulled from additional external and internal sources. Some data is pulled or retrieved by the gather module 110 for each possible hypothesis.

The data store 135 can store the metrics and previous threat alerts associated with network traffic for a period of time, which is, by default, at least 27 days. This corpus of data is fully searchable. The cyber security appliance 100 works with network probes to monitor network traffic and store and record the data and metadata associated with the network traffic in the data store.

The gather module 110 may have a process identifier classifier. The process identifier classifier can identify and track each process and device in the network, under analysis, making communication connections. The data store 135 cooperates with the process identifier classifier to collect and maintain historical data of processes and their connections, which is updated over time as the network is in operation. In an example, the process identifier classifier can identify each process running on a given device along with its endpoint connections, which are stored in the data store. Similarly, data from any of the domains under analysis may be collected and compared.

Examples of domains/networks under analysis being protected can include any of i) an Informational Technology network, ii) an Operational Technology network, iii) a Cloud service, iv) a SaaS service, v) an endpoint device, vi) an email domain, and vii) any combinations of these. A domain module is constructed and coded to interact with and understand a specific domain.

For instance, the first domain module 145 may operate as an IT network module configured to receive information from and send information to, in this example, IT network-based sensors (i.e., probes, taps, etc.). The first domain module 145 also has algorithms and components configured to understand, in this example, IT network parameters, IT network protocols, IT network activity, and other IT network characteristics of the network under analysis. The second domain module 150 is, in this example, an email module. The second domain module 150 can be an email network module configured to receive information from and send information to, in this example, email-based sensors (i.e., probes, taps, etc.). The second domain module 150 also has algorithms and components configured to understand, in this example, email parameters, email protocols and formats, email activity, and other email characteristics of the network under analysis. Additional domain modules can also collect domain data from another respective domain.

The coordinator module 155 is configured to work with various machine learning algorithms and relational mechanisms to i) assess, ii) annotate, and/or iii) position in a vector diagram, a directed graph, a relational database, etc., activity including events occurring, for example, in the first domain compared to activity including events occurring in the second domain. The domain modules can cooperate to exchange and store their information with the data store.

The process identifier classifier (not shown) in the gather module 110 can cooperate with additional classifiers in each of the domain modules 145/150 to assist in tracking individual processes and associating them with entities in a domain under analysis as well as individual processes and how they relate to each other. The process identifier classifier can cooperate with other trained AI classifiers in the modules to supply useful metadata along with helping to make logical nexuses.

A feedback loop of cooperation exists between the gather module 110, the analyzer module 115, AI model(s) 160 trained on different aspects of this process, and the cyber threat analyst module 120 to gather information to determine whether a cyber threat is potentially attacking the networks/domains under analysis.

### Determination of Whether Something is Likely Malicious

In the following examples the analyzer module 115 and/or cyber threat analyst module 120 can use multiple factors to the determination of whether a process, event, object, entity, etc. is likely malicious.

In an example, the analyzer module 115 and/or cyber threat analyst module 120 can cooperate with one or more of the AI model(s) 160 trained on certain cyber threats to detect whether the anomalous activity detected, such as suspicious email messages, exhibit traits that may suggest a malicious intent, such as phishing links, scam language, sent from suspicious domains, etc. The analyzer module 115 and/or cyber threat analyst module 120 can also cooperate with one of more of the AI model(s) 160 trained on potential IT based cyber threats to detect whether the anomalous activity detected, such as suspicious IT links, URLs, domains, user activity, etc., may suggest a malicious intent as indicated by the AI models trained on potential IT based cyber threats.

In the above example, the analyzer module 115 and/or the cyber threat analyst module 120 can cooperate with the one or more AI models 160 trained with machine learning on the normal pattern of life for entities in an email domain under analysis to detect, in this example, anomalous emails which are detected as outside of the usual pattern of life for each entity, such as a user, email server, etc., of the email network/domain. Likewise, the analyzer module 115 and/or the cyber threat analyst module 120 can cooperate with the one or more AI models trained with machine learning on the normal pattern of life for entities in a second domain under analysis (in this example, an IT network) to detect, in this example, anomalous network activity by user and/or devices in the network, which is detected as outside of the usual pattern of life (e.g. abnormal) for each entity, such as a user or a device, of the second domain's network under analysis.

Thus, the analyzer module 115 and/or the cyber threat analyst module 120 can be configured with one or more data analysis processes to cooperate with the one or more of the AI model(s) 160 trained with machine learning on the normal pattern of life in the system, to identify an anomaly of at least one of i) the abnormal behavior, ii) the suspicious activity, and iii) the combination of both, from one or more entities in the system. Note, other sources, such as other model breaches, can also identify at least one of i) the abnormal behavior, ii) the suspicious activity, and iii) the combination of both to trigger the investigation.

Accordingly, during this cyber threat determination process, the analyzer module 115 and/or the cyber threat analyst module 120 can also use AI classifiers that look at the features and determine a potential maliciousness based on commonality or overlap with known characteristics of malicious processes/entities. Many factors including anomalies that include unusual and suspicious behavior, and other indicators of processes and events are examined by the one or more AI models 160 trained on potential cyber threats and/or the AI classifiers looking at specific features for their malicious nature in order to make a determination of whether an individual factor and/or whether a chain of anomalies is determined to be likely malicious.

Initially, in this example of activity in an IT network analysis, the rare JA3 hash and/or rare user agent connections for this network coming from a new or unusual process are factored just like in the first wireless domain suspicious wireless signals are considered. These are quickly determined by referencing the one or more of the AI model(s) 160 trained with machine learning on the pattern of life of each device and its associated processes in the system. Next, the analyzer module 115 and/or the cyber threat analyst module 120 can have an external input to ingest threat intelligence from other devices in the network cooperating with the cyber security appliance 100. Next, the analyzer module 115 and/or the cyber threat analyst module 120 can look for other anomalies, such as model breaches, while the AI models trained on potential cyber threats can assist in examining and factoring other anomalies that have occurred over a given timeframe to see if a correlation exists between a series of two or more anomalies occurring within that time frame.

The analyzer module 115 and/or the cyber threat analyst module 120 can combine these Indicators of Compromise (e.g., unusual network JA3, unusual device JA3, . . . ) with many other weak indicators to detect the earliest signs of an emerging threat, including previously unknown threats, without using strict blacklists or hard-coded thresholds. However, the AI classifiers can also routinely look at blacklists, etc. to identify maliciousness of features looked at.

Another example of features may include a deeper analysis of endpoint data. This endpoint data may include domain metadata, which can reveal peculiarities such as one or more indicators of potentially a malicious domain (i.e., its URL). The deeper analysis may assist in confirming an analysis to determine that indeed a cyber threat has been detected. The analyzer module 115 can also look at factors of how rare the endpoint connection is, how old the endpoint is, where geographically the endpoint is located, how a security certificate associated with a communication is verified only by an endpoint device or by an external 3rd party, just to name a few additional factors. The analyzer module 115 (and similarly the cyber threat analyst module) can then assign weighting given to these factors in the machine learning that can be supervised based on how strongly that characteristic has been found to match up to actual malicious sites in the training.

In another AI classifier to find potentially malicious indicators, the agent analyzer data analysis process in the analyzer module 115 and/or cyber threat analyst module 120 may cooperate with the process identifier classifier to identify all of the additional factors of i) are one or more processes running independently of other processes, ii) are the one or more processes running independent are recent to this network, and iii) are the one or more processes running independent connect to the endpoint, which the endpoint is a rare connection for this network, which are referenced and compared to one or more AI models trained with machine learning on the normal behavior of the pattern of life of the system.

Note, a user agent, such as a browser, can act as a client in a network protocol used in communications within a client-server distributed computing system. In particular, the Hypertext Transfer Protocol (HTTP) identifies the client software originating (an example user agent) the request, using a user-agent header, even when the client is not operated by a user. Note, this identification can be faked, so it is only a weak indicator of the software on its own, but when compared to other observed user agents on the device, this can be used to identify possible software processes responsible for requests.

The analyzer module 115 and/or the cyber threat analyst module 120 may use the agent analyzer data analysis process that detects a potentially malicious agent previously unknown to the system to start an investigation on one or more possible cyber threat hypotheses. The determination and output of this step is what are possible cyber threats that can include or be indicated by the identified abnormal behavior and/or identified suspicious activity identified by the agent analyzer data analysis process.

In an example, the cyber threat analyst module 120 can use the agent analyzer data analysis process and the AI models(s) trained on forming and investigating hypotheses on what are a possible set of cyber threats to use the machine learning and/or set scripts to aid in forming one or more hypotheses to support or refute each hypothesis. The cyber threat analyst module 120 can cooperate with the AI models trained on forming and investigating hypotheses to form an initial set of possible hypotheses, which needs to be intelligently filtered down. The cyber threat analyst module 120 can be configured to use the one or more supervised machine learning models trained on i) agnostic examples of a past history of detection of a multitude of possible types of cyber threat hypotheses previously analyzed by human, who was a cyber security professional, ii) a behavior and input of how a plurality of human cyber security analysts make a decision and analyze a risk level regarding and a probability of a potential cyber threat, iii) steps to take to conduct an investigation start with anomaly via learning how expert humans tackle investigations into specific real and synthesized cyber threats and then the steps taken by the human cyber security professional to narrow down and identify a potential cyber threat, and iv) what type of data and metrics that were helpful to further support or refute each of the types of cyber threats, in order to determine a likelihood of whether the abnormal behavior and/or suspicious activity is either i) malicious or ii) benign?

The cyber threat analyst module 120 using AI models, scripts and/or rules based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

The cyber threat analyst module 120 using AI models, scripts and/or rules-based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

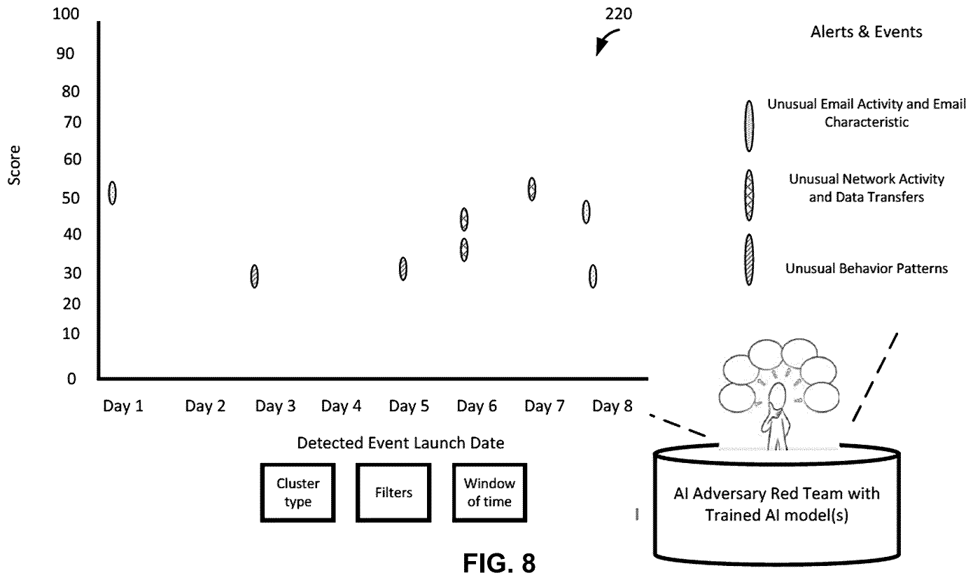

In an example, a behavioral pattern analysis of what are the unusual behaviours of the network/system/device/user under analysis by the machine learning models may be as follows. The coordinator module can tie the alerts, activities, and events from, in this example, the email domain to the alerts, activities, and events from the IT network domain. FIG. 8 illustrates a graph 220 of an embodiment of an example chain of unusual behaviour for, in this example, the email activities and IT network activities deviating from a normal pattern of life in connection with the rest of the system/network under analysis. The cyber threat analyst module 120 and/or analyzer module can cooperate with one or more machine learning models. The one or more machine learning models are trained and otherwise configured with mathematical algorithms to infer, for the cyber-threat analysis, ‘what is possibly happening with the chain of distinct alerts, activities, and/or events, which came from the unusual pattern,’ and then assign a threat risk associated with that distinct item of the chain of alerts and/or events forming the unusual pattern. The unusual pattern can be determined by examining initially what activities/events/alerts that do not fall within the window of what is the normal pattern of life for that network/system/device/user under analysis can be analysed to determine whether that activity is unusual or suspicious. A chain of related activity that can include both unusual activity and activity within a pattern of normal life for that entity can be formed and checked against individual cyber threat hypothesis to determine whether that pattern is indicative of a behaviour of a malicious actor—human, program, or other threat. The cyber threat analyst module 120 can go back and pull in some of the normal activities to help support or refute a possible hypothesis of whether that pattern is indicative of a behavior of a malicious actor.

An example behavioral pattern included in the chain is shown in the graph over a time frame of, an example, 7 days. The cyber threat analyst module 120 detects a chain of anomalous behavior of unusual data transfers three times, unusual characteristics in emails in the monitored system three times which seem to have some causal link to the unusual data transfers. Likewise, twice unusual credentials attempted the unusual behavior of trying to gain access to sensitive areas or malicious IP addresses and the user associated with the unusual credentials trying unusual behavior has a causal link to at least one of those three emails with unusual characteristics. Again, the cyber security appliance 100 can go back and pull in some of the normal activities to help support or refute a possible hypothesis of whether that pattern is indicative of a behaviour of a malicious actor. The analyser module can cooperate with one or more models trained on cyber threats and their behaviour to try to determine if a potential cyber threat is causing these unusual behaviours. The cyber threat analyst module 120 can put data and entities into 1) a directed graph and nodes in that graph that are overlapping or close in distance have a good possibility of being related in some manner, 2) a vector diagram, 3) a relational database, and 4) other relational techniques that will at least be examined to assist in creating the chain of related activity connected by causal links, such as similar time, similar entity and/or type of entity involved, similar activity, etc., under analysis. If the pattern of behaviours under analysis is believed to be indicative of a malicious actor, then a score of how confident is the system in this assessment of identifying whether the unusual pattern was caused by a malicious actor is created. Next, also assigned is a threat level score or probability indicative of what level of threat does this malicious actor pose. Lastly, the cyber security appliance 100 is configurable in a user interface, by a user, enabling what type of automatic response actions, if any, the cyber security appliance 100 may take when different types of cyber threats, indicated by the pattern of behaviours under analysis, that are equal to or above a configurable level of threat posed by this malicious actor.

The autonomous response engine of the cyber security system is configured to take one or more autonomous mitigation actions to mitigate the cyber threat during the cyberattack by the cyber threat. The autonomous response engine is configured to reference an Artificial Intelligence model trained to track a normal pattern of life for each node of the protected system to perform an autonomous act of restricting a potentially compromised node having i) an actual indication of compromise and/or ii) merely adjacent to a known compromised node, to merely take actions that are within that node's normal pattern of life to mitigate the cyber threat. Similarly named components in the cyber security restoration engine 190 can operate and function similar to as described for the detection engine.

The chain of the individual alerts, activities, and events that form the pattern including one or more unusual or suspicious activities into a distinct item for cyber-threat analysis of that chain of distinct alerts, activities, and/or events. The cyber-threat module may reference the one or more machine learning models trained on, in this example, e-mail threats to identify similar characteristics from the individual alerts and/or events forming the distinct item made up of the chain of alerts and/or events forming the unusual pattern.

### An Assessment of the Cyber Threat in Order to Determine Appropriate Autonomous Actions, for Example, Those by the Autonomous Response Engine

In the next step, the analyzer module 115 and/or cyber threat analyst module 120 generates one or more supported possible cyber threat hypotheses from the possible set of cyber threat hypotheses. The analyzer module 115 generates the supporting data and details of why each individual hypothesis is supported or not. The analyzer module 115 can also generate one or more possible cyber threat hypotheses and the supporting data and details of why they were refuted.

In general, the analyzer module 115 cooperates with the following three sources. The analyzer module 115 cooperates with the one or more of the AI model(s) 160 trained on cyber threats to determine whether an anomaly such as the abnormal behavior and/or suspicious activity is either 1) malicious or 2) benign when the potential cyber threat under analysis is previously unknown to the cyber security appliance 100. The analyzer module 115 cooperates with one or more of the AI model(s) 160 trained on a normal pattern of life of entities in the network under analysis. The analyzer module 115 cooperates with various AI-trained classifiers. With all of these sources, when they input information that indicates a potential cyber threat that is i) severe enough to cause real harm to the network under analysis and/or ii) a close match to known cyber threats, then the analyzer module can make a final determination to confirm that a cyber threat likely exists and send that cyber threat to the assessment module to assess the threat score associated with that cyber threat. Certain model breaches will always trigger a potential cyber threat that the analyzer will compare and confirm the cyber threat.

In the next step, the assessment module 125 with the AI classifiers is configured to cooperate with the analyzer module 115. The analyzer module 115 supplies the identity of the supported possible cyber threat hypotheses from the possible set of cyber threat hypotheses to the assessment module 125. The assessment module 125 with the AI classifiers cooperates with the one or more of the AI model(s) 160 trained on possible cyber threats can make a determination on whether a cyber threat exists and what level of severity is associated with that cyber threat. The assessment module 125 with the AI classifiers cooperates with one or more of the AI model(s) 160 trained on possible cyber threats in order assign a numerical assessment of a given cyber threat hypothesis that was found likely to be supported by the analyzer module 115 with the one or more data analysis processes, via the abnormal behavior, the suspicious activity, or the collection of system data points. The assessment module 125 with the AI classifiers output can be a score (ranked number system, probability, etc.) that a given identified process is likely a malicious process. The assessment module 125 with the AI classifiers can be configured to assign a numerical assessment, such as a probability, of a given cyber threat hypothesis that is supported and a threat level posed by that cyber threat hypothesis which was found likely to be supported by the analyzer module 115, which includes the abnormal behavior or suspicious activity as well as one or more of the collection of system data points, with the one or more AI models trained on possible cyber threats.

The cyber threat analyst module 120 in the AI-based cyber security appliance 100 component provides an advantage over competitors' products as it reduces the time taken for cyber security investigations, provides an alternative to manpower for small organizations and improves detection (and remediation) capabilities within the cyber security appliance 100. The AI-based, cyber threat analyst module 120 performs its own computation of threat and identifies interesting network events with one or more processers. These methods of detection and identification of threat all add to the above capabilities that make the cyber threat analyst module 120 a desirable part of the cyber security appliance 100. The cyber threat analyst module 120 offers a method of prioritizing which is not just a summary or highest score alert of an event evaluated by itself equals the worst and prevents more complex attacks being missed because their composite parts/individual threats only produced low-level alerts.

The AI classifiers can be part of the assessment module 125, which scores the outputs of the analyzer module 115. Again, as for the other AI classifiers discussed, the AI classifier can be coded to take in multiple pieces of information about an entity, object, and/or thing and based on its training and then output a prediction about the entity, object, or thing. Given one or more inputs, the AI classifier model will try to predict the value of one or more outcomes. The AI classifiers cooperate with the range of data analysis processes that produce features for the AI classifiers. The various techniques cooperating here allow anomaly detection and assessment of a cyber threat level posed by a given anomaly; but more importantly, an overall cyber threat level posed by a series/chain of correlated anomalies under analysis.

In the next step, the formatting module 130 can generate an output such as a printed or electronic report with the relevant data. The formatting module 130 can cooperate with both the analyzer module 115 and the assessment module 125 depending on what the user wants to be reported. The formatting module 130 is configured to format, present a rank for, and output one or more supported possible cyber threat hypotheses from the assessment module into a formalized report, from a one or more report templates populated with the data for that incident. The formatting module 130 is configured to format, present a rank for, and output one or more detected cyber threats from the analyzer module or from the assessment module into a formalized report, from a one or more report templates populated with the data for that incident. Many different types of formalized report templates exist to be populated with data and can be outputted in an easily understandable format for a human user's consumption. The formalized report on the template is outputted for a human user's consumption in a medium of any of 1) printable report, 2) presented digitally on a user interface, 3) in a machine-readable format for further use in machine-learning reinforcement and refinement, or 4) any combination of the three. The formatting module 130 is further configured to generate a textual write up of an incident report in the formalized report for a wide range of breaches of normal behavior, used by the AI models trained with machine learning on the normal behavior of the system, based on analyzing previous reports with one or more models trained with machine learning on assessing and populating relevant data into the incident report corresponding to each possible cyber threat. The formatting module 130 can generate a threat incident report in the formalized report from a multitude of a dynamic human-supplied and/or machine created templates corresponding to different types of cyber threats, each template corresponding to different types of cyber threats that vary in format, style, and standard fields in the multitude of templates. The formatting module 130 can populate a given template with relevant data, graphs, or other information as appropriate in various specified fields, along with a ranking of a likelihood of whether that hypothesis cyber threat is supported and its threat severity level for each of the supported cyber threat hypotheses, and then output the formatted threat incident report with the ranking of each supported cyber threat hypothesis, which is presented digitally on the user interface and/or printed as the printable report.

In the next step, the assessment module 125 with the AI classifiers, once armed with the knowledge that malicious activity is likely occurring/is associated with a given process from the analyzer module 115, then cooperates with the autonomous response module 140 to take an autonomous action such as i) deny access in or out of the device or the network ii) shutdown activities involving a detected malicious agent, iii) restrict devices and/or user's to merely operate within their particular normal pattern of life, iv) remove some user privileges/permissions associated with the compromised user account, etc.

The autonomous response module 140, rather than a human taking an action, can be configured to cause one or more rapid autonomous actions in response to be taken to counter the cyber threat. A user interface for the response module can program the autonomous response module 140 i) to merely make a suggested response to take to counter the cyber threat that will be presented on a display screen and/or sent by a notice to an enterprise security administrator for explicit authorization when the cyber threat is detected or ii) to autonomously take a response to counter the cyber threat without a need for a human to approve the response when the cyber threat is detected. The autonomous response module 140 will then send a notice of the autonomous response as well as display the autonomous response taken on the display screen. Example autonomous responses may include cut off connections, shutdown devices, change the privileges of users, delete and remove malicious links in emails, slow down a transfer rate, cooperate with other security devices such as a firewall to trigger its autonomous actions, remove virtual machine (VM) permissions, modify networking rules, modify identity and access management (IAM) user or role policies, and other autonomous actions against the devices and/or users. The autonomous response module 140 uses one or more of the AI model(s) 160 that are configured to intelligently work with other third-party defense systems in that customer's network against threats. The autonomous response module 140 can send its own protocol commands to devices and/or take actions on its own. In addition, the autonomous response module 140 uses the one or more of the AI model(s) 160 to orchestrate with other third-party defense systems to create a unified defense response against a detected threat within or external to that customer's network. The autonomous response module 140 can be an autonomous self-learning digital response coordinator that is trained specifically to control and reconfigure the actions of traditional legacy computer defenses (e.g., firewalls, switches, proxy servers, etc.) to contain threats propagated by, or enabled by, networks and the internet. The cyber threat analyst module 120 and/or assessment module 125 can cooperate with the autonomous response module 140 to cause one or more autonomous actions in response to be taken to counter the cyber threat, improves computing devices in the system by limiting an impact of the cyber threat from consuming unauthorized CPU cycles, memory space, and power consumption in the computing devices via responding to the cyber threat without waiting for some human intervention. The trigger module, analyzer module 115, assessment module 125, the cyber threat analyst module, and formatting module 130 cooperate to improve the analysis and formalized report generation with less repetition to consume CPU cycles with greater efficiency than humans repetitively going through these steps and re-duplicating steps to filter and rank the one or more supported possible cyber threat hypotheses from the possible set of cyber threat hypotheses.

The trigger module, analyzer module, assessment module, and formatting module cooperate to improve the analysis and formalized report generation with less repetition to consume CPU cycles with greater efficiency than humans repetitively going through these steps and re-duplicating steps to filter and rank the one or more supported possible cyber threat hypotheses from the possible set of cyber threat hypotheses.

There are four discrete AI-based engines working to achieve aims with their own machine learning approaches. Each separate AI contributes data that has been processed intelligently through machine learning approaches and then hands over the processed behavioral metrics to another AI engine which then performs its own individualized machine-learned task.

The prevent engine in conducting simulations can use the cyber threat analyst module 120 with external data input (e.g., Crowdstrike®) and cooperate with the detection engine to identify an infected patient zero and additional devices actually compromised and/or directly linked to devices actually compromised in need of remediation. The linked devices or the activity may not be directly visible to the detection engine alone and the external data input fills in the big picture. The cyber security restoration engine to restore the protected system can potentially use the external data input that the system is receiving from third party integrations (e.g., from host-based agents from 3rd party vendors, antivirus and-based testing antivirus, etc. to identify patient zero of the attack, identify, where the attack has happened and is happening, identify devices that the system reasonably believes are linked to the compromised entity, and recommend remediation or perform remediation via AI alone, and/or AI in combination with human assistance. The cyber security restoration engine can restore the protected system back to a state before a compromise (e.g., abnormalities started) by a cyber threat occurred to the protected system. The cyber security restoration engine restores nodes in the protected system to cyberattacks in progress—so heals in real time, as an attack happens, as well as can assist in healing after an attack has taken place.

The trusted operational state of a node can be an operational state for a date and time before the earliest detection of a possible compromise of a node in the graph (device and/or user account) plus a threshold buffer amount of time.

In an example, the detection engine can use historic IaaS data on virtual resource usage to identify errant virtual resources and the autonomous response engine to spin down those resources or disable overactive microservices like lambdas. In another example, the detection engine can use historic IaaS data on virtual resource usage to understand when a client is undergoing some kind of DDOS and the autonomous response engine acts to do scaling to handle the load until the overload is over. The restoration engine can recommend controlling the scaling when the system understands deliberate overloading of traffic is occurring and then bringing that scaling back down again to assist their service architectures to deal with situations when some cyber threat is trying to overload those systems to bring that customer down.

In another example, the cyber security restoration engine to restore the protected system can use historic source codebase information and modelling from the AI models in the detection engine for development to revert commits and code changes that potentially introduce bad or compromised code. The cyber security restoration engine to restore the protected system can also use historic records of a source code database information to find out when during the development of a product that the cyber-attack occurred on the source code in order to restore the source code back to the state before the compromise occurred, as well as use historic code base analysis and understanding to identify supply chain and products vulnerable to bad code/compromised code and sending an update package/at least a notice to revert those products and further prevent the source code vulnerabilities from trickling down the supply chains from the vendor to the end user. Once file data of a cyber threat is identified, then that file data and its characteristics are captured in an inoculation package and then cascade that file information to each cyber security appliance in the fleet of cyber security appliances, and quarantine the identical and very similar files in order to remove them from all of the environments before anything can spread even more than it has via immediate remediation and also using the system's own inoculation data.

In an example, the autonomous response engine can stop a device that is infected from connecting to other nodes. In addition, the autonomous response engine can restrict reading and writing traffic and/or types of data/information being communicated in that traffic to restrict traffic movement and process activity to nodes close to an entity that the system thinks is performing erroneously or infected.

Referring to FIG. 4, the autonomous response engine is configured to use one or more Application Programming Interfaces to translate desired mitigation actions for nodes (devices, user accounts, etc.) into a specific language and syntax utilized by that device, user account, etc. from potentially multiple different vendors being protected in order to send the commands and other information to cause the desired mitigation actions to change, for example, a behavior of a detected threat of a user and/or a device acting abnormal to the normal pattern of life. The selected mitigation actions on the selected nodes minimize an impact on other parts of the system being protected (e.g., devices and users) that are i) currently active in the system being protected and ii) that are not in breach of being outside the normal behavior benchmark. The autonomous response engine can have a discovery module to i) discover capabilities of each node being protected device and the other cyber security devices (e.g., firewalls) in the system being protected and ii) discover mitigation actions they can take to counter and/or contain the detected threat to the system being protected, as well as iii) discover the communications needed to initiate those mitigation actions.

For example, the autonomous response engine cooperates and coordinates with an example set of network capabilities of various network devices. The network devices may have various capabilities such as identity management including setting user permissions, network security controls, firewalls denying or granting access to various ports, encryption capabilities, centralize logging, antivirus anti-malware software quarantine and immunization, patch management, etc., and also freeze any similar, for example, network activity, etc. triggering the harmful activity on the system being protected.

Accordingly, the autonomous response engine will take an autonomous mitigation action to, for example, shutdown the device or user account, block login failures, perform file modifications, block network connections, restrict the transmission of certain types of data, restrict a data transmission rate, remove, or restrict user permissions, etc. The autonomous response engine for an email system could initiate example mitigation actions to either remedy or neutralize the tracking link, when determined to be the suspicious covert tracking link, while not stopping every email entering the email domain with a tracking link, or hold the email communication entirely if the covert tracking link is highly suspicious, and also freeze any similar, for example, email activity triggering the harmful activity on the system being protected.

The autonomous response engine has a default set of autonomous mitigation actions shown on its user interface that it knows how to perform when the different types of cyber threats are equal to or above a user configurable threshold posed by this type of cyber threat. The autonomous response engine is also configurable in its user interface to allow the user to augment and change what type of automatic mitigation actions, if any, the autonomous response engine may take when different types of cyber threats that are equal to or above the configurable level of threat posed by a cyber threat.

The autonomous response engine can also reference its artificial intelligence trained to perform mitigation actions. Again, the autonomous response engine has an administrative tool in its user interface to program/set what autonomous mitigation actions the autonomous response engine can take, including types of mitigation actions and specific mitigation actions the autonomous response engine is capable of, when the cyber-threat module in the detection engine indicates the threat risk parameter is equal to or above the actionable threshold, selectable by the cyber professional. The cyber professional can also indicate what types of mitigation actions can be performed for different users and parts of the system as well as what actions need the cyber professional to approve. Again, the autonomous response engine can also reference a default library of mitigation actions, types of mitigation actions and specific mitigation actions the autonomous response engine is capable of on a particular node.

Referring to FIG. 6, the cyber-attack simulator using Artificial Intelligence-based simulations is communicatively coupled to a cyber security appliance 100, an open source (OS) database server 790, an email system 791, one or more endpoint computing devices 791A-B, and an IT network system 792 with one or more entities (including a communication server 793, domain name server 794, web server 795, email server 796, proxy server 797, FTP server 798 and file/date store server 799), over one or more networks 746/747 in the system being protected.

The prediction engine with Artificial Intelligence-based simulations is configured to integrate with the cyber security appliance 100 and cooperate with components within the cyber security appliance 100 installed and protecting the network from cyber threats by making use of outputs, data collected, and functionality from two or more of a data store, other modules, and one or more AI models already existing in the cyber security appliance 100.

The prediction engine may include a cyber threat generator module to generate many different types of cyber threats with the past historical attack patterns to attack the simulated system to be generated by the simulated attack module that will digitally/virtually replicate the system being protected, such as a phishing email generator configured to generate one or more automated phishing emails to pen test the email defenses and/or the network defenses provided by the cyber security appliance 100. For example, the system being protected can be an email system and then the phishing email generator may be configured to cooperate with the trained AI models to customize the automated phishing emails based on the identified data points of the organization and its entities.

The email module and network module may use a vulnerability tracking module to track and profile, for example, versions of software and a state of patches and/or updates compared to a latest patch and/or update of the software resident on devices in the system/network. The vulnerability tracking module can supply results of the comparison of the version of software as an actual detected vulnerability for each particular node in the system being protected, which is utilized by the node exposure score generator and the prediction engine with Artificial Intelligence-based simulations in calculating 1) the spread of a cyber threat and 2) a prioritization of remediation actions on a particular node compared to the other network nodes with actual detected vulnerabilities. The node exposure score generator is configured to also factor in whether the particular node is exposed to direct contact by an entity generating the cyber threat (when the threat is controlled from a location external to the system e.g., network) or the particular node is downstream of a node exposed to direct contact by the entity generating the cyber threat external to the network.

The node exposure score generator and the simulated attack module in the prediction engine cooperate to run the one or more hypothetical simulations of an actual detected cyber threat incident and/or a hypothetical cyberattack incident to calculate the node paths of least resistance in the virtualized instance/modeled instance of the system being protected. The progress through the node path(s) of least resistance through the system being protected are plotted through the various simulated instances of components of the graph of the system being protected until reaching a suspected end goal of the cyber-attack scenario, all based on historic knowledge of connectivity and behavior patterns of users and devices within the system under analysis. The simulated attack module, via a simulator and/or a virtual network clone creator, can be programmed to model and work out the key paths and devices in the system (e.g., a network, with its nets and subnets), via initially mapping out the system being protected and querying the cyber security appliance on specific's known about the system being protected by the cyber security appliance 100. The simulated attack module is configured to search and query, two or more of i) a data store, ii) modules in the detection engine, and iii) the one or more Artificial Intelligence (AI) models making up the cyber security appliance 100 protecting the actual network under analysis from cyber threats, on what, i) the data store, ii) the modules, and iii) the one or more AI models in the cyber security appliance 100, already know about the nodes of the system, under analysis to create the graph of nodes of the system being protected. Thus, the prediction engine with Artificial Intelligence-based simulations is configured to construct the graph of the virtualized version of the system from knowledge known and stored by modules, a data store, and one or more AI models of a cyber security appliance 100 protecting an actual network under analysis. The knowledge known and stored is obtained at least from ingested traffic from the actual system under analysis. Thus, the virtualized system, and its node components/accounts connecting to the network, being tested during the simulation are up to date and accurate for the time the actual system under analysis is being tested and simulated because the prediction engine with Artificial Intelligence-based simulations is configured to obtain actual network data collected by two or more of 1) modules, 2) a data store, and 3) one or more AI models of a cyber security appliance protecting the actual network under analysis from cyber threats. The simulated attack module will make a model incorporating the actual data of the system through the simulated versions of the nodes making up that system for running simulations on the simulator. Again, a similar approach is taken when the simulated attack module uses a clone creator to spin up and create a virtual clone of the system being protected with virtual machines in the cloud.

The prediction engine with Artificial Intelligence-based simulations is configured to simulate the compromise of a spread of the cyber threat being simulated in the simulated cyber-attack scenario, based on historical and/or similar cyber threat attack patterns, between the devices connected to the virtualized network, via a calculation on an ease of transmission of the cyber threat algorithm, from 1) an originally compromised node by the cyber threat, 2) through to other virtualized/simulated instances of components of the virtualized network, 3) until reaching a suspected end goal of the cyber-attack scenario, including key network devices. The prediction engine with Artificial Intelligence-based simulations also calculates how likely it would be for the cyber-attack to spread to achieve either of 1) a programmable end goal of that cyber-attack scenario set by a user, or 2) set by default an end goal scripted into the selected cyber-attack scenario.

The email module and the network module can include a profile manager module. The profile manager module is configured to maintain a profile tag on all of the devices connecting to the actual system/network under analysis based on their behavior and security characteristics and then supply the profile tag for the devices connecting to the virtualized instance of the system/network when the construction of the graph occurs. The profile manager module is configured to maintain a profile tag for each device before the simulation is carried out; and thus, eliminates a need to search and query for known data about each device being simulated during the simulation. This also assists in running multiple simulations of the cyberattack in parallel.

The prediction engine with Artificial Intelligence-based simulations module is configured to construct the graph of the virtualized system, e.g. a network with its nets and subnets, where two or more of the devices connecting to the virtualized network are assigned with different weighting resistances to malicious compromise from the cyber-attack being simulated in the simulated cyber-attack scenario based on the actual cyber-attack on the virtualized instance of the network and their node vulnerability score. In addition to a weighting resistance to the cyberattack, the calculations in the model for the simulated attack module factor in the knowledge of a layout and connection pattern of each particular network device in a network, an amount of connections and/or hops to other network devices in the network, how important a particular device (a key importance) determined by the function of that network device, the user(s) associated with that network device, and the location of the device within the network. Note, multiple simulations can be conducted in parallel by the orchestration module. The simulations can occur on a periodic regular basis to pen test the cyber security of the system and/or in response to a detected ongoing cyberattack in order to get ahead of the ongoing cyberattack and predict its likely future moves. Again, the graph of the virtualize instance of the system is created with two or more of 1) known characteristics of the network itself, 2) pathway connections between devices on that network, 3) security features and credentials of devices and/or their associated users, and 4) behavioral characteristics of the devices and/or their associated users connecting to that network, which all of this information is obtained from what was already know about the network from the cyber security appliance.

During an ongoing cyberattack, the simulated attack module is configured to run the one or more hypothetical simulations of the detected cyber threat incident and feed details of a detected incident by a cyber threat module in the detection engine into the collections module of the prediction engine using Artificial Intelligence-based simulations. The simulated attack module is configured to run one or more hypothetical simulations of that detected incident in order to predict and assist in the triggering an autonomous response by the autonomous response engine and then restoration by the restoration engine to the detected incident.

The simulated attack module ingests the information for the purposes of modeling and simulating a potential cyberattacks against the network and routes that an attacker would take through the network. The simulated attack module can construct the graph of nodes with information to i) understand an importance of network nodes in the network compared to other network nodes in the network, and ii) to determine key pathways within the network and vulnerable network nodes in the network that a cyber-attack would use during the cyber-attack, via modeling the cyber-attack on at least one of 1) a simulated device version and 2) a virtual device version of the system being protected under analysis. Correspondingly, the calculated likelihood of the compromise and timeframes for the spread of the cyberattack is tailored and accurate to each actual device/user account (e.g., node) being simulated in the system because the cyber-attack scenario is based upon security credentials and behavior characteristics from actual traffic data fed to the modules, data store, and AI models of the cyber security appliance.

The prediction engine with its Artificial Intelligence trained on how to conduct and perform cyberattack in a simulation in either a simulator or in a clone creator spinning up virtual instances on virtual machines will take a sequence of actions and then evaluate the actual impact after each action in the sequence, in order to yield a best possible result to contain/mitigate the detected threat while minimizing the impact on other network devices and users that are i) currently active and ii) not in breach, from different possible actions to take. Again, multiple simulations can be run in parallel so that the different sequences of mitigation actions and restoration actions can be evaluated essentially simultaneously. The prediction engine with Artificial Intelligence-based simulations in the prediction engine is configured to use one or more mathematical functions to generate a score and/or likelihood for each of the possible actions and/or sequence of multiple possible actions that can be taken in order to determine which set of actions to choose among many possible actions to initiate. The one or more possible actions to take and their calculated scores can be stacked against each other to factor 1) a likelihood of containing the detected threat acting abnormal with each possible set of actions, 2) a severity level of the detected threat to the network, and 3) the impact of taking each possible set of actions i) on users and ii) on devices currently active in the network not acting abnormal to the normal behavior of the network, and then communicate with the cyber threat detection engine, the autonomous response engine, and the cyber-security restoration engine, respectively, to initiate the chosen set of actions to cause a best targeted change of the behavior of the detected threat acting abnormal to the normal pattern of life on the network while minimizing the impact on other network devices and users that are i) currently active and ii) not in breach of being outside the normal behavior benchmark. The prediction engine cooperates with the AI models modelling a normal pattern of life for entities/nodes in the system being protected.

The simulated attack module is programmed itself and can cooperate with the artificial intelligence in the restoration engine to factor an intelligent prioritization of remediation actions and which nodes (e.g., devices and user accounts) in the simulated instance of the system being protected should have a priority compared to other nodes. This can also be reported out to assist in allocating human security team personnel resources that need human or human approval to restore the nodes based on results of the one or more hypothetical simulations of the detected incident.

Note, the prediction engine does not need to not calculate every theoretically possible path from the virtualized instance of the source device to the end goal of the cyber-attack scenario but rather a set of the most likely paths, each time a hop is made from one node in the virtualized network to another device in the virtualized network, in order to reduce an amount of computing cycles needed by the one or more processing units as well as an amount of memory storage needed in the one or more non-transitory storage mediums.

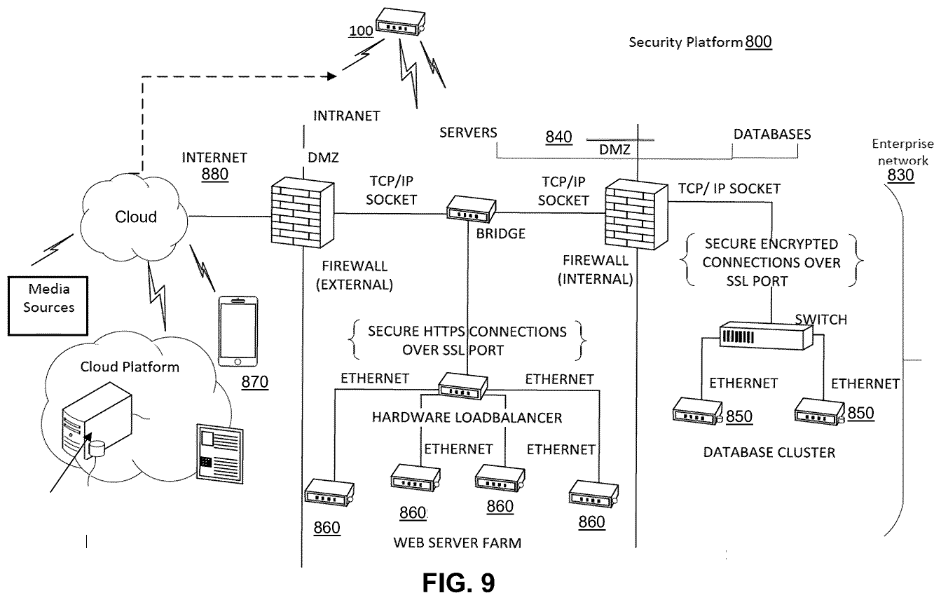

Reference is again made to FIG. 9, which illustrates a block diagram of an embodiment of the AI-based cyber security appliance 100 with the cyber security restoration engine and other Artificial Intelligence-based engines plugging in as an appliance platform to protect a system. The probes and detectors monitor, in this example, email activity and IT network activity to feed this data to determine what is occurring in each domain individually to their respective modules configured and trained to understand that domain's information as well as correlate causal links between these activities in these domains to supply this input into the modules of the cyber security appliance 100. The network can include various computing devices such as desktop units, laptop units, smart phones, firewalls, network switches, routers, servers, databases, Internet gateways, etc.

The cyber security appliance 100 is part of an enterprise network 830, which may further include one or more computing devices 840 such as database servers 850, web servers 860, networking devices 870 (e.g., bridge, switch, router, load-balancers, gateways, and/or firewalls) and endpoint devices 870 with connectivity to resources within the enterprise network 830 as well as a publicly accessible network 880 (e.g., the Internet). The endpoint devices 870 may include, but are not limited or restricted to desktop computers, laptops, smart phones, tablets, wearables, smart appliances, or the like. The security controls operate as probes and detectors that are configured to monitor, for example, network-based activity (e.g., email activity, TCP/IP communications, text or Short Message Service (SMS) activity, etc.) and computing device activity (e.g., download activity based on volume, day, time of day, etc.); credential update/modification activity (e.g., credential changes, failed access attempts to a resource, etc.); and/or resource activity (e.g., attempted/successful accesses to enterprise resources, etc.). The security controls provide the monitored data (or a version of the monitored data) as input into the modules of the cyber security appliance 100 to determine what is occurring in each domain individually.

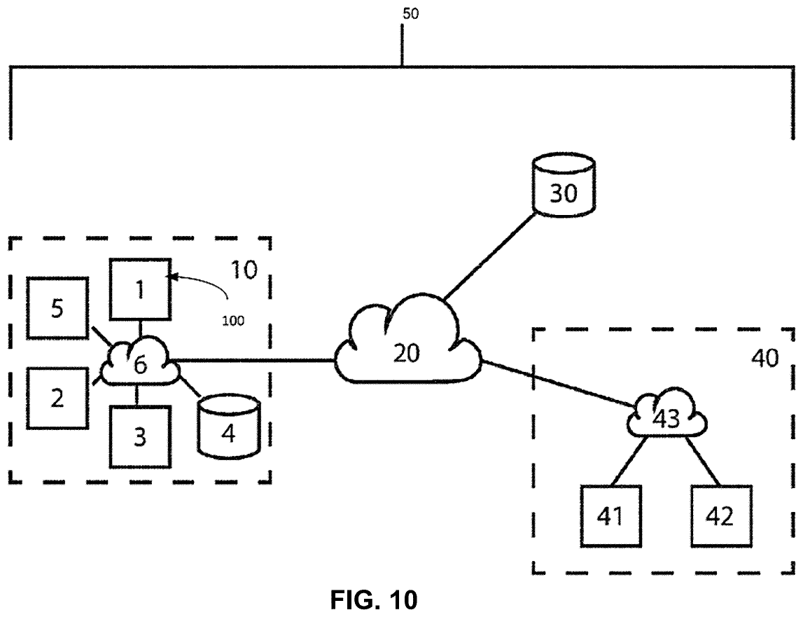

FIG. 10 illustrates an example Artificial Intelligence based cyber security appliance 100 using a cyber threat analyst module 120 104 to protect an example network. The example network of computer systems 50 uses a cyber security appliance 100. The system depicted is a simplified illustration, which is provided for ease of explanation.

Referring to FIG. 10, an exemplary and generalized embodiment of a system (e.g., enterprise network) 50 featuring computer systems 10 and 40, where one or more of these computer systems 10 and/or 40 may deploy the AI-based, cyber security appliance 100 of FIG. 1 to protect the enterprise, is shown. Herein, the system 50 comprises a first computer system 10 within a building, which uses the threat detection system to detect and thereby attempt to prevent threats to computing devices within its bounds. The first computer system 10 comprises three computing devices 1, 2, 3, a local server 4, and a multifunctional device (MFD) 5 that provides printing, scanning and facsimile functionalities to each of the computers 1, 2, 3. All of the devices within the first computer system 10 are communicatively coupled via a first Local Area Network (LAN) 6. Consequently, all of the computing devices 1, 2, 3 are able to access the local server 4 via the first LAN 6 and use the functionalities of the MFD 5 via the LAN 6. The first LAN 6 of the first computer system 10 is connected to the Internet 20, which in turn provides computing devices 1, 2, 3 with access to a multitude of other computing devices, including a server 30 and a second computer system 40. The second computer system 40 also includes two computing devices 41, 42, connected by a second LAN 43.

In this exemplary embodiment of the cyber security appliance 100, a first computing device 1 on the first computer system 10 has the electronic hardware, modules, models, and various software processes of the cyber security appliance 100; and therefore, runs threat detection for detecting threats to the first computer system 10. As such, the first computing device 1 includes one or more processors arranged to run the steps of the process described herein, memory storage components required to store information related to the running of the process, as well as one or more network interfaces for collecting information from various security controls (e.g., sensors, probes, etc.) collecting data associated with the system (network) 50 under analysis.

The cyber security appliance 100 in the first computing device 1 builds and maintains a dynamic, ever-changing model of the ‘normal behavior’ of each user and machine within the first computer system 10. The approach is based on Bayesian mathematics, and monitors all interactions, events and communications within the first computer system 10—which computing device is talking to which, files that have been created, networks that are being accessed. For example, a second computing device 2 is based in a company's San Francisco office and operated by a marketing employee who regularly accesses the marketing network, usually communicates with machines in the company's U.K. office in the second computer system 40 between 9.30 AM and midday, and is active from about 8:30 AM until 6 PM. The same employee virtually never accesses the employee time sheets, very rarely connects to the company's Atlanta network and has no dealings in South-East Asia. The cyber security appliance 100 takes all the information that is available relating to this employee and establishes a ‘pattern of life’ for that person and the devices used by that person in that system, which is dynamically updated as more information is gathered. The model of the normal pattern of life for an entity in the system 50 under analysis is used as a moving benchmark, allowing the cyber security appliance 100 to spot behavior on the system 50 seems to fall outside of this normal pattern of life, and flags this behavior as anomalous, requiring further investigation and/or autonomous action.

The cyber security appliance 100 is built to deal with the fact that today's attackers are getting stealthier, and an attacker/malicious agent may be ‘hiding’ in a system to ensure that they avoid raising suspicion in an end user, such as by slowing their machine down. The AI model(s) 160 in the cyber security appliance 100 builds a sophisticated ‘pattern of life’—that understands what represents normality for every person, device, and network activity in the system being protected by the cyber security appliance 100. The self-learning algorithms in the AI can, for example, understand each node's (user account, device, etc.) in an organization's normal patterns of life in about a week, and grows more bespoke with every passing minute. Conventional AI typically relies solely on identifying threats based on historical attack data and reported techniques, requiring data to be cleansed, labelled, and moved to a centralized repository. The detection engine self-learning AI can learn “on the job” from real-world data occurring in the system and constantly evolves its understanding as the system's environment changes. The Artificial Intelligence can use machine learning algorithms to analyze patterns and ‘learn’ what is the ‘normal behavior’ of the system (network) 50 by analyzing data on the activity on the system 50 at the device and employee level. The unsupervised machine learning does not need humans to supervise the learning in the model but rather discovers hidden patterns or data groupings without the need for human intervention. The unsupervised machine learning discovers the patterns and related information using the unlabeled data monitored in the system itself. Unsupervised learning algorithms can include clustering, anomaly detection, neural networks, etc. Unsupervised learning can break down features of what it is analyzing (e.g., a network node of a device or user account), which can be useful for categorization, and then identify what else has similar or overlapping feature sets matching to what it is analyzing.

The cyber security appliance 100 can use unsupervised machine learning to works things out without pre-defined labels. In the case of sorting a series of different entities, such as different devices, the system analyzes the information and works out the different classes of devices. This allows the system 50 to handle the unexpected and embrace uncertainty when new entities and classes are examined. The modules and models of the cyber security appliance 100 do not always know what they are looking for but can independently classify data and detect compelling patterns. The cyber security appliance's 100 unsupervised machine learning methods do not require training data with pre-defined labels. Instead, they are able to identify key patterns and trends in the data, without the need for human input. The advantage of unsupervised learning in this system is that it allows computers to go beyond what their programmers already know and discover previously unknown relationships. The unsupervised machine learning methods can use a probabilistic approach based on a Bayesian framework. The machine learning allows the cyber security appliance 100 to integrate a huge number of weak indicators/low threat values by themselves of potentially anomalous network behavior to produce a single clear overall measure of these correlated anomalies to determine how likely a network device is to be compromised. This probabilistic mathematical approach provides an ability to understand important information, amid the noise of the network—even when it does not know what it is looking for.

The cyber security appliance 100 can use a Recursive Bayesian Estimation to combine these multiple analyzes of different measures of network behavior to generate a single overall/comprehensive picture of the state of each device, the cyber security appliance 100 takes advantage of the power of Recursive Bayesian Estimation (RBE) via an implementation of the Bayes filter. Using RBE, the cyber security appliance's 100 AI models are able to constantly adapt themselves, in a computationally efficient manner, as new information becomes available to the system. The AI model(s) of the cyber security appliance 100 may be configured to continually recalculate threat levels in the light of new evidence, identifying changing attack behaviors where conventional signature-based methods fall down.

Training an AI model can be accomplished by having the model learn good values for all of the weights and the bias for labeled examples created by the system, and in this case, starting with no labels initially. A goal of the training of the AI model can be to find a set of weights and biases that have low loss, on average, across all examples.

The AI classifier can receive supervised machine learning with a labeled data set to learn to perform their task as discussed herein. An anomaly detection technique that can be used is supervised anomaly detection that requires a data set that has been labeled as “normal” and “abnormal” and involves training a classifier. Another anomaly detection technique that can be used is an unsupervised anomaly detection that detects anomalies in an unlabeled test data set under the assumption that the majority of the instances in the data set are normal, by looking for instances that seem to fit least to the remainder of the data set. The AI model representing normal behavior from a given normal training data set can detect anomalies by establishing the normal pattern and then test the likelihood of a test instance under analysis to be generated by the AI model. Anomaly detection can identify rare items, events or observations which raise suspicions by differing significantly from the majority of the data, which includes rare objects as well as things like unexpected bursts in activity.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory memory storage devices in an executable format to be executed by one or more processors. The computer readable medium may be non-transitory and does not include radio or other carrier waves. The computer readable medium could be, for example, a physical computer readable medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit.

### Computing Devices

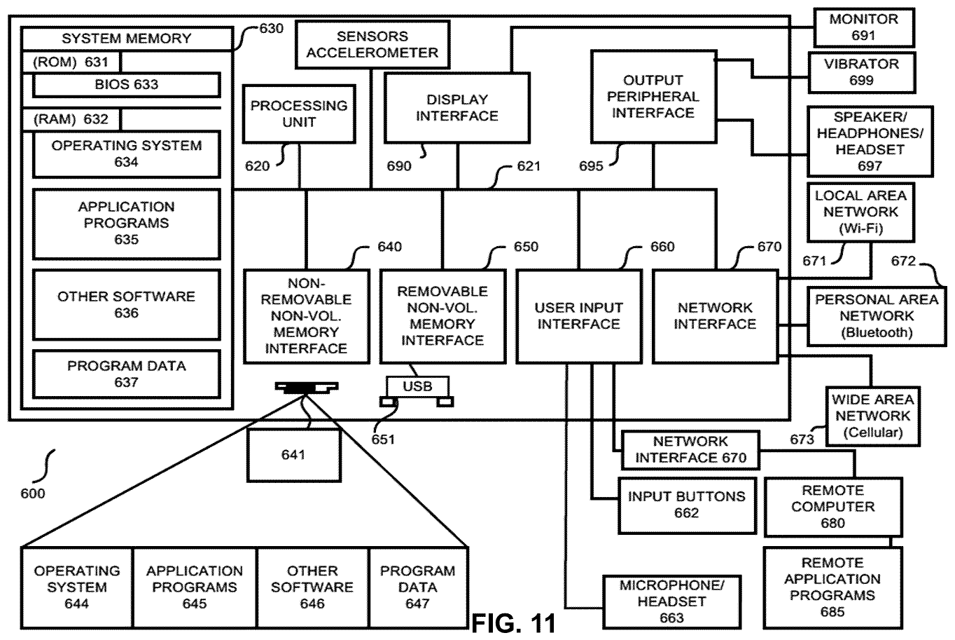

FIG. 11 illustrates a block diagram of an embodiment of one or more computing devices that can be a part of the Artificial Intelligence-based cyber security system including the multiple Artificial Intelligence-based engines discussed herein.

The computing device may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this design implemented in software 644, 645, 646 are stored in the one or more memories 630-632 and are executed by the one or more processors 620. The processing unit 620 may have one or more processing cores, which couples to a system bus 621 that couples various system components including the system memory 630. The system bus 621 may be any of several types of bus structures selected from a memory bus, an interconnect fabric, a peripheral bus, and a local bus using any of a variety of bus architectures.

Computing device 602 typically includes a variety of computing machine-readable media (which may include non-transitory machine-readable media). Machine-readable media can be any available media that can be accessed by computing device 602 and includes both volatile and nonvolatile media, and removable and non-removable media. By way of example, and not limitation, computing machine-readable media use includes storage of information, such as computer-readable instructions, data structures, other executable software, or other data. Machine-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 602. Transitory media such as wireless channels are not included in the machine-readable media. Machine-readable media typically embody computer readable instructions, data structures, and other executable software. In an example, a volatile memory drive 641 is illustrated for storing portions of the operating system 644, application programs 645, other executable software 646, and program data 647.

A user may enter commands and information into the computing device 602 through input devices such as a keyboard, touchscreen, or software or hardware input buttons 662, a microphone 663, a pointing device and/or scrolling input component, such as a mouse, trackball, or touch pad 661. The microphone 663 can cooperate with speech recognition software. These and other input devices are often connected to the processing unit 620 through a user input interface 660 that is coupled to the system bus 621, but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 602 can operate in a networked environment using logical connections to one or more remote computers/client devices, such as a remote computing system 680. The remote computing system 680 can a personal computer, a mobile computing device, a server, a router, a network PC, a peer device, or other common network node, and typically includes many or all of the elements described above relative to the computing device 602. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 602 is connected to the LAN 671 through a network interface 670, which can be, for example, a Bluetooth® or Wi-Fi adapter. When used in a WAN networking environment (e.g., Internet), the computing device 602 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 602, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

### Artificial Intelligence-Based Cyber Security Analyst

An AI system that has two parts is indicated below where a human user can understand and drive the artificial intelligence-based cyber security analyst tool (also referred to herein as ‘AI analyst’ or ‘cyber threat analyst module’) investigations as well as augment potential autonomous responses from the Response engine. The user may review the output of the artificial intelligence-based cyber security analyst tool's investigations. In addition, the user may review recommendations from the investigations that can be taken as response actions. The user may review the artificial intelligence-based cyber security analyst tool on how it concluded something was a threat and why. In some cases, the user may be able to review the Autonomous responses from the Response engine. In some cases, the user may be able to review the artificial intelligence-based cyber security analyst tool's analysis of how it might augment the Response engine's actions. In some cases, there are settings to allow the user to then use their own better judgement on whether to augment the Response engine's autonomous actions with the suggestions from the cyber threat analyst module 120 along with other actions the user may want to add. In this manner, the approach to AI-based analysis and the response to such analysis can be enhanced to improve cyber security.

### User Selection of AI-Powered Hypothesis Analysis and Outcomes

The artificial intelligence-based cyber security analyst tool's investigations into potential cyber-attacks from potential cyber threats (which may be considered to represent a cyber ‘incident’) can provide the ability for users such as customers to review the outcomes of the artificial intelligence-based cyber security analyst tool's investigations at the hypothesis-level (including hypothesis steps taken and investigation steps taken and then its conclusion). The artificial intelligence-based cyber security analyst tool may also let users now define any kind of custom model criteria, and add their own hypothesis in order to choose one or more hypotheses for potential cyber-attacks to be investigated (e.g., in accordance with the user's instructions). Such functionality may provide a completely AI-based investigation experience with a human readable summary on why the system took the hypothesis steps taken, investigation steps taken, and then its conclusion.

Thus, the cyber threat analyst module's investigations into potential cyber-attacks from potential cyber threats may have the ability for users such as customers to review the outcomes of cyber threat analyst module's investigations at the hypothesis-level. Custom model criteria may be supplied from a user to choose a hypothesis for potential cyber-attacks to be investigated. The cyber threat analyst module's investigation can utilize custom model criteria supplied from a user to choose one or more hypotheses for potential cyber-attacks to be investigated as a result of their custom model criteria. This approach places SOC teams in the driving seat, allowing them to dictate how the cyber threat analyst module 120 should investigate each model alert—even custom models. A model alert (also referred to herein simply as an ‘alert’) refers to an alert that is generated by the cyber security system when data associated with a computing network that is observed by the cyber security system (e.g., network traffic, computing device behavior, etc.) is such that the model triggers the alert. The cyber security system may use various models (e.g., see AI models 160 in FIG. 1) that can generate an alert when the observed data fits a model that is indicative of a potential cyber threat. A further discussion on model alerts is provided below. The system may allow the user to select (e.g., via a user interface) to see the steps and thought process of how the investigative AI, such as AI analyst, came up with each AI-Powered cyber threat hypothesis investigated by the machine learning, and then the steps and data looked at in the analysis by the machine learning to confirm a likelihood (or not likelihood) of one or more model breaches/alerts being the result from a cyber-attack from the cyber threat. The cyber threat analyst module 120 may be considered to lift the lid even further on its AI-powered investigation processes, building trust through awareness and understanding. The cyber threat analyst module 120 may expose the cyber threat analyst module 120 commentary and analysis on model breaches. Such commentary and analysis can be provided irrespective of the outcome of the cyber threat analyst module's investigation. That is, the commentary and analysis can be provided for any outcome—whether or not the AI analysis in the cyber threat analyst module 120 determines that there is a cyber incident.

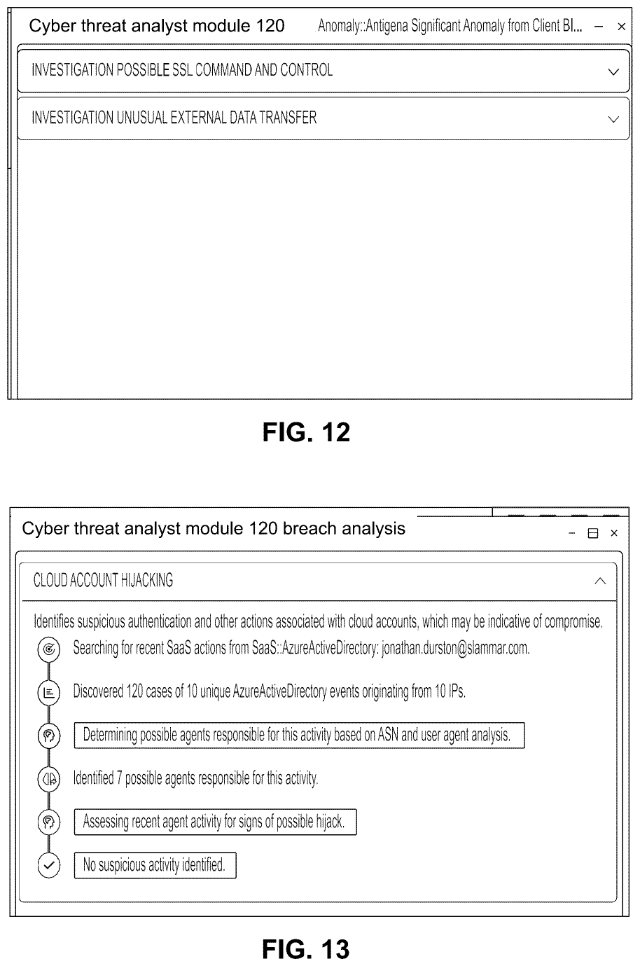

FIG. 12 illustrates an example user interface (UI) presenting a list of AI analyst investigations. An investigation into a possible cyber threat involving SSL command and control and a possible cyber threat involving an investigation into an unusual external data transfer.

FIG. 13 illustrates an example user interface presenting a model breach analysis. AI analyst has investigated cloud account hijacking. The purpose of this investigation is to identify suspicious authentication and other actions. There are some example steps AI analyst performed, and the outcome analysis of the investigation that the investigation did not find suspicious activity was identified. The user with the user interface is able to call up a representation of what hypotheses have been run, and is then able to dig into the details of those hypotheses including whether or not the AI analyst investigation found anything of interest (i.e., a possible cyber incident).

For every compatible DETECT alert (e.g., model breach), the AI analysis in the cyber threat analyst module 120 investigates a series of possible relevant hypotheses and tries to find data and/or find activity that meets the criteria, i.e., the hypotheses. When AI analyst finds activity and/or data that meets the criteria that supports a likelihood of a hypothesis, then those hypotheses are considered to be worth surfacing to an operator via the user interface. The AI analyst may present the most salient information to the end user. Many possible cyber threat hypotheses can be investigated but not all of them will meet the criteria (e.g., they do not score highly enough and/or the hypotheses are not proved with relevant information well enough) to be shown to the user. For example, the user interface may choose to present the two most compelling hypotheses with the events and data supporting that hypothesis and the customer can see the steps that were performed. With the new improvements, users who wish to dive deeper can review these investigations in even greater detail. For example, the user interface presents “What did the AI Analysis in the cyber threat analyst module 120 look for? What did it expect to find but did not? Did it find activity below the threshold to share with human users, etc.”. Such an approach may have the benefit of allowing customers to quickly understand the steps the AI analysis in the cyber threat analyst module 120 took and why it chose not to surface specific activity (due to lack of enough relevant activity, or lack of priority in the evidence found). In addition, a user can choose to see every hypothesis investigated and the events, activity, and other data even if that hypothesis was not deemed worthy to present to a user.

Some customers may not trust/have confidence that the AI analysis in the cyber threat analyst module 120 investigates all alerts, or covers all possible investigation approaches. The UI may also allow customers to see; and therefore, skip the investigation steps that the AI analysis in the cyber threat analyst module 120 already performed and found no evidence for. In the cases where no evidence was found, a user interface did not provide information on the investigation or indicate why a certain alert was never surfaced at all. In accordance with this disclosure, the user can select to see all hypothesis investigated, those deemed worthy and those not deemed worthy to present to a user. The user can confirm to themselves if they choose that AI analyst has performed a full evaluation and has investigated every possible factor.

This has a side effect that a user can also just click on a model breach presented by the UI and then see all of the AI analyst hypothesis investigations that involved that model breach as well as all of the reviews, analysis and steps performed for each of those AI analyst hypothesis investigations rather than the user awaiting the black box machine learning to present, for example, the two most likely hypotheses and be left wondering if a particular model breach was truly investigated or not. The user can select to see whether the AI led investigation did or did not find activity, as well as whether the AI-led investigation did find this activity was important in relation to the other data analyzed and/or find out why that activity was not deemed important. The user can see the underlying evaluations—e.g., what created an incident and what activities and data were deemed relevant enough (or not relevant enough) to support a likelihood of that hypothesis on the potential cyber-attack. Also, the UI provides the ability for a model breach to be clicked on to see what the system has determined regarding that model breach rather than merely informing a user that a model breach occurred without telling the user anything else about that model breach.

The AI analysis in the cyber threat analyst module 120 conducts investigations to potential cyber-attacks from potential cyber threats that then can provide the ability for users to select to choose to launch a cyber threat analyst module's investigation hypothesis to be investigated as a result of their custom model criteria:

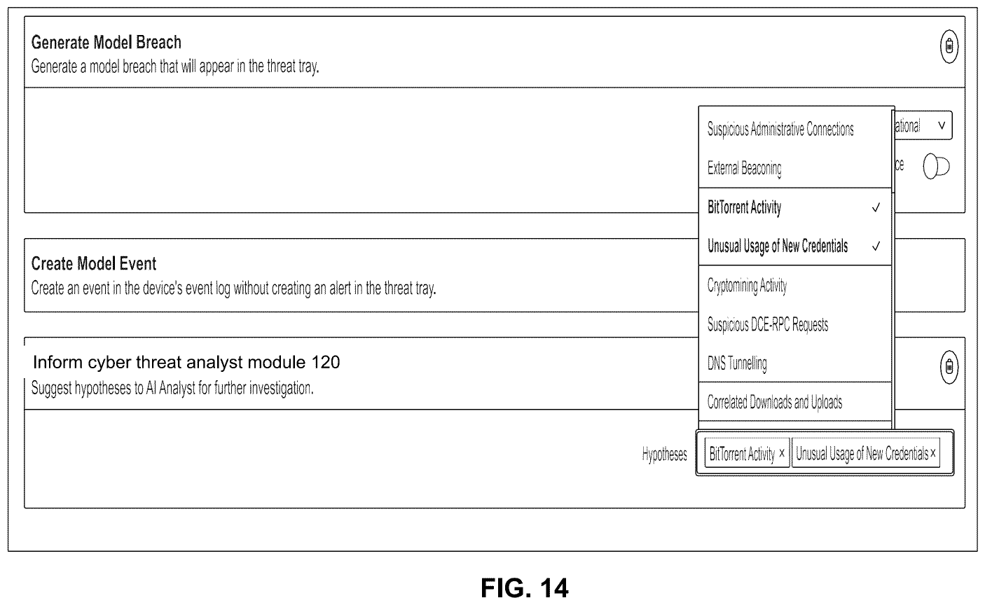

FIG. 14 is an example of a user suggesting, via a user interface, that AI analyst should investigate a hypothesis as a result of a model breach. In this example, the user asked AI analyst to investigate bit torrent activity and unusual usage of credentials.

Thus, advanced users can also now invoke one or more the cyber threat analyst module 120 investigations for their custom detections as part of the DETECT models framework, creating a pipeline of AI-analyzed inputs and AI-investigated outputs. The user is provided with the ability to invoke these types of AI analyst investigations and analysis on custom models that the user built themselves. For example, the user can make a model which triggers an AI analyst investigation to investigate every time there is a failed login from a location (e.g., an unexpected location such as India rather than an expected location such the US) and/or some other user selected set of factors. The user can force AI analyst investigations on particular alerts or activities even when the AI analyst using its initial machine learning analysis did not think the model breach was relevant to a possible cyber-attack. The ability of the user to invoke the cyber threat analyst module 120 investigations for their custom detections may have merely augmented the existing default investigations. However, in accordance with this disclosure, the user can also change/remove certain activities that can trigger or be part of the hypothesis from the AI analyst analysis. For example, if the user does not like the fact that when a model breach is created for SMB traffic, then the user can add a custom criterion specifying to not trigger an AI analyst investigation unless the SMB traffic is also coupled with some other alert that could possibly indicate, for example, a cloud hi-jacking. The user can also direct AI analyst to ignore certain model breaches. The UI provides the ability for the user to customize the AI led investigations based on user knowledge and/or preferences where previously a user might have had limited input on what could trigger and/or be considered in an AI analyst investigation. The user input may be considered to make AI analyst a more customized assistant and tool for the user rather than a black box that would present hypotheses and corresponding investigations on potential cyber-attacks occurring on the user's system. Users may have improved interactivity with AI analyst via the UI, which may provide more user satisfaction.

Note, as background discussion, the artificial intelligence-based cyber security analyst tool can use the cyber threat analyst module 120 and its interaction with the other modules and AI models in the Cyber security appliance.

The artificial intelligence-based cyber security analyst may be considered to more closely mirror the human investigative process, having the ability to question data, understand and test hypotheses, then reach conclusions—all at machine speed. The artificial intelligence-based cyber security analyst autonomously investigates alerts, streamlines investigations, and prioritizes incidents, thus reducing workload and alert fatigue. A user can also customize investigations to align with an organization's security needs and unlock autonomous threat mitigation capabilities.

The artificial intelligence-based cyber security analyst uses various forms of machine learning, including unsupervised, supervised, and deep learning combined with human intuition and trade craft from hundreds of world-class human cyber analysts across thousands of customer deployments.

The artificial intelligence-based cyber security analyst may relieve a human cyber analyst from spending anywhere between half an hour and half a day investigating a single suspicious security incident. The artificial intelligence-based cyber security analyst looks for patterns, forms hypotheses, reaches conclusions about how to mitigate the threat, and shares the findings with the rest of the business or organization. The artificial intelligence-based cyber security analyst continuously may conduct investigations behind the scenes (albeit with the improved user interactivity as described herein) and operate at a speed and scale beyond human capabilities.

The artificial intelligence-based cyber security analyst and/or cyber threat detect engine can have a natural language interface that enables every user, regardless of experience level or organization size, to take full advantage of the capabilities of that tool—artificial intelligence-based cyber security analyst and/or cyber threat detect engine.

Furthermore, the artificial intelligence-based cyber security analyst tool may aid security analysts in making informed decisions for cyber threat hunting. The artificial intelligence-based cyber security analyst tool may equip human security analysts with the necessary information to proactively identify and mitigate potential security incidents. By analyzing data from various sources, such as network logs, intrusion detection systems, and threat intelligence feeds, the tool can highlight indicators of compromise (IOCs) and provide recommendations for remediation actions. This empowers security analysts to respond swiftly to critical incidents and minimize the impact on the organization.

Through continuous improvement and refinement, the artificial intelligence-based cyber security analyst tool may ensure that it remains up to date with the evolving cybersecurity landscape. The artificial intelligence-based cyber security analyst tool may collaborate closely with industry-leading cyber threat hunters, managed detection and response operators, and incident response experts to incorporate their expertise and insights into its analysis. This feedback loop helps enhance the tool's accuracy and effectiveness, enabling it to adapt to emerging threats and new attack vectors.

### The Cyber Threat Analyst Module-Powered RESPOND Actions for In-Progress Incident Containment

The artificial intelligence-based cyber security analyst tool's investigations into potential cyber-attacks from potential cyber threats can cooperate with the autonomous response module on autonomous responses to be taken by the autonomous response module to assist with containment of a cyber incident that is in progress and then add the cyber threat analyst module's own response action as a recommendation to take included with the AI respond engine's suggested response actions. The artificial intelligence-based cyber security analyst tool can be based off a graph network structure. The artificial intelligence-based cyber security analyst tool reads in the autonomous and manual responses that have been taken. The artificial intelligence-based cyber security analyst tool can look at the graph structure of the incident to see whether any edges have active actions, and if they do not have an active action, create one that matches that edge.

Thus, the cyber threat analyst module 120 investigations into potential cyber-attacks from potential cyber threats can cooperate with the autonomous response module to assist with containment of a cyber incident that is in progress. Thus, AI analyst interacts with RESPOND for in progress incident containment. AI analyst may interact with autonomous response module (Respond) to try to identify edges that have not been covered by the initial respond action and take other action. The cyber threat analyst module 120 may pull together a complete picture of an incident as a set of events containing edges. The AI analysis in the cyber threat analyst module 120 may be able to drive RESPOND actions based on its understanding of wider incidents, buying the SOC team more time to investigate and ensuring that the incident is contained.

In an example scenario, a system (e.g., computing network) protected by the cyber security system has an evolving compromise with activity that was detected by models in the Detect engine of the cyber security system. As a result of the evolving compromise, the system has unusual connectivity going off in a bunch of directions. This compromise may be a result of a user who has been compromised by, for example, a weird/potentially malicious email. As a result, the respond engine may perform actions including restricting unexpected and/or malicious connections associated with the email, disabling the MS Office® user, and/or removing an email rule.

However, in this scenario, AI analyst also has seen those model breaches/alerts pop up, has conducted an investigation, and analyzed Respond's autonomous actions taken and on what devices those autonomous actions have been taken on. AI analyst analyzes Respond's autonomous actions taken and what devices those autonomous actions have been taken on and, in this case, has further found further devices that it believes to be involved, and further activity from the affected devices that are not currently covered by Respond's actions.

In an example, AI analyst may then interact with the response component to communicate that further respond actions should be taken for the current incident in progress from all the events and all the models.

A mapping component may map to an AI analyst incident graph with all of the possible events connected by edges. The mapping component coordinates data from AI analyst to nodes and edges in the incident graphs, that it thinks of part of the incident and coordinates the active Respond actions that are currently in the system that are associated with the devices. The mapping component performs the mapping, the handling of the creation of the Response, handling the priority of which ones should be done first, and handling the mapping of AI analyst detected activity to appropriate respond action. AI analyst may identify which edges currently have active respond actions that will suitably target the activity of that edge because it may be an active respond action for the edge. In this example, the respond action is targeted against one hostname, and the AI analyst investigation revealed that there are multiple host names connecting them for those edges which do not have respond coverage or do not have adequate respond coverage. The response component once notified may then suggest to the end user that they should add these additional respond actions to each of the un-responded edges or the respond actions may be added automatically depending upon the setting chosen by the user.

Heal/restoration engine (as discussed herein) can cooperate with the Respond engine for interactive simulations (e.g., for training purposes). Using the parts of an interactive simulation spread of a cyber-attack that HEAL suggestions ‘prevent’ are used as a performance measure. Heal can use Generative AI.

AI analyst's cooperation with the response component can also then adjust the healing priority which is the order in which things should be healed, based upon i) whether they need additional recommendations to be successfully contained by the response, ii) whether they are successfully contained by the response, or iii) whether they cannot be contained at all.

### Further Discussion of Hypotheses

Some examples relating to hypotheses are now discussed.

The AI analysis in the cyber threat analyst module 120 investigates model alerts to surface any significant activity as ‘incidents’ for further investigation.

Like a human analyst or researcher, the AI analysis in the cyber threat analyst module 120 starts this investigation process with high-level theories about the type of malicious activity that occurred or what the attacker intended to achieve. For example: “is there evidence of network scanning?”, “is there a possibility of data exfiltration?”, or “does this cloud account show signs of being hijacked?”.

These hypotheses—each capturing a broad category of malicious activity or anomalous behavior—are then proven or disproven as the cyber threat analyst module 120 investigates. This investigation may entail iteratively querying data, analyzing the results, investigating related activity, querying further data, and so on. The AI analysis in the cyber threat analyst module 120 may reach interim conclusions based on queried information, and then iterate on these over time as it queries and analyses more data. If a hypothesis is confirmed and the activity is assessed to be sufficiently interesting, it is surfaced to end-users as an incident event.

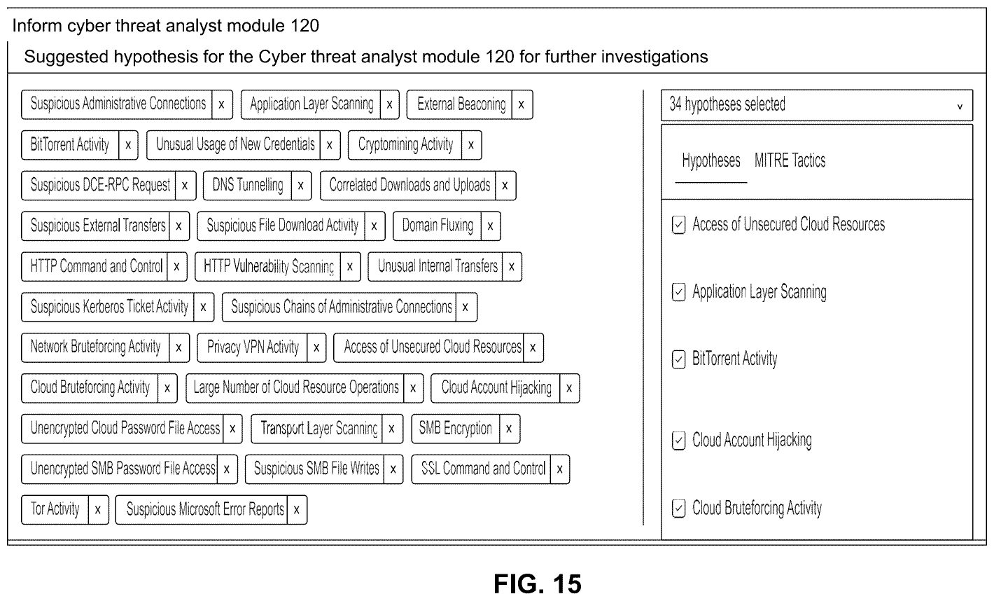

Hypotheses refer to the specific investigations that the cyber threat analyst module 120 performs as a direct result of a model alert. These hypotheses can be changed on a per-model basis by editing the model action via a UI. FIG. 15 depicts an example representation of a UI for allowing a user to select one or more hypotheses for the AI analysis in the cyber threat analyst module 120 to use as part of an investigation. As depicted, these hypotheses can belong to categories including “Access of Unsecured Cloud Resources” (which identifies the access by external actors of cloud resources which may be unintentionally unsecured), “Application Layer Scanning” (which identifies suspicious patterns of requests over several application protocols that may be indicative of reconnaissance by malicious actors), “BitTorrent Activity” (which identifies use of BitTorrent filesharing software, which is frequently used for copyright infringement and may be in violation of network usage policies), “Cloud Account Hijacking” (which identifies suspicious authentication and other actions associated with cloud accounts, which may be indicative of compromise), and “Cloud Brute Forcing Activity” (which identifies possible brute forcing of cloud accounts). A user may select one or more of these categories in order to suggest the associated hypotheses associated with each category to the cyber threat analyst module. The UI presents various options for the user so they can choose from the categories listed in the UI (and are not limited to those described above) or from a tab “MITRE Tactics”, which brings up another list when selected by the user. As depicted by FIG. 15, there is a set of hypotheses available for the user to suggest to the AI analysis in the cyber threat analyst module 120 to use as part of an investigation.

Thus, a user can select (e.g., add or remove) hypotheses individually, or a user can select a MITRE tactic, and the appropriate corresponding hypotheses are automatically be applied. In other words, a user has complete flexibility to select one or more hypotheses from one or more sets of hypotheses that relate to particular categories.

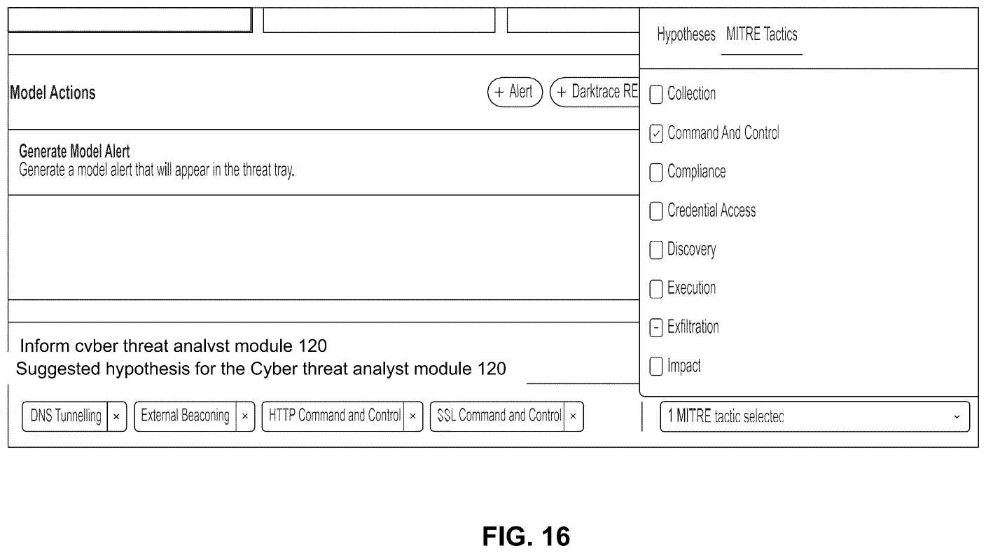

FIG. 16 depicts an example representation of a UI for allowing a user to select one or more so-called MITRE Tactics for the cyber threat analyst module 120 to use as part of an investigation. MITRE Tactics can include the categories of “collection”, “command and control”, “compliance”, “credential access”, “discovery”, “execution”, “exfiltration”, and “impact”. As depicted, by selecting the “Command and Control” MITRE tactic, this automatically applies the DNS Tunnelling, External Beaconing, HTTP Command and Control, and SSL Command and Control hypotheses. Selecting the other MITRE tactics allows the hypotheses associated with each of those tactics to be selected and presented to the user to allow the user to keep them or remove them from being used as part of the investigation.

Any hypothesis which could feasibly identify activity under a given MITRE tactic is mapped to that tactic. This mapping is not mutually exclusive in either direction—one hypothesis could be mapped to many tactics, while one tactic has many hypotheses.

The AI analysis in the cyber threat analyst module 120 investigates the hypotheses selected for the model; if a model does not contain a specific hypothesis, then the cyber threat analyst module 120 does not carry out the associated investigation. For example, if the model does not contain the ‘Suspicious File Download Activity’ hypothesis, then the cyber threat analyst module 120 may not investigate alerts of this model for suspicious file download activity. Additionally, if all hypotheses are removed from a model, the cyber threat analyst module 120 may not carry out any investigation of alerts of that model.

Human analysts may regularly review the hypotheses associated with stock models used by the cyber threat analyst module 120 to ensure optimal detection, so it should not typically be necessary to edit them. However, the option may be provided for users who desire more fine-grained control of the cyber threat analyst module's operation, for instance when performing advanced tuning, or when building custom models for the cyber threat analyst module 120 to investigate.

There are several potential considerations as follows.

It may not always be worth adding hypotheses to models. For example—in the case of metamodels that fire only if lower level models fire—adding hypotheses to both the lower level and higher level model effectively leads to the cyber threat analyst module 120 duplicating its analysis. The hypotheses only need to be applied to the lower level model.

Adding unnecessary hypotheses to models—for instance, associating exfiltration investigations with models designed to detect activity completely unrelated to exfiltration—may not be advised. If very large numbers of investigations are being performed, some investigations may be dropped to prevent load issues, which could lead to less relevant investigations being prioritized over more relevant ones.

Hypotheses can be applied using either higher-level MITRE tactic groupings, or on a per-hypothesis basis. Both approaches may have the same effect of associating the model with specific hypotheses; it may not be necessary to add a specific hypothesis if it is already covered by the applied MITRE tactic.

### Detailed Cyber Threat Analyst Module's Investigations in the Model Alert Log

Some examples of detailed the cyber threat analyst module's investigations in the model alert log are now discussed.

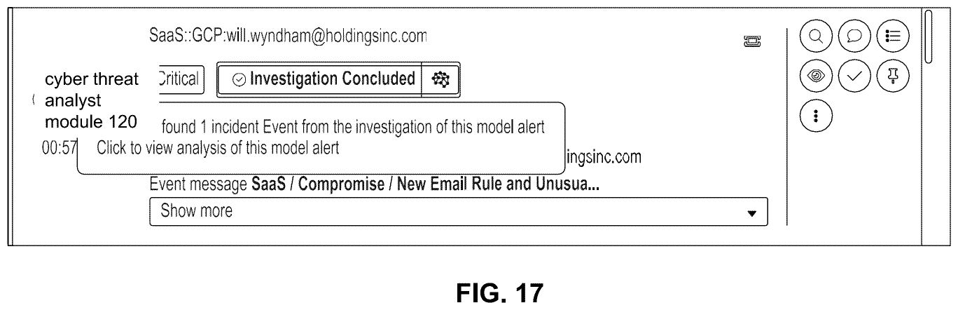

As noted above, the cyber threat analyst module 120 investigates model alerts to surface any significant activity as incidents for further investigation. FIG. 17 depicts an example representation of a UI that allows information generated by the cyber threat analyst module 120 to be provided to a user. In this example, the AI analysis in the cyber threat analyst module 120 has found an incident event from the conclusion of an investigation into a model alert. This incident is indicated as being “critical” and allows the user to interact with the UI to find out more details about the incident (e.g., “click to view analysis of this model alert”) and trigger any further actions (if needed).

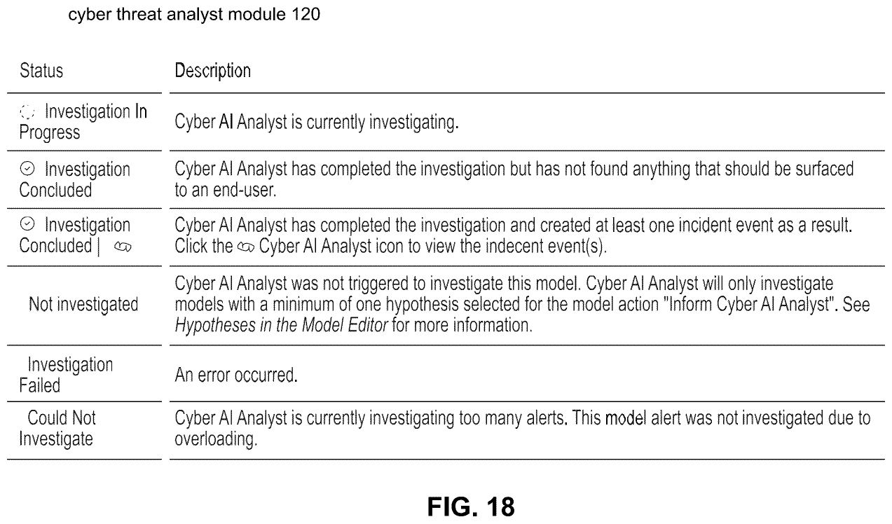

FIG. 18 is a table listing the possible statuses of an investigation associated with a model alert. Thus, each entry in the model alert log shows the status of this investigation by the cyber threat analyst module 120 into the activity detected. Thus, the UI may display the status and update the status as the investigation progresses. Such status information may not normally be visible to the user since this is handled in the background. However, in accordance with certain embodiments, the status information is provided for the user via the UI.

As depicted, the statuses can include “investigation in progress”, “investigation concluded” (but there is no cyber incident to surface to the user), “investigation concluded” (and there is a cyber incident to surface to the user), “not investigated”, “investigation failed”, and “could not investigate”. By providing the status information to the user, the user can understand what analysis has been done by AI analyst and then decide whether further action is needed (e.g., the user may consider that other hypotheses need to be tested).

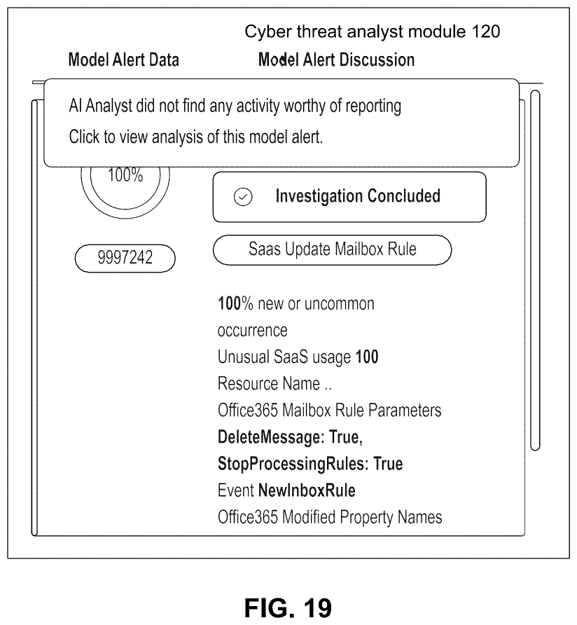

FIG. 19 depicts an example representation of a UI when an investigation has been concluded. The “Investigation Concluded” state means the cyber threat analyst module 120 is ready to display the results of its investigation, whether it resulted in a cyber incident or not. Reviewing this analysis for model alerts which did not result in cyber incidents can be useful to understand why the cyber threat analyst module 120 did not show the activity to an end-user. It is possible for a user to click on the text in the UI to open a detailed analysis of the investigation steps the cyber threat analyst module 120 took.

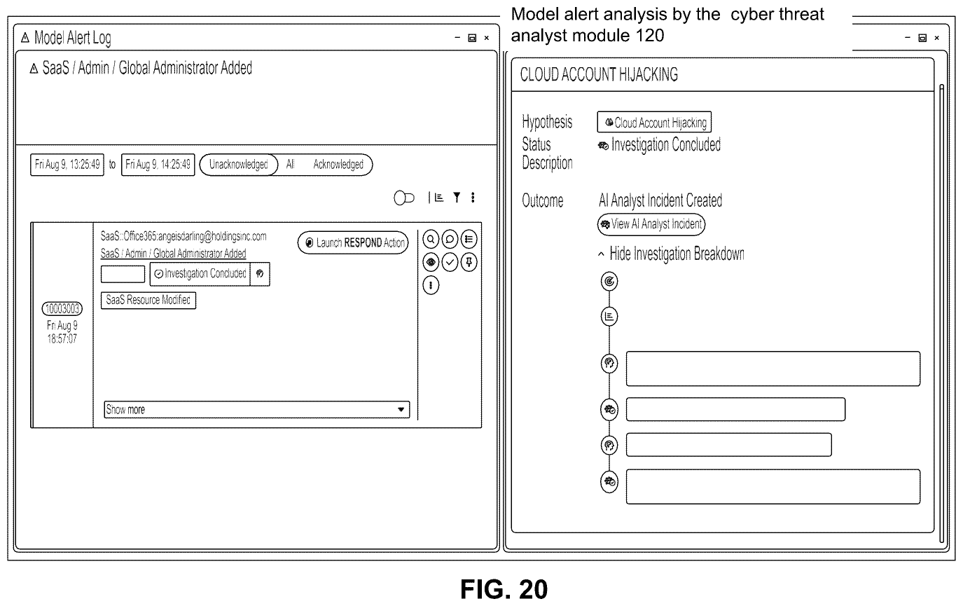

FIG. 20 depicts an example representation of a UI providing the analysis of a model alert breakdown. The detailed analysis breakdown describes the investigation that AI analysis in the cyber threat analyst module 120 performed and the final verdict in each case. The window is broken into two main sections: summary, and hypotheses. The summary section names the model that the cyber threat analyst module 120 investigated and describes the overall investigation ethos. Below are a series of hypotheses—lines of investigation that the AI analysis in the cyber threat analyst module 120 pursued as a result of the alert. In this example, as part of a model alert log, a user has been added to the list of global administrators for the SaaS service. Global administrators have full privileges and can manage all aspects of the SaaS services and identified including access management and billing information. The UE indicates an action to review whether the activity was expected, and whether the user requires global administrator privileges. The AI analysis in the cyber threat analyst module 120 has provided analysis of the model alert, which starts from the hypothesis ‘Cloud Account Hijacking’. The status is specified in the UI as ‘Investigation Concluded’. The description of the investigation is given in the UI, which in this example, identifies suspicious authentication and other actions associated with cloud accounts, which may be indicative of compromise. The UI indicates that the cyber threat analyst module 120 incident is created (i.e., there is a potential threat). The UI provides the ability to show/hide the investigation breakdown. In this example, the investigation included the following features/phases: (i) Searching for recent SaaS actions from an associated email address, (ii) Discovered a specified Directory event Update user originating from a specified location, (iii) Determining possible agents responsible for this activity based on Autonomous System Number (ASN) and user agent analysis, (iv) identified a single possible agent responsible for this activity, (v) Assessing recent agent activity for signs of possible hijack, and (vi) Identified one suspicious case of the specified Directory event Update user, associated with a single agent. The system also provides as part of its UI a ‘Launch RESPOND action’ to trigger the cyber security system to take an appropriate action in response to the incident. In another example, if the outcome is that there is no incident (i.e., the data does not support the hypothesis), the UI is still able to show details such as the investigation breakdown.

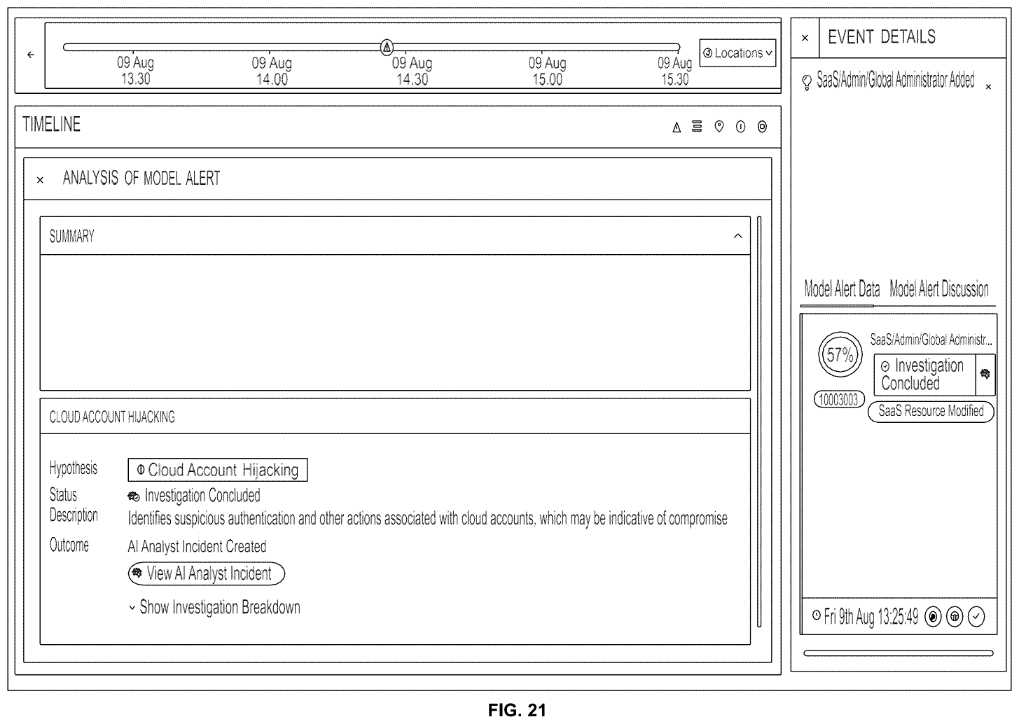

FIG. 21 depicts an example representation of a UI showing the breakdown open over the event timeline and can be dismissed by a user click via the UI.

Like a human analyst or researcher, the cyber threat analyst module 120 starts the investigation process with high-level theories about the type of malicious activity that occurred or what the attacker intended to achieve. For example: “is there evidence of network scanning?”, “is there a possibility of data exfiltration?”, or “does this cloud account show signs of being hijacked?”.

These hypotheses—each capturing a broad category of malicious activity or anomalous behavior—are then proven or disproven as the cyber threat analyst module 120 investigates. This entails iteratively querying data, analyzing the results, making sub-hypotheses, querying further data, and so on. If a hypothesis is confirmed and the activity assessed to be sufficiently interesting, it is surfaced to end-users as an incident event.

In this example, the UI provides an analysis of a model alert. Such analysis includes a summary, which describes that the cyber threat analyst module 120 investigated the model alert relating to a user being added to the list of global administrators for the SaaS service. The summary also describes that the cyber threat analyst module 120 has investigated the model alert and surrounding activity, along with presenting the results of the investigation. Some functionality of the cyber threat analyst module 120 is now described: To find events or behaviors worth surfacing to human analysist, the cyber threat analyst module 120 identifies hypotheses relevant to the unusual activity that triggered the model alert, and tries to find evidence that applies to each theory. This evidence is gathered using a series of AI-powered investigation steps. Only those hypotheses that are successfully proven and deemed of interest result in the cyber threat analyst module 120 incident event. In this example, the UI indicates that the cyber threat analyst module 120 has identified a hypothesis as being relevant to the model alert. FIG. 21 depicts a contracted view of the Cloud Account Hijacking portion of the UI depicted by FIG. 20. A user can interact with the UI in order to contract or expand different portions of the UI in order to view information of interest as and when needed.

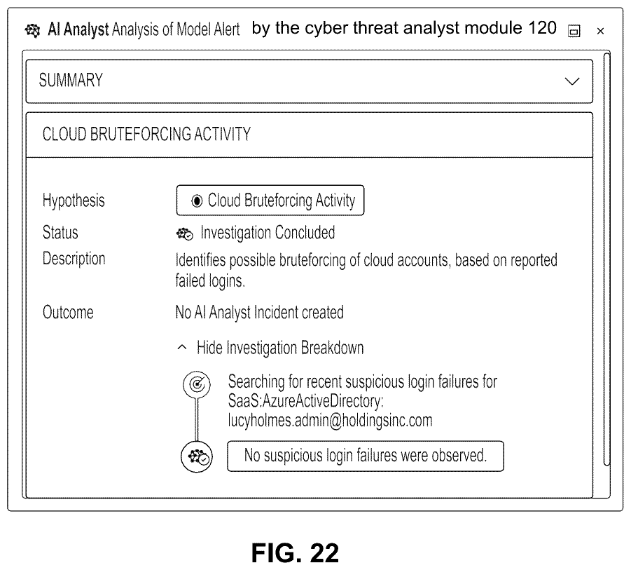

FIG. 22 depicts an example representation of a UI providing information about an example hypothesis entry. In this example, the example hypothesis entry is cloud brute forcing activity.

Each entry represents a different hypothesis the cyber threat analyst module 120 pursued. The name of the hypothesis is shown at the top of the section and repeated on the entry itself. Underneath is a status for the specific investigation, as some hypotheses may require intensive data analysis which may take slightly longer to complete than others.

Finally, the outcome of the specific investigation hypothesis is listed.

If the cyber threat analyst module 120 incident event was created as a result of the investigation, this is indicated with a “View Cyber AI Analyst Incident” button.

If the cyber threat analyst module 120 did not find any relevant activity, the status reads “No Cyber threat analyst module 120 Incident is created”.

If the cyber threat analyst module 120 did find some relevant activity—but did not consider it worth surfacing to a user—the reason is outlined.

Although a model alert may be the trigger for an investigation, that does not mean the activity the cyber threat analyst module 120 surfaces is directly related to the original model alert. Like a human, the cyber threat analyst module 120 uses a model alert as a starting point to investigate the device. The behavioral analysis it performs may discover anomalies or patterns of activity that were not the original trigger point for the model alert but are worthy of investigation.

For each hypothesis, users can also view the high-level investigation steps the AI analysis in the cyber threat analyst module 120 followed to prove or disprove the hypothesis. To view, click “Show Investigation Breakdown”.

Like the investigation process panel of the Cyber AI Analyst interface, the breakdown explains how the AI analysis in the cyber threat analyst module 120 went from the initial trigger to the final conclusion for the specific hypothesis. As the investigation process proceeds, the AI analysis in the cyber threat analyst module 120 narrows down the activity from a wider analysis to a targeted anomaly.

Each investigation blends AI, supervised machine learning and intensive data analysis; these smart steps may be highlighted (e.g., with color highlighting) in the UI, as appropriate. For example, the UI may indicate “carrying out intelligent data analysis”.

As noted before, the behavioral analysis the AI analysis in the cyber threat analyst module 120 performs may discover anomalies or patterns of activity that were not the original trigger point for the model alert but are worthy of investigation.

As such, the UI provides a mechanism to facilitate user interactivity with the cyber security system to facilitate user input for investigations (e.g., selecting one or more hypotheses) by the cyber threat analyst module 120 and allow the user to be provided with information about the investigations for each hypothesis investigated, irrespective of whether the cyber threat analyst module 120 has determined that an alert represents a cyber incident.

### Recommended Autonomous Response Actions

Some examples of recommended response actions are now discussed.

the cyber threat analyst module 120 can recommend or automatically execute incident-based Autonomous Response actions. Autonomous Response initially responds to model alerts—however, these are relatively narrow activity detections, and very few are considered to reveal a threat urgent enough that Autonomous Response should be immediately triggered.

Incident-based Autonomous Response is a second stage of consideration. The cyber threat analyst module 120 investigates an alert (including those that do not trigger an Autonomous Response directly) and discovers—with greater confidence and in more detail—whether there is a plausible threat. This includes activities that did not themselves cause an alert.

At this later and more assured stage of the process, incident-based Autonomous Response may step in and create Response Actions to control all of the detected activity at once.

These response actions may then be available to view in the Response Actions page of the UI.

The following discission provides an example sequence of how to configure the AI analyst to perform an investigation.

Actions directed by the cyber threat analyst module 120 may be disabled by default and can display “Actions disabled” on the UI. To enable the actions, the following stages may be followed.

In a first stage, the user opens, via a UI, a “Threat Visualizer” (which visualizes the threat on the UI) and navigates to the configuration page in the UI. For example, “System Config page (Main Menu>Admin)”.

In a second stage, the user may go to an appropriate location in the UI indicative of the response settings (e.g., “Settings>RESPOND”) and locate the “Detected Incident Respond Actions” and “Manual Incident Respond Actions” settings.

The Detected Incident Respond Actions setting applies to incidents (and incident events) that have been raised autonomously by the software: an alert appears and the cyber threat analyst module 120 investigates and generates an incident.

The Manual Incident Respond Actions setting applies when the incident (or incident event) was created as a result of a triggered investigation or other manual input. If a user triggers an investigation which generates an incident event that is added to an existing, system-created incident, the Manual Incident Respond Actions setting applies. An example of this is a user starting a manual the cyber threat analyst module 120 investigation. The user is anticipating unusual behavior to be found and potentially actioned as a result.

In a third stage, the user may click on an appropriate location in the UI such as a drop-down button and enable the relevant permissions for each setting. There may be three enablement options: “Force Human Confirmation”, “Permit Autonomous Action”, and “Force Autonomous Action”.

If set to Force Human Confirmation, Autonomous Response asks for confirmation from the user before taking an action—regardless of the global state.

In Permit Autonomous Action mode, a response is taken automatically unless confirmation for actions is required globally according to the schedule.

If Force Autonomous Action is chosen, the model overrides the global schedule and always take action without confirmation.

Autonomous Response actions are created from the higher level the cyber threat analyst module 120 data and executed based on the value of the relevant setting. This takes into account the cyber threat analyst module 120 schedule as well as the Autonomous Response eligibility of the devices proposed for actions. This data then informs whether the action is to be automatically executed or suggested to the user for manual execution.

It may be recommended that the enablement settings for both Detected Incident Respond Actions and Manual Incident Respond Actions are the same.

In a fourth stage, Once the relevant settings have been enabled, these changes are saved automatically, and preferences updated.

In a fifth stage, the recommended Response Actions are then available to view in the Response Actions page. Each action displays the source incident.

### Improved and Augmented Artificial Intelligence-Based Investigations of Potential Cyber Incidents, and Use Thereof

As has already been described, the approach to AI-based analysis and the response to such analysis can be enhanced to improve cyber security. Further discussion and embodiments relating to the techniques described above are now provided.

AI-based analysis of a model alert involves performing an investigation to determine if the available data supports a hypothesis that has been selected by the cyber security system. Although there are benefits to having a fully autonomous system that can perform detection without needing to involve a user, there are scenarios where a user such as a member of an IT security team may wish to gain more insight into current activity in the computing network and the current performance of the cyber security system. There are also scenarios where the user may wish to have more control in respect of certain activity. While some level of user interactivity is possible with the cyber security system, there are scenarios where a user can improve and/or augment the functionality of an AI-based cyber security system to improve cyber security.

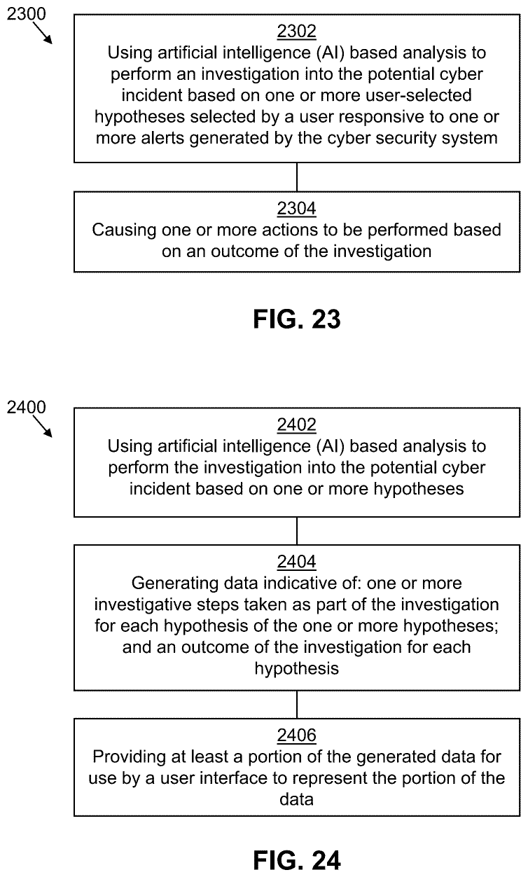

FIG. 23 illustrates a method 2300 of investigating a potential cyber incident detected by a cyber security system according to an embodiment. The method 2300 may be computer-implemented by virtue of being implemented by one or more computing devices such as described herein. In some cases, the method 2300 may be implemented by the cyber security appliance 100, which could be connected to an organization's network such as depicted by FIG. 9. In some cases, the method 2300 may be implemented in the cloud such as depicted by FIG. 9. In some cases, one or more parts of the method 2300 may be implemented in a distributed manner, for example, by one or more computing devices such as depicted in FIG. 9. For example, one part of the method 2300 may be implemented by one computing device (e.g., the cyber security appliance 100) in any location in a security platform such as depicted by FIG. 9, and another part of the method 2300 may be implemented by another computing device (e.g., the cloud or a server) in any location in the security platform.

As described below, the method 2300 may be implemented by one or more modules forming part of one or more apparatus for investigating a potential cyber incident detected by a cyber security system. The method 2300 includes a plurality of blocks, each of which may be implemented by a computing device. The depicted sequence of blocks is illustrative rather than limiting. Certain blocks may be omitted in some embodiments.

The method 2300 comprises, at block 2302, using artificial intelligence (AI) based analysis to perform an investigation into the potential cyber incident based on one or more user-selected hypotheses selected by a user responsive to one or more alerts generated by the cyber security system.

The AI based analysis may be performed by the cyber threat analyst module 120 as described herein. In use, one or more alerts (model alerts) may be presented to the user (e.g., a human analyst, a member of security team, etc.) via a user interface and the user may, responsive to the one or more alerts, select one or more hypotheses for the cyber threat analyst module 120 to use as part of its investigation.

The method 2300 further comprises, at block 2304, causing one or more actions to be performed based on an outcome of the investigation.

Examples of such actions are discussed below and may depend on user wishes. In some cases, response actions may be taken autonomously by the cyber security system or may be in response to further user input if it turns out that the outcome of the investigation is that the alert is considered by AI analyst to represent a cyber ‘incident’. For example, the one or more actions to be taken may depend on the configuration that may be predetermined or set by the user. There may be cases where it is not yet determined whether a response action is needed. In such cases, the relevant information may be provided to the user.

By virtue of being able to select one or more hypotheses for the cyber threat analyst module 120 to investigate, the user may have more control over investigations that are to be carried out by the cyber threat analyst module. In other words, the user may have the ability to customize and trigger the operation of the cyber threat analyst module 120 in response to an alert. As a result, the cyber threat analyst module 120 can start investigating off the back of custom criteria, rather than predefined criteria. In some cases, autonomous response actions can then be automatically triggered off the back of the cyber threat analyst module 120 determining that there has been a cyber incident. In the case that a user-selected hypothesis (rather than a hypothesis selected automatically based on predefined criteria) and the observed data supported the user-selected hypothesis, a response action may be triggered, for example, to contain the cyber incident. Such a response action may not have been triggered without user input. Thus, the user can augment the functionality of the cyber security system to enhance the detection and/or response to cyber incidents.

It shall be appreciated that certain alerts may automatically trigger an autonomous response by the cyber security system without user input. There are scenarios where it is preferable for the cyber security system to respond autonomously to rapidly contain a cyber threat. For example, if the cyber security system has a high confidence level (e.g., above a threshold metric indicative of the level of risk posed by an alert) that the observed data is indicative of a cyber incident, the cyber security system may respond autonomously to rapidly address the cyber incident. At a lower confidence level (e.g., below the threshold metric), there may be a need for further investigations to be carried out in order to exclude the possibility that the alert is indicative of a genuine cyber incident. Determining that there is a cyber incident when the analysis of the data associated with the alert yields a false positive result may lead to a response that interrupts the normal operation of the computing network and causes unnecessary downtime. Further, determining that there is not a cyber incident when the analysis of the data associated with the alert yields a false negative may prevent a necessary response to the cyber incident that could have significant negative consequences. Therefore, a multi-level approach to responses may be beneficial to ensure that there is a rapid, autonomous, response to alerts associated with a high-confidence level threat, while allowing for a lower confidence level threat to be analyzed further to determine whether or not they are indicative of a cyber incident to reduce disruption and respond appropriately if there is indeed a cyber incident. The ability for the user to select one or more hypotheses to be used as part of an investigation may be used in the lower confidence level threat scenario. That is, those alerts that do not automatically trigger an autonomous response can be investigated based on predefined criteria as well as based on user input (as described herein). Thus, the investigation of these lower level alerts can be improved because the user can modify the approach of the investigation. For example, the user can select their own hypothesis (in the case that the predefined criteria did not automatically select the hypothesis), select the priority of the hypotheses (e.g., to cause the cyber threat analyst module 120 to investigate higher priority concerns before lower priority concerns), and/or input any other criteria that may influence how the cyber threat analyst module 120 approaches the investigation.

In some cases, one or more response actions may be created in the event that an initially lower confidence level alert is determined by the cyber threat analyst module 120 to represent a cyber incident. In some cases, the user may have the ability to trigger such response actions in response to the analysis. The cyber threat analyst module 120 may not automatically trigger restoration steps but the results of any analysis and/or any other relevant information such as recommended mitigation steps may be provided to the restoration engine in order for appropriate action to be taken.

As such, while there are certain benefits to having the cyber threat analyst module 120 automatically run investigations based on predefined criteria (i.e., computer-identified hypotheses based on observed data), such an approach does not allow for user insight to be incorporated into an investigation on-demand (when the alert is raised). Providing the user with the capability to select one or more hypotheses on-demand in accordance with certain embodiments described herein may provide enhanced functionality that allows an AI-based investigation to incorporate user insight to improve the range of analysis to be performed by the cyber threat analyst module 120 and/or focus on a certain type of analysis to be performed by the cyber threat analyst module. Such an approach may increase the likelihood of detecting a genuine cyber incident in the lower confidence level domain, thereby further improving the performance of an AI-based cyber security system. In other words, certain embodiments described herein now provide a user (e.g., human user) with the ability to interact with the cyber security system in order to use their own knowledge and experience to augment the AI-based analysis i.e., by selecting the one or more hypotheses.

Thus, users may be able to configure the cyber threat analyst module 120 investigations in a way that they were not able to before i.e., by controlling what type of investigation is performed and/or by controlling the conditions under which the investigation occurs. The results of the investigation can be used to improve incident response. Further, as will be described in more detail below, the user may be provided with additional information about an investigation.

Some embodiments relating to the method 2300 are now described. Any combination of one or more of these embodiments may be implemented as part of the method 2300.

In some embodiments, the method 2300 further comprises receiving the one or more user selected hypotheses. For example, a user may select one or more hypotheses via a user interface. As described in more detail below, the one or more hypotheses selected by the user may be provided to a cyber threat analyst module 120 for incorporation into the AI-based analysis.

In some embodiments, the method 2300 further comprises causing the user interface to provide a representation of the one or more alerts detected by the cyber security system. The method 2300 may further comprise causing the user interface to allow the user to select the one or more user-selected hypotheses. A user interface may provide a convenient way for the user to interact with the cyber threat analyst module 120 in order to input their selection. A representation of the one or more alerts may refer to a visual representation on a graphical user interface (or any other appropriate representation for the user such as audible) of the alert via the user interface so that a user can be informed about the alert and take action as they deem appropriate.

In some embodiments, the method 2300 further comprises providing a representation of one or more suggested hypotheses identified by the cyber security system in response to the one or more alerts. The one or more suggested hypotheses may be identified based on one or more predefined rules. The method 2300 may further comprise causing the user interface to provide the user with an option to select one or more hypotheses for investigation from a set of hypotheses other than the one or more suggested hypotheses. Thus, the user is empowered to make the decision about what hypotheses are to be investigated and can therefore overrule or augment the decision making made by the cyber security system. This could even involve empowering the user to request that a certain hypothesis not be investigated because the user knows that the hypothesis is not supported by the data. A hypothesis may be initiated (for investigation) based on defined rules (e.g., in the case where the user is not involved in selecting one or more hypotheses). However, where the user selects the one or more hypotheses, the user may select one or more of the hypotheses that would otherwise be initiated based on the defined rules and/or select one or more other hypotheses that would not otherwise be initiated based on the defined rules. Such an approach may allow for further customizability for the user since certain hypotheses may be investigated (where such hypotheses would not usually be investigated based on the defined rules) or may not be investigated (where such hypotheses would usually be investigated based on the defined rules).

In some embodiments, the method 2300 further comprises receiving one or more user specified criteria for the cyber security system. The one or more user specified criteria may be indicative of the one or more actions that are to be performed based on the outcome of the investigation. The one or more user specified criteria may be provided via the user interface.

In some embodiments, the one or more actions comprise one or more autonomous responses to be taken by the cyber security system. In some embodiments, the one or more actions comprise causing the user interface to represent at least some data generated as part of the investigation into the potential cyber incident. In some embodiments, the one or more actions comprise causing the user interface to provide a request for input from the user. Any combination of these different types of actions may be taken. Thus, user specified criteria may indicate how the user instructs the cyber security system to behave in response to an alert and subsequent analysis to that alert.

In some embodiments, the one or more actions comprise one or more autonomous responses to be taken by an autonomous response module of the cyber security system.

In some embodiments, the one or more actions comprise causing the user interface to represent at least some data generated as part of the investigation into the potential cyber incident. The method 2300 may further comprise using the data to generate a representation comprising: a status of the investigation; or a description associated with at least one of the one or more hypotheses; or one or more steps taken by the cyber threat analyst module 120 as part of the investigation for at least one of the one or more user-selected hypotheses; or the outcome of the investigation, wherein the outcome is indicative of whether the data supports at least one of the one or more user-selected hypotheses; or a combination thereof. The user interface may represent the data in any appropriate way for the type of user interface being used. For example, the data could be represented in the form of a written description, a picture, or audio, etc.

In some embodiments, the one or more actions comprise causing the user interface to provide the request for input from the user. The request for input may comprise a request for the user to trigger one or more responses to be taken by the cyber security system to address the potential cyber incident. Thus, a user may select on-demand a response that the user thinks is appropriate in view of the nature of the incident, and could be any of the responses available to the cyber security system.

FIG. 24 illustrates a method 2400 of representing data generated as part of an investigation into a potential cyber incident detected by a cyber security system according to an embodiment. The method 2400 may be computer-implemented by virtue of being implemented by one or more computing devices such as described herein. In some cases, the method 2400 may be implemented by the cyber security appliance 100, which could be connected to an organization's network such as depicted by FIG. 9. In some cases, the method 2400 may be implemented in the cloud such as depicted by FIG. 9. In some cases, one or more parts of the method 2400 may be implemented in a distributed manner, for example, by one or more computing devices such as depicted in FIG. 9. For example, one part of the method 2400 may be implemented by one computing device (e.g., the cyber security appliance 100) in any location in a security platform such as depicted by FIG. 9, and another part of the method 2400 may be implemented by another computing device (e.g., the cloud or a server) in any location in the security platform.

As described below, the method 2400 may be implemented by one or more modules forming part of one or more apparatus for investigating a potential cyber incident detected by a cyber security system. The method 2400 includes a plurality of blocks, each of which may be implemented by a computing device. The depicted sequence of blocks is illustrative rather than limiting. Certain blocks may be omitted in some embodiments.

The method 2400 comprises, at block 2402, using artificial intelligence (AI) based analysis to perform the investigation into the potential cyber incident based on one or more hypotheses.

The method 2400 further comprises, at block 2404, generating data indicative of: one or more investigative steps taken as part of the investigation for each hypothesis of the one or more hypotheses; and an outcome of the investigation for each hypothesis.

The method 2400 further comprises, at block 2406, providing at least a portion of the generated data for use by a user interface to represent the portion of the data.

The functionality of the method 2400 and its associated embodiments is interrelated to the functionality of the method 2300 and its associated embodiments. Thus, the functionality of the method 2400 and its associated embodiments can be combined with, replace, or otherwise modify the method 2300 and its associated embodiments, and vice versa.

As referred to in certain embodiments relating to the method 2300, data is generated as part of an AI-based investigation into an alert. Such data can be represented via a user interface to allow the user to have an improved understanding about various elements of the investigation. A user may typically have limited insight into an AI-based investigation because the user is only provided with limited information by the system. This is relevant for AI-based analysis because some AI-based tools are not built for user interactivity. For example, the user may just receive an indication of a positive hit for a hypothesis (i.e., the data supports the hypothesis). That is, the cyber security system may cause the user interface to indicate that there is a cyber incident if the AI-based analysis finds a supported hypothesis.

However, in accordance with certain embodiments described herein, by providing the ability for at least a portion of the generated data (which includes one or more investigative steps taken as part of the investigation for the one or more hypotheses) to be provided to the user via a user interface, the user may be able to gain an improved understanding about the investigation. For example, information about the steps of the investigation that were taken, and why, may be helpful for the user. By exposing such information to the user, the user may be considered to be less isolated from the operations performed by the cyber threat analyst module 120 as part of an investigation into an alert and therefore the user can gain an improved understanding of the alert, what is happening in the computing network, and how the cyber security system is performing. If the user sees something of interest in the representation of the data, they can take appropriate action such as performing their own analysis or requesting the cyber security system takes an action.

An outcome of an investigation into an alert may include a positive result (i.e., one or more hypotheses are supported) or a negative result (i.e., one or more hypotheses are not supported). The outcome (i.e., the positive result) and additional information (e.g., about the one or more investigative steps taken as part of the investigation) may be indicated to the user in accordance with certain embodiments described herein, i.e., the user interface may represent data indicative of one or more investigative steps taken as part of the investigation. Thus, the user is provided with the additional information about the investigation beyond just an indication of a positive result. In some cases, there may be multiple successful hypotheses for a single alert. Such an outcome and the associated additional information for each successful hypothesis may be indicated to the user.

A negative result may typically be deemed to be not important and therefore the user may not be presented with any information about a hypothesis associated with that negative result. However, the outcome (i.e., the negative result) and additional information (e.g., about the one or more investigative steps taken as part of the investigation) may be indicated to the user in accordance with certain embodiments described herein, i.e., the user interface may represent data indicative of one or more investigative steps taken as part of the investigation. Thus, the user is provided with the additional information about the investigation, as well as being informed about the existence of the negative result. Thus, the user may gain an insight that they would not have otherwise gained because such a negative result (and the additional information about investigative steps) is not typically exposed to the user. In some cases, there may be multiple unsuccessful hypotheses for a single alert. Such an outcome and the associated additional information for each unsuccessful hypothesis may be indicated to the user.

As such, by representing the portion of the data for the user via a user interface (e.g., presented in any appropriate form such as a summarised written description of the outcome and investigative steps) associated with an alert, the user can gain an understanding about exactly what type of investigations were performed by the cyber threat analyst module 120 (e.g., which hypotheses were tested), which of these one or more hypotheses led to a conclusion that there is an associated cyber incident, what kind of incident has been identified, what were the steps of the investigation for each hypothesis, and why the cyber threat analyst module 120 performed such an investigation. In addition, if the cyber threat analyst module 120 concludes that an alert is not associated with a cyber incident, then the portion of data represented via the user interface may still indicate why the cyber threat analyst module 120 came to that conclusion.

Further, by providing the additional information such as the data indicative of the investigative steps taken as part of the investigation, the explainability of the AI is enhanced and the details about the investigation performed by the cyber threat analyst module 120 may be considered to be more accessible for a user. For example, by being provided with the data, the user can understand what has been done by the cyber threat analyst module 120 and have confidence about what has and what has not been investigated. Since the investigation can be based on one or more hypotheses, the AI-based investigation can be broken down by hypothesis into smaller explainable segments of information to help the user more easily access and review the information provided via the user interface.

Some embodiments relating to the method 2400 are now described. Any combination of one or more of these embodiments may be implemented as part of the method 2400.

In some embodiments, the method 2400 further comprises receiving one or more user-selected hypotheses selected by the user via the user interface. Any appropriate user interface (e.g., a graphical user interface or other type of interface) may be used to allow the user to input their selection.

In some embodiments, the method 2400 further comprises sending an indication of the one or more user-selected hypotheses (e.g., to a computing device implementing the AI-based analysis). Such one or more user-selected hypotheses may be used as part of the investigation into the potential cyber incident.

In some embodiments, the method 2400 further comprises causing the user interface to display a representation of one or more alerts generated by the cyber security system in connection with the potential cyber incident.

In some embodiments, the method 2400 further comprises handling a user request, input via the user interface, for the portion of the data generated by the cyber threat analyst module 120 to be displayed by the user interface. For example, the user request may be handled via an application programming interface (API).

In some embodiments, the outcome of the investigation for each hypothesis is indicative of whether a determination is made by the AI-based analysis that the hypothesis is supported based on the generated data.

In some embodiments, if a determination is made that at least one hypothesis of the one or more hypotheses is not supported based on the generated data, the method 2400 further comprises providing, for use by the user interface, at least a portion of the generated data associated with the at least one hypothesis. Thus, if the hypothesis yields a negative result, the data associated with the investigation using that hypothesis may still be provided to the user because the user may find such information to be useful.

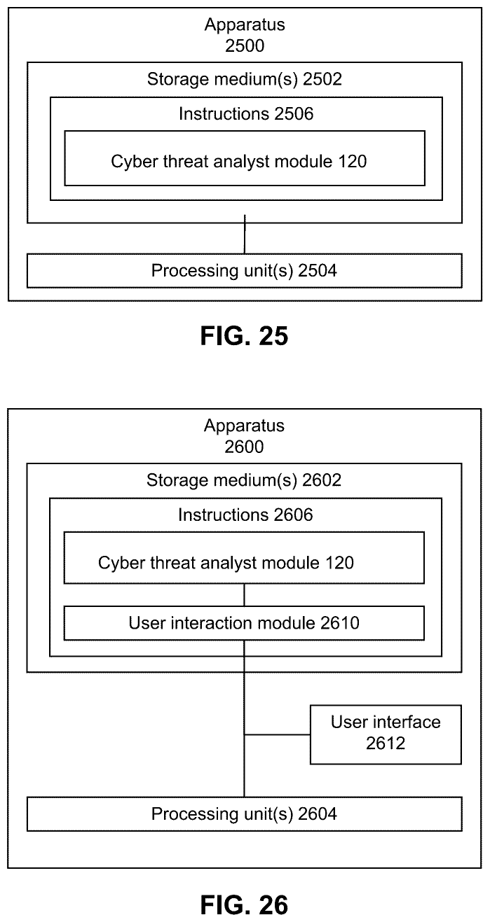

FIG. 25 illustrates a block diagram of an apparatus 2500 for performing an investigation into a potential cyber incident detected by a cyber security system according to an embodiment. The apparatus 2500 comprises one or more storage medium(s) 2502 (e.g., non-transitory storage medium(s) another type of machine-readable memory). The apparatus 2500 further comprises one or more processing unit(s) 2504 coupled to the one or more storage medium(s) 2502. The one or more storage medium(s) 2502 store instructions 2506 that, when implemented by the one or more processing unit(s) 2504 implement certain functionality as described below.

The instructions 2506 are implemented in software to implement the functionality of the method 2300 with the cyber threat analyst module. Thus, the functionality of the apparatus 2500 shall be understood with reference to the description of the method 2300 and its associated embodiments. The particular number and arrangement of modules is exemplary and alternative arrangements are possible. For example, any number of modules could implement the stated functionality. Further, the naming of the modules is for description purposes rather than being limiting in terms of structure or functionality of the apparatus 2500.

The cyber threat analyst module 120 is configured to perform the investigation into the potential cyber incident based on one or more user-selected hypotheses selected by a user responsive to one or more alerts generated by the cyber security system. The cyber threat analyst module 120 is configured to cause one or more actions to be performed based on an outcome of the investigation.

The apparatus 2500 may be further configured to implement functionality of any of the embodiments relating to the method 2300. Further, the apparatus 2500 may be configured to implement functionality of the method 2400 and any of the embodiments relating to the method 2400. Further details of certain embodiments relating to such functionality are described below.

FIG. 26 illustrates a block diagram of an apparatus 2600 for performing an investigation into a potential cyber incident detected by a cyber security system according to an embodiment. The apparatus 2600 comprises one or more storage medium(s) 2602 (e.g., non-transitory storage medium(s) another type of machine-readable memory). The apparatus 2600 further comprises one or more processing unit(s) 2604 coupled to the one or more storage medium(s) 2602. The one or more storage medium(s) 2602 store instructions 2606 that, when implemented by the one or more processing unit(s) 2604 implement certain functionality as described below.

The instructions 2606 are implemented in software to implement the functionality of the method 2300 with cyber threat analyst module 120 (corresponding to the cyber threat analyst module 120 of FIG. 25). Thus, the functionality of the apparatus 2600 shall be understood with reference to the description of the method 2300 and its associated embodiments. The particular number and arrangement of modules is exemplary and alternative arrangements are possible. For example, any number of modules could implement the stated functionality. Further, the naming of the modules is for description purposes rather than being limiting in terms of structure or functionality of the apparatus 2600.

The apparatus 2600 further comprises a user interaction module 2610 communicatively coupled to the cyber threat analyst module. The user interaction module 2610 is configured to receive the one or more user-selected hypotheses. Instructions implemented in software for the user interaction module 2610 are configured to be stored in the one or more (e.g., non-transitory) storage mediums to be executed by the one or more processing units. In some cases, the user interaction module 2610 may be implemented via an API or interact with an API in order to provide the described functionality. In some embodiments, the user interaction module 2610 may be used to implement certain functionality as described in relation to the method 2300 and its associated embodiments, such as described in more detail below.

In some embodiments, the user interaction module 2610 is communicatively coupled to a user interface 2612. The user interface 2612 is configured to receive input from the user indicative of the one or more user-selected hypotheses. In some embodiments, the user interface 2612 may be used to implement certain functionality as described in relation to the method 2300 and its associated embodiments, such as described in more detail below.

In some embodiments, the user interaction module 2610 is configured to cause the user interface 2612 to: provide a representation of the one or more alerts detected by the cyber security system; and allow the user to select the one or more user-selected hypotheses for the cyber threat analyst module 120 to investigate.

In some embodiments, the user interaction module 2610 is configured to provide a representation of one or more suggested hypotheses identified by the cyber security system in response to the one or more alerts. The one or more suggested hypotheses may be identified based on one or more predefined rules. The user interaction module 2610 may be configured to cause the user interface to provide the user with an option to select one or more hypotheses for investigation from a set of hypotheses other than the one or more suggested hypotheses.

In some embodiments, the user interaction module 2610 is configured to receive one or more user specified criteria for the cyber security system. The one or more user specified criteria may be indicative of the one or more actions that are to be performed based on the outcome of the investigation.

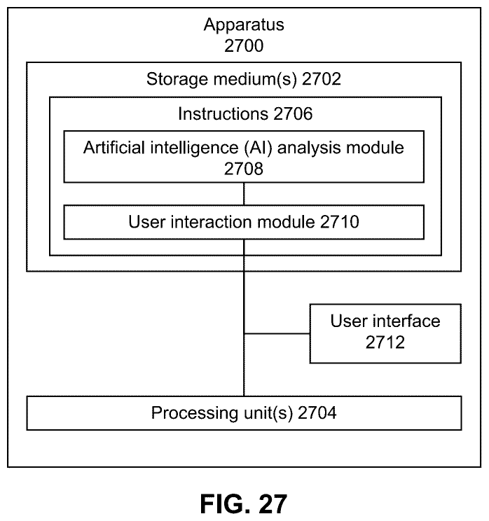

FIG. 27 illustrates a block diagram of an apparatus 2700 for representing data generated as part of an investigation into a potential cyber incident detected by a cyber security system. The apparatus 2700 comprises one or more storage medium(s) 2702 (e.g., non-transitory storage medium(s) another type of machine-readable memory). The apparatus 2700 further comprises one or more processing unit(s) 2704 coupled to the one or more storage medium(s) 2702. The one or more storage medium(s) 2702 store instructions 2706 that, when implemented by the one or more processing unit(s) 2704 implement certain functionality as described below.

The instructions 2706 are implemented in software to implement the functionality of the method 2400 with the cyber threat analyst module 120 and a user interaction module 2710. Thus, the functionality of the apparatus 2700 shall be understood with reference to the description of the method 2400 and its associated embodiments. The particular number and arrangement of modules is exemplary and alternative arrangements are possible. For example, any number of modules could implement the stated functionality. Further, the naming of the modules is for description purposes rather than being limiting in terms of structure or functionality of the apparatus 2700.

The cyber threat analyst module 120 is configured to perform an investigation into the potential cyber incident based on one or more hypotheses. The cyber threat analyst module 120 is configured to generate data indicative of: one or more investigative steps taken as part of the investigation for each hypothesis of the one or more hypotheses; and an outcome of the investigation for each hypothesis.

The user interaction module 2710 is communicatively coupled to the cyber threat analyst module 120 and a user interface 2712. The user interaction module 2710 is configured to provide at least a portion of the data generated by the cyber threat analyst module 120 for use by the user interface 2712 to represent the portion of the data.

The apparatus 2700 may be further configured to implement functionality of any of the embodiments relating to the method 2400. Further, the apparatus 2700 may be configured to implement functionality of the method 2300 and any of the embodiments relating to the method 2300. Further details of certain embodiments relating to such functionality are described below.

Any appropriate one of the cyber threat analyst module 120 and/or the user interaction module 2710 may be configured to implement the functionality of any of the embodiments described in relation to the method 2400.

In some embodiments, the user interaction module 2710 is configured to receive one or more user-selected hypotheses selected by the user via the user interface 2712.

In some embodiments, the user interaction module 2710 is configured to send an indication of the one or more user-selected hypotheses to the cyber threat analyst module. The cyber threat analyst module 120 is configured to use the one or more user-selected hypotheses as part of the investigation into the potential cyber incident.

In some embodiments, the user interaction module 2710 is configured to cause the user interface 2712 to display a representation of one or more alerts generated by the cyber security system in connection with the potential cyber incident.

In some embodiments, the user interaction module 2710 is configured to handle a user request, input via the user interface 2712, for the portion of the data generated by the cyber threat analyst module 120 to be displayed by the user interface.

In some embodiments, the user interaction module 2710 is implemented via an application programming interface (API).

In some embodiments, if the cyber threat analyst module 120 determines that at least one hypothesis of the one or more hypotheses is not supported based on the generated data, the user interaction module 2710 is configured to provide, for use by the user interface 2712, at least a portion of the generated data associated with the at least one hypothesis.

Certain embodiments may provide one or more of the following functionalities as will be understood with reference to the rest of the description.

In some embodiments, a user may be able to configure what one or more hypotheses The cyber threat analyst module 120 uses to investigate an alert. In some embodiments, the user may be provided with additional information about the investigations (i.e., based on one or more hypotheses) that have been conducted, including those investigations where nothing was discovered that the user needs to be alerted to.

A further use of investigations is to apply additional response actions. In the response cases, how the additional information from the cyber threat analyst module 120 is used and the additional context around the incident may improve response actions, as well as potentially facilitating user interactions with the response actions.

It shall be appreciated that the automation scope of the cyber threat analyst module 120 may be extended to further explanations and actions that until now would have to have been followed up by a human. The human would have had to repeat the investigation to understand, but now this can be considered to be more automated. In some embodiments, AI-based analysis may be controlled by the user to look at custom circumstances or triggers, and in some cases, trigger an automatic response to an entire incident. It is then possible to automate human steps further down the line.

As such, a human-AI augmented system may be provided where a human may rely on the detections of the cyber threat analyst module. The user may interrogate those detections and invoke those detections on their own criteria and allow the Cyber threat analyst module 120 to, based on its investigations, drive autonomous actions. A human user can define conditions on autonomy level, such how much of a device it should target. Thus, certain embodiments described herein may facilitate user control, on a sliding scale between AI autonomy and human control, over the level of user interactivity with the cyber threat analyst module 120 needed for reviewing alerts and triggering response actions.

In certain situations, each of the terms “engine,” “module” and “component” is representative of hardware, firmware, and/or software that is configured to perform one or more functions. As hardware, the engine (or module or component) may include circuitry having data processing and/or storage functionality. Examples of such circuitry may include, but are not limited or restricted to a processor, a programmable gate array, a microcontroller, an application specific integrated circuit, wireless receiver, transmitter and/or transceiver circuitry, semiconductor memory, or combinatorial logic. Alternatively, or in combination with the hardware circuitry described above, the engine (or module or component) may be software in the form of one or more software modules, which may be configured to operate as its counterpart circuitry. For instance, a software module may be a software instance that operates as or is executed by a processor, namely a virtual processor whose underlying operations is based on a physical processor such as virtual processor instances for Microsoft® Azure® or Google® Cloud Services platform or an EC2 instance within the Amazon® AWS infrastructure, for example. Illustrative examples of the software module may include an executable application, a daemon application, an application programming interface (API), a subroutine, a function, a procedure, an applet, a servlet, a routine, source code, a shared library/dynamic load library, or simply one or more instructions. A module may be implemented in hardware electronic components, software components, and a combination of both. A module is a core component of a complex system consisting of hardware and/or software that is capable of performing its function discretely from other portions of the entire complex system but designed to interact with the other portions of the entire complex system. The term “computerized” generally represents that any corresponding operations are conducted by hardware in combination with software and/or firmware. The terms “computing device” or “device” should be generally construed as physical device with data processing capability, data storage capability, and/or a capability of connecting to any type of network, such as a public cloud network, a private cloud network, or any other network type. Examples of a computing device may include, but are not limited or restricted to, the following: a server, a router or other intermediary communication device, an endpoint (e.g., a laptop, a smartphone, a tablet, a desktop computer, a netbook, IoT device, networked wearable, etc.) Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, a module can be implemented with electronic circuits, software that contain patterns of instructions stored in one or more memories and executed by one or more processors, or any combination of both. In an embodiment, the logic consists of electronic circuits that follow the rules of Boolean Logic, software that contain patterns of instructions, or any combination of both. Note, many functions performed by electronic hardware components can be duplicated by software emulation. Thus, a software program written to accomplish those same functions can emulate the functionality of the hardware components in the electronic circuitry.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. An apparatus for performing an investigation into a potential cyber incident detected by a cyber security system, the apparatus comprising:
a cyber threat analyst module configured to perform the investigation into the potential cyber incident,
a user interaction module communicatively coupled to the cyber threat analyst module, wherein the user interaction module is configured to receive one or more user-selected hypotheses,
wherein the cyber threat analyst module is configured to perform the investigation into the potential cyber incident based on the one or more user-selected hypotheses selected by a user responsive to one or more alerts generated by the cyber security system, wherein the cyber threat analyst module is configured to cause one or more actions to be performed based on an outcome of the investigation, and
wherein instructions implemented in software for the cyber threat analyst module and the user interaction module are configured to be stored in one or more non-transitory storage mediums to be executed by one or more processing units.

2. The apparatus of claim 1, wherein the user interaction module is configured to review an output of the investigation into the potential cyber incident, and then supply the one or more user-selected hypotheses for the cyber threat analyst module to further review by the cyber threat analyst module to conclude whether the potential cyber incident detected by the cyber security system is an actual cyber incident caused by a cyber threat.

3. The apparatus of claim 1, wherein the user interaction module is communicatively coupled to a user interface, wherein the user interface is configured to receive input from the user indicative of the one or more user-selected hypotheses.

4. The apparatus of claim 3, wherein the user interaction module is configured to cause the user interface to:
provide a representation of the one or more alerts detected by the cyber security system; and
allow the user to select the one or more user-selected hypotheses for the cyber threat analyst module to investigate.

5. The apparatus of claim 1, wherein the user interaction module is configured to provide a representation of one or more suggested hypotheses identified by the cyber security system in response to the one or more alerts, wherein the one or more suggested hypotheses are identified based on one or more predefined rules, and wherein the user interaction module is configured to cause a user interface to provide the user with an option to select the one or more hypotheses for investigation from a set of hypotheses other than the one or more suggested hypotheses.

6. The apparatus of claim 1, wherein the user interaction module is configured to receive one or more user specified criteria for the cyber security system, wherein the one or more user specified criteria are indicative of the one or more actions that are to be performed based on the outcome of the investigation to allow the user to augment recommended response actions to be taken by the cyber security system with the one or more actions selected by the user.

7. The apparatus of claim 1, wherein the user interaction module is configured to allow the user to be able to review i) how the cyber threat analyst module performed the investigation into the potential cyber incident and concluded a cyber threat was present and ii) then what are one or more autonomous responses to be taken by the cyber security system.

8. The apparatus of claim 1, wherein the user interaction module is configured to cooperate with an autonomous response module to allow the user to review one or more autonomous responses to be taken by the autonomous response module to mitigate against a cyber threat detected in the potential cyber incident and then to allow the user to insert their own better judgement on what autonomous responses will be taken by the autonomous response module.

9. The apparatus of claim 1, wherein the one or more actions comprise causing a user interface to represent at least some data generated as part of the investigation into the potential cyber incident, and wherein the apparatus is configured to use data to generate a representation comprising:
a status of the investigation;
a description associated with at least one of the one or more hypotheses;
one or more steps taken by the cyber threat analyst module as part of the investigation for at least one of the one or more user-selected hypotheses;
the outcome of the investigation, wherein the outcome is indicative of whether the data supports at least one of the one or more user-selected hypotheses; or
a combination thereof.

10. The apparatus of claim 1, wherein one or more actions comprise causing a user interface to provide a request for input from the user to trigger one or more responses to be taken by the cyber security system to address the potential cyber incident.

11. An apparatus for representing data generated as part of an investigation into a potential cyber incident detected by a cyber security system, the apparatus comprising:
an cyber threat analyst module configured to perform the investigation into the potential cyber incident based on one or more hypotheses,
wherein the cyber threat analyst module is configured to generate data indicative of:
one or more investigative steps taken as part of the investigation for each hypothesis of the one or more hypotheses;
an outcome of the investigation for each hypothesis,
a user interaction module communicatively coupled to the cyber threat analyst module and a user interface, wherein the user interaction module is configured to provide at least a portion of the data generated by the cyber threat analyst module for use by a user interface to represent the portion of the data, and
wherein instructions implemented in software for the cyber threat analyst module and the user interaction module are configured to be stored in one or more non-transitory storage mediums to be executed by one or more processing units.

12. The apparatus of claim 11, wherein the user interaction module is configured to receive one or more user-selected hypotheses selected by a user via the user interface, and wherein the user interaction module is configured to review an output of the investigation into the potential cyber incident, and then supply the one or more user-selected hypotheses for the cyber threat analyst module to further review by the cyber threat analyst module to conclude whether the potential cyber incident detected by the cyber security system is an actual cyber incident caused by a cyber threat.

13. The apparatus of claim 11, wherein the user interaction module is configured to send an indication of one or more user-selected hypotheses to the cyber threat analyst module, and wherein the cyber threat analyst module is configured to use the one or more user-selected hypotheses as part of the investigation into the potential cyber incident.

14. The apparatus of claim 11, wherein the user interaction module is configured to cause the user interface to display a representation of one or more alerts generated by the cyber security system in connection with the potential cyber incident.

15. The apparatus of claim 11, wherein the user interaction module is configured to handle a user request, input via the user interface, for the portion of the data generated by the cyber threat analyst module to be displayed by the user interface.

16. The apparatus of claim 11, wherein the user interaction module is implemented via an application programming interface (API), and
wherein the user interaction module is configured to cooperate with an autonomous response module to allow a user to review one or more autonomous responses to be taken by the autonomous response module to mitigate against a cyber threat detected in the potential cyber incident and then to allow the user to insert their own better judgement on what autonomous responses will be taken by the autonomous response module.

17. The apparatus of claim 11, wherein the outcome of the investigation for each hypothesis is indicative of whether the cyber threat analyst module determined that the hypothesis is supported based on the data generated by the cyber threat analyst module.

18. The apparatus of claim 11, wherein when the cyber threat analyst module determines that at least one hypothesis of the one or more hypotheses is not supported based on the data generated, and wherein the user interaction module is configured to provide, for use by the user interface, at least a portion of the generated data associated with the at least one hypothesis.

19. A computer-implemented method of investigating a potential cyber incident detected by a cyber security system, the method comprising:
using artificial intelligence (AI) based analysis to perform an investigation into the potential cyber incident based on one or more user-selected hypotheses selected by a user responsive to one or more alerts generated by the cyber security system; and
causing one or more actions to be performed based on an outcome of the investigation.

20. The computer-implemented method of claim 19, further comprising:
representing data generated as part of the investigation into the potential cyber incident detected by the cyber security system, where the generated data is indicative of
one or more investigative steps taken as part of the investigation for each hypothesis of the one or more hypotheses,
an outcome of the investigation for each hypothesis; and
providing at least a portion of the generated data for use by a user interface to represent the portion of the data.
